(19) United States
(12) Patent Application Publication
(10) Pub. No.: US 2005/0160065 A1
(43) Pub. Date: Jul. 21, 2005

(54) System and method for enhancing resource accessibility

(76) Inventor: Lisa Seeman, Jerusalem (IL)

Correspondence Address: BRENDA POMERANCE;LAW OFFICE OF BRENDA POMERANCE, 260 WEST 52 STREET SUITE 27B, NEW YORK, NY, 10019, US

(21) Appl. No.: 10/957,797

(22) Filed: Oct. 4, 2004

Related U.S. Application Data
(63) Continuation-in-part of application No. PCT/IL03/00255, filed on Mar. 27, 2003.
(60) Provisional application No. 60/370,199, filed on Apr. 5, 2002.

(51) Int. Cl. G06F 7/00

(52) U.S. Cl. 707/1

(57) ABSTRACT

A resource accessibility engine according to the present invention uses a resource-specific knowledge base and user preferences to convert a resource into an improved accessibility resource. Examples of a resource include a website, document, webpage image file, multimedia file, auditory file or any other text and/or non-text record. The resource-specific knowledge includes content and formatting information that reduces ambiguities, translates implied information into explicit information and improves the accessibility of the resource content. The user preferences represent the physical capabilities of the user's access device, and the user's semantic and personal preferences for how content should be displayed. An editor uses an annotation wizard to create the resource-specific knowledge base based on the original resource.

### CROSS-REFERENCE TO RELATED APPLICATIONS

This application claims priority as a continuation-in-part of PCT/IL 03/00255, filed Mar. 27, 2003, which claims priority from U.S. provisional patent application Ser. No. 60/370,199, filed Apr. 5, 2002.

### BACKGROUND OF THE INVENTION

The present invention relates to rendering the content of a resource, and more particularly, is directed to creating a knowledge base relating to the content and formatting of the resource, and using the knowledge base to convert the original resource to a more accessible resource based on user needs such as device capability and human perception capability. The resource may be an Internet website, web content, media document or a multimedia document.

A problem with conventional websites is that neither the designer who designs their format and layout, nor the writer who decides on their content, provide for the vast range of devices and users that may access the websites. More specifically, devices have varying display sizes, varying audio capabilities and varying bandwidth connections. Users have varying abilities and disabilities, such as visual, auditory, perceptual, cognitive, learning, mobility, background knowledge, memory or other, which may depend on the user herself and/or characteristics of the user's environment, such as dim lighting, extremely bright lighting or ambient noise and so on.

Generally, prior art tools which address this situation are limited in the types of scenarios that can be accommodated, e.g., only lighting constraints or only screen element size.

In the United States, the most widely used accessibility guidelines are those specified for implementation of section 508 of the Rehabilitation Act of 1973, as amended, 29 U.S.C. 794d. Section 508 requires that when Federal agencies develop, procure, maintain, or use electronic and information technology, Federal employees with disabilities have access to and use of information and data that is comparable to the access and use by Federal employees who are not individuals with disabilities, unless an undue burden would be imposed on the agency. Section 508 also requires that individuals with disabilities, who are members of the public seeking information or services from a Federal agency, have access to and use of information and data that is comparable to that provided to the public who are not individuals with disabilities, unless an undue burden would be imposed on the agency. The guidelines are at http://www.access-board.gov/sec508guide/. The 508 guidelines are as follows:
(a) A text equivalent for every non-text element shall be provided (e.g., via “alt”, “longdesc”, or in element content).
(b) Equivalent alternatives for any multimedia presentation shall be synchronized with the presentation.
(c) Web pages shall be designed so that all information conveyed with color is also available without color, for example from context or markup.
(d) Documents shall be organized so they are readable without requiring an associated style sheet.
(e) Redundant text links shall be provided for each active region of a server-side image map.
(f) Client-side image maps shall be provided instead of server-side image maps except where the regions cannot be defined with an available geometric shape.
(g) Row and column headers shall be identified for data tables.
(h) Markup shall be used to associate data cells and header cells for data tables that have two or more logical levels of row or column headers.
(i) Frames shall be titled with text that facilitates frame identification and navigation.
(j) Pages shall be designed to avoid causing the screen to flicker with a frequency greater than 2 Hz and lower than 55 Hz.
(k) A text-only page, with equivalent information or functionality, shall be provided to make a web site comply with the provisions of this part, when compliance cannot be accomplished in any other way. The content of the text-only page shall be updated whenever the primary page changes.
(l) When pages utilize scripting languages to display content, or to create interface elements, the information provided by the script shall be identified with functional text that can be read by assistive technology.
(m) When a web page requires that an applet, plug-in or other application be present on the client system to interpret page content, the page must provide a link to a plug-in or applet that complies with §1194.21(a) through (l).
(n) When electronic forms are designed to be completed on-line, the form shall allow people using assistive technology to access the information, field elements, and functionality required for completion and submission of the form, including all directions and cues.
(o) A method shall be provided that permits users to skip repetitive navigation links.
(p) When a timed response is required, the user shall be alerted and given sufficient time to indicate more time is required.

The World-Wide Web Consortium (W3C) has published W3C Recommendation, dated May 5, 1999, for Web Content Accessibility Guidelines (WCAG) 1.0, available at http://www.w3.org/TR/WAI-WEBCONTENT/, explaining how to make web content accessible to people with disabilities. WCAG comprises guidelines, which are general goal statements, and checkpoints, which are specific things to do in support of the guidelines. Table 1 provides the current WCAG guidelines and checkpoints. Each checkpoint has a priority level assigned thereto.

TABLE 1

| WCAG | | | |
|---|---|---|---|
| No. | Topics | Priority | Checkpoint description |
| 1 | GUIDELINE | | PROVIDE EQUIVALENT ALTERNATIVES TO |
| | | | AUDITORY AND VISUAL CONTENT. |
| | | | Provide content that, when presented to the user, conveys |
| | | | essentially the same function or purpose as auditory or |
| | | | visual content. |
| 1.1 | General | P1 | Provide a text equivalent for every non-text element (e.g., |
| | | | via “alt”, “longdesc”, or in element content). This |
| | | | includes: images, graphical representations of text |
| | | | (including symbols), image map regions, animations (e.g., |
| | | | animated GIFs), applets and programmatic objects, ascii |
| | | | art, frames, scripts, images used as list bullets, spacers, |
| | | | graphical buttons, sounds (played with or without user |
| | | | interaction), stand-alone audio files, audio tracks of video, |
| | | | and video. |
| 1.2 | Images and | P1 | Provide redundant text links for each active region of a |
| | image maps | | server-side image map. |
| 1.3 | Images and | P1 | Until user agents can automatically read aloud the text |
| | image maps | | equivalent of a visual track, provide an auditory |
| | | | description of the important information of the visual track |
| | | | of a multimedia presentation. |
| 1.4 | Multimedia | P1 | For any time-based multimedia presentation (e.g., a movie |
| | | | or animation), synchronize equivalent alternatives (e.g., |
| | | | captions or auditory descriptions of the visual track) with |
| | | | the presentation. |
| 1.5 | Images and | P3 | Until user agents render text equivalents for client-side |
| | image maps | | image map links, provide redundant text links for each |
| | | | active region of a client-side image map. |
| 2 | GUIDELINE | | DON'T RELY ON COLOR ALONE. |
| | | | Ensure that text and graphics are understandable when |
| | | | viewed without color. |
| 2.1 | General | P1 | Ensure that all information conveyed with color is also |
| | | | available without color, for example from context or |
| | | | markup. |
| 2.2 | General | P2 | Ensure that foreground and background color |
| | | | combinations provide sufficient contrast when viewed by |
| | | | someone having color deficits or when viewed on a black |
| | | | and white screen. [Priority 2 for images, Priority 3 for |
| | | | text]. |
| 3 | GUIDELINE | | USE MARKUP AND STYLE SHEETS AND DO SO |
| | | | PROPERLY. |
| | | | Mark up documents with the proper structural elements. |
| | | | Control presentation with style sheets rather than with |
| | | | presentation elements and attributes. |
| 3.1 | General | P2 | Use markup languages when reasonable to convey |
| | | | information. |
| 3.2 | General | P2 | Create documents that validate to published formal |
| | | | grammars. |
| 3.3 | General | P2 | Use style sheets to control presentation. |
| 3.4 | General | P2 | Use relative rather than absolute units in markup language |
| | | | attribute values and style sheet property values. |
| 3.5 | General | P2 | Use mark up elements to convey document structure and |
| | | | use them according to specification. |
| 3.6 | General | P2 | Mark up lists and list items properly. |
| 3.7 | General | P2 | Mark up quotations. Do not use quotation markup for |
| | | | formatting effects such as indentation. |
| 4 | GUIDELINE | | CLARIFY NATURAL LANGUAGE USAGE. |
| | | | Use markup that facilitates pronunciation or interpretation |
| | | | of abbreviated or foreign text. |
| 4.1 | General | P1 | Clearly identify changes in the natural language of a |
| | | | document's text and any text equivalents (e.g., captions). |
| 4.2 | General | P3 | Specify the expansion of each abbreviation or acronym in |
| | | | a document where it first occurs. |
| 4.3 | General | P3 | Identify the primary natural language of a document. |
| 5 | GUIDELINE | | CREATE TABLES THAT TRANSFORM |
| | | | GRACEFULLY. |
| | | | Ensure that tables have necessary markup to be |
| | | | transformed by accessible browsers and other user agents. |
| 5.1 | Tables | P1 | For data tables, identify row and column headers. |
| 5.2 | Images and | P1 | For data tables that have two or more logical levels of row |
| | image maps | | or column headers, use markup to associate data cells and |
| | | | header cells. |
| 5.3 | Tables | P2 | Do not use tables for layout unless the table makes sense |
| | | | when linearized. Otherwise, if the table does not make |
| | | | sense, provide an alternative equivalent (which may be a |
| | | | linearized version). |
| 5.4 | Tables | P2 | If a table is used for layout, do not use any structural |
| | | | markup for the purpose of visual formatting. |
| 5.5 | Tables | P3 | Provide summaries for tables. |
| 5.6 | Tables | P3 | Provide abbreviations for header labels. |
| 6 | GUIDELINE | | ENSURE THAT PAGES FEATURING NEW |
| | | | TECHNOLOGIES TRANSFORM GRACEFULLY. |
| | | | Ensure that pages are accessible even when newer |
| | | | technologies are not supported or are turned off. |
| 6.1 | General | P1 | Organize documents so they may be read without style |
| | | | sheets. For example, when an HTML document is |
| | | | rendered without associated style sheets, it must still be |
| | | | possible to read the document. |
| 6.2 | General | P1 | Ensure that equivalents for dynamic content are updated |
| | | | when the dynamic content changes. |
| 6.3 | Applets and | P1 | Ensure that pages are usable when scripts, applets, or |
| | scripts | | other programmatic objects are turned off or not |
| | | | supported. If this is not possible, provide equivalent |
| | | | information on an alternative accessible page. |
| 6.4 | Applets and | P2 | For scripts and applets, ensure that event handlers are |
| | scripts | | input device-independent. |
| 6.5 | General | P2 | Ensure that dynamic content is accessible or provide an |
| | | | alternative presentation or page. |
| 7 | GUIDELINE | | ENSURE USER CONTROL OF TIME-SENSITIVE |
| | | | CONTENT CHANGES. |
| | | | Ensure that moving, blinking, scrolling or auto-updating |
| | | | object or pages may be paused or stopped. |
| 7.1 | General | P1 | Until user agents allow users to control flickering, avoid |
| | | | causing the screen to flicker. |
| 7.2 | General | P2 | Until user agents allow users to control blinking, avoid |
| | | | causing content to blink (i.e., change presentation at a |
| | | | regular rate, such as turning on and off). |
| 7.3 | Applets and | P2 | Until user agents allow users to freeze moving content, |
| | scripts | | avoid movement in pages. |
| 7.4 | General | P2 | Until user agents provide the ability to stop the refresh, do |
| | | | not create periodically auto-refreshing pages. |
| 7.5 | General | P2 | Until user agents provide the ability to stop auto-redirect, |
| | | | do not use markup to redirect pages automatically. |
| | | | Instead, configure the server to perform redirects. |
| 8 | GUIDELINE | | ENSURE DIRECT ACCESSIBILITY OF EMBEDDED |
| | | | USER INTERFACES. |
| | | | Ensure that the user interface follows principles of |
| | | | accessible design: device-independent access to |
| | | | functionality, keyboard operability, self-voicing, etc. |
| 8.1 | Applets and | P2 | Make programmatic elements such as scripts and applets |
| | scripts | | directly accessible or compatible with assistive |
| | | | technologies [Priority 1 if functionality is important and |
| | | | not presented elsewhere, otherwise Priority 2.] |
| 9 | GUIDELINE | | DESIGN FOR DEVICE-INDEPENDENCE. |
| | | | Use features that enable activation of page elements via a |
| | | | variety of input devices. |
| 9.1 | Images and | P1 | Provide client-side image maps instead of server-side |
| | image maps | | image maps except where the regions cannot be defined |
| | | | with an available geometric shape. |
| 9.2 | Applets and | P2 | Ensure that any element that has its own interface can be |
| | scripts | | operated in a device-independent manner. |
| 9.3 | Applets and | P2 | For scripts, specify logical event handlers rather than |
| | scripts | | device-dependent event handlers. |
| 9.4 | General | P3 | Create a logical tab order through links, form controls, and |
| | | | objects. |
| 9.5 | General | P3 | Provide keyboard shortcuts to important links (including |
| | | | those in client-side image maps), form controls, and |
| | | | groups of form controls. |
| 10 | GUIDELINE | | USE INTERIM SOLUTIONS. |
| | | | Use interim accessibility solutions so that assistive |
| | | | technologies and older browsers will operate correctly. |
| 10.1 | General | P2 | not cause pop-ups or other windows to appear and do not |
| | | | change the current window without informing the user. |
| 10.2 | Forms | P2 | Until user agents support explicit associations between |
| | | | labels and form controls, for all form controls with |
| | | | implicitly associated labels, ensure that the label is |
| | | | properly positioned. |
| 10.3 | Tables | P3 | Until user agents (including assistive technologies) render |
| | | | side-by-side text correctly, provide a linear text alternative |
| | | | (on the current page or some other) for all tables that lay |
| | | | out text in parallel, word-wrapped columns. |
| 10.4 | Forms | P3 | Until user agents handle empty controls correctly, include |
| | | | default, place-holding characters in edit boxes and text |
| | | | areas. |
| 10.5 | General | P3 | Until user agents (including assistive technologies) render |
| | | | adjacent links distinctly, include non-link, printable |
| | | | characters (surrounded by spaces) between adjacent links. |
| 11 | GUIDELINE | | USE W3C TECHNOLOGIES AND GUIDELINES. |
| | | | Use W3C technologies (according to specification) and |
| | | | follow accessibility guidelines. Where it is not possible to |
| | | | use a W3C technology, or doing so results in material that |
| | | | does not transform gracefully, provide an alternative |
| | | | version of the content that is accessible. |
| 11.1 | General | P2 | Use W3C technologies when they are available and |
| | | | appropriate for a task and use the latest versions when |
| | | | supported. |
| 11.2 | General | P2 | Avoid deprecated features of W3C technologies. |
| 11.3 | General | P3 | Provide information so that users may receive documents |
| | | | according to their preferences (e.g., language, content |
| | | | type, etc.) |
| 11.4 | And if all | P1 | OR provide a link to an alternative page that uses W3C |
| | else fails | | technologies, is accessible, has equivalent information (or |
| | | | functionality), and is updated as often as the inaccessible |
| | | | (original) page. |
| 12 | GUIDELINE | | PROVIDE CONTEXT AND ORIENTATION |
| | | | INFORMATION. |
| | | | Provide context and orientation information to help users |
| | | | understand complex pages or elements. |
| 12.1 | Frames | P1 | Title each frame to facilitate frame identification and |
| | | | navigation. |
| 12.2 | Frames | P2 | Describe the purpose of frames and how frames relate to |
| | | | each other if it is not obvious by frame titles alone. |
| 12.3 | General | P2 | Divide large blocks of information into more manageable |
| | | | groups where natural and appropriate. |
| 12.4 | Forms | P2 | Associate labels explicitly with their controls. |
| 13 | GUIDELINE | | PROVIDE CLEAR NAVIGATION MECHANISMS. |
| | | | Provide clear and consistent navigation mechanisms - |
| | | | orientation information, navigation bars, a site map, etc. - |
| | | | to increase the likelihood that a person will find what they |
| | | | are looking for at a site. |
| 13.1 | General | P2 | Clearly identify the target of each link. |
| 13.2 | General | P2 | Provide metadata to add semantic information to pages |
| | | | and sites. |
| 13.3 | General | P2 | Provide information about the general layout of a site |
| | | | (e.g., a site map or table of contents). |
| 13.4 | General | P2 | Use navigation mechanisms in a consistent manner. |
| 13.5 | General | P3 | Provide navigation bars to highlight and give access to the |
| | | | navigation mechanism. |
| 13.6 | General | P3 | Group related links, identify the group (for user agents), |
| | | | and, until user agents do so, provide a way to bypass the |
| | | | group. |
| 13.7 | General | P3 | With the client only - If search functions are provided, |
| | | | enable different types of searches for different skill levels |
| | | | and preferences. |
| 13.8 | General | P3 | Place distinguishing information at the beginning of |
| | | | headings, paragraphs, lists, etc. |
| 13.9 | General | P3 | Provide information about document collections (i.e., |
| | | | documents comprising multiple pages.). |
| 13.10 | General | P3 | Provide a means to skip over multi-line ASCII art. |
| 14 | GUIDELINE | | ENSURE THAT DOCUMENTS ARE CLEAR AND |
| | | | SIMPLE. |
| | | | Ensure that documents are clear and simple so they may |
| | | | be more easily understood. |
| 14.1 | General | P1 | Use the clearest and simplest language appropriate for a |
| | | | site's content. |
| 14.2 | General | P3 | Supplement text with graphic or auditory presentations |
| | | | where they will facilitate comprehension of the page. |
| 14.3 | General | P3 | Create a style of presentation that is consistent across |
| | | | pages. |

Unfortunately, many websites do not follow these guidelines, either through ignorance, indifference or insufficient resources to ensure compliance.

Another problem is that the guidelines are intentionally limited, since the guideline creators focus on a subset of everything that could be done, to avoid frightening authors with a guideline that appears unduly onerous to comply with.

Accordingly, there is a need to improve the accessibility of resources without burdening the resource designers and writers; resources include websites, web content, multimedia files, complicated documents and books intended for electronic viewing.

### SUMMARY OF THE INVENTION

In accordance with an aspect of this invention, there are provided a method of and a system for enhancing resource accessibility. Using a computer, a resource knowledge base is applied to the resource to generate a converted resource, the resource knowledge base providing information about the resource that is absent from or implicit in the resource, and the converted resource is provided to a user.

In accordance with another aspect of this invention, a resource knowledge base is created by using a computer to apply rules representing knowledge gap situations to a resource to identify knowledge gaps, and obtaining knowledge to fill the knowledge gaps, the obtained knowledge forming the resource knowledge base.

In accordance with a further aspect of this invention, a method of converting a resource from one format to at least one other target format comprises using a computer to apply at least one mapping knowledge base to the resource to generate at least one mapped resource, each mapping knowledge base providing information about the meaning of information whose format is to be converted so that the mapped resource is properly represented in the target format, and providing the at least one mapped resource to a user.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1A is a diagram showing the configuration of a prior art rendering system;

FIG. 1B is a chart showing the main elements involved in a prior art page rendering;

FIG. 2A is a chart showing processing activity in a prior art accessibility checker program;

FIG. 2B is a chart showing processing activity in an accessibility compliance program;

FIGS. 3A-3B are diagrams showing configurations in which the present invention is applied;

FIG. 4 is a chart showing the components of an annotation wizard;

FIG. 5 is a chart showing how manually specified knowledge gaps are compiled into executable transformation programs;

FIG. 6 is a diagram showing a data structure for a knowledge gap file;

FIG. 7 is a chart showing the activity involved in creating a resource knowledge base;

FIGS. 8-9 are diagrams respectively showing data structures for intermediate and final knowledge bases;

FIGS. 10A-10C are charts showing the main elements involved in resource conversion according to the embodiments of the present invention;

FIG. 11 is a flowchart showing set-up of a user preferences file;

FIG. 12 is a diagram showing a data structure for a user preferences file;

FIGS. 13A-13F are a flowchart showing how a resource knowledge base is created for a resource;

FIGS. 14A-14C are a flowchart showing how a resource is converted to an accessible resource;

FIG. 15A is a chart showing the screen layout of an editor interface; and

FIG. 15B is a chart showing an image and dialog presented to the editor.

### DETAILED DESCRIPTION

Software for converting information from one format to another is well known. In the area of websites, a rendering engine converts a web page from its conventional form to a reformatted form based on user preferences.

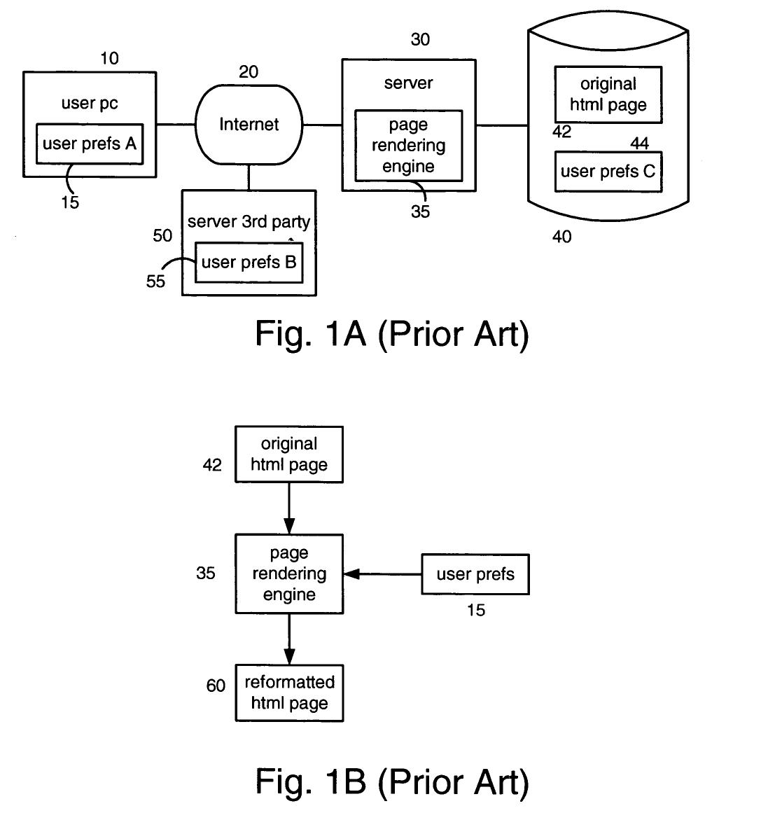

FIG. 1A depicts the environment of a conventional rendering engine. A user has personal computer 10 or other access device, such as a personal digital assistant (PDA), coupled to Internet 20. Using typical hypertext transfer protocol (http), the user sends a page request via Internet 20 to server 30, and server 30 responds with a page to be presented on the user's access device. Third party server 50 is also coupled to Internet 20.

Page rendering engine 35, comprising software executing on server 30, receives the page request, retrieves the original hypertext markup language (HTML) web page, and converts its format according to user preferences, which are stored at one or more of the user's access device, shown as user preferences 15, the server's data storage facility, shown as user preferences 44, and/or a third party website, shown as user preferences 55. The page rendering engine sends the reformatted web page to the user in response to the user's page request.

Conventional user preferences include user specified information, such as font size, device specific information, such as number of pixels in the display.

FIG. 1B is a diagram showing the above-described activity. Page 42 of a website is an input to page rendering engine 35. User preferences 15 are also an input to page rendering engine 35, which reformats page 42 in accordance with user preferences 15 to produce reformatted page 60.

A problem with the conventional rendering system is that it is completely unresponsive to the meaning of the website content. For example, if a bulleted list of items has red bullets indicating sale items, a conventionally rendered page for a user with a black-and-white display will only indicate that the bullet is red; the fact that the item is on sale will be transparent to the rendering. However, the fact that the item is on sale is probably much more important to the user than the color of the bullet. Another problem with the conventional rendering system is that to accommodate each new user scenario (learning disabled, flashing images aversion, forms of dyslexia), the rendering system itself and/or the resource creator's content must be revised.

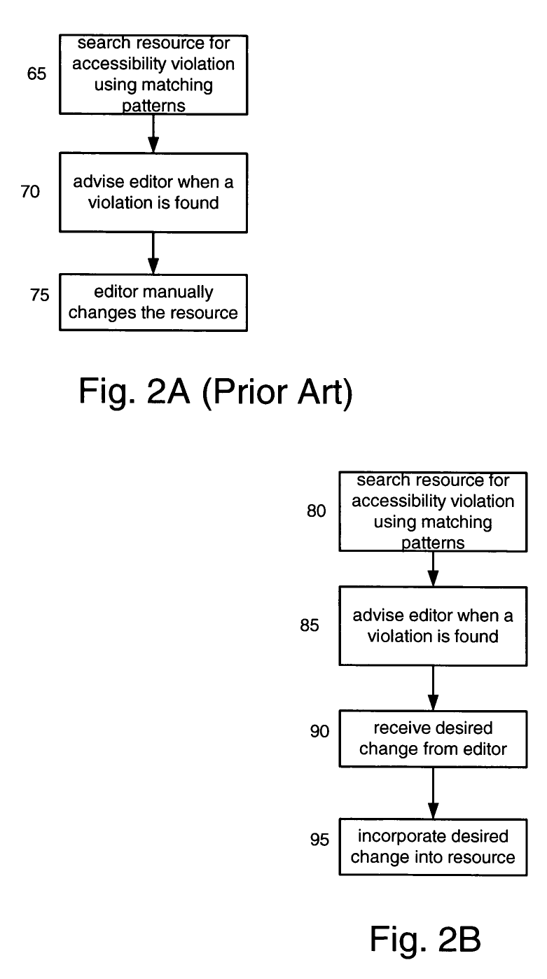

FIG. 2A is a chart showing processing activity in a prior art accessibility checker program, specifically, the Bobby program developed by Center for Applied Special Technology (CAST), supported by Watchfire in Waltham, Mass., and available at http://bobby.watchfire.com/bobby/html/en/indexjsp.

Bobby is a comprehensive web accessibility software tool designed to help expose and repair barriers to accessibility and encourage compliance with existing accessibility guidelines. Bobby tests for compliance with government standards, including the U.S. Government's Section 508. It offers prioritized suggestions based on the Web Content Accessibility Guidelines provided by the World Wide Web Consortium's (W3C) Web Access Initiative. Bobby allows developers to test web pages and generate summary reports highlighting critical accessibility issues before posting content to live servers. Bobby tests web pages using the guidelines established by the World Wide Web Consortium's (W3C) Web Access Initiative (WAI), as well as Section 508 guidelines from the Architectural and Transportation Barriers Compliance Board (Access Board) of the U.S. Federal Government.

Bobby is run by a user on a web directory that includes hypertext markup language (HTML) files. At step 65, the Bobby program searches a resource for accessibility violations using a set of patterns; if the code for a resource matches the patterns, then Bobby determines that an accessibility standards violation exists. At step 70, Bobby advises its user, an editor, that a violation has been found. At step 75, the user manually changes the resource to comply with the accessibility standards. This process repeats until there are no accessibility violations detected in the resource. Bobby is not completely accurate since it does not properly evaluate the content of various elements, such as alt-tags.

FIG. 2B is a chart showing processing activity in accessibility compliance programs, specifically, ACCVERIFY and ACCMONITOR from HiSoftware Solutions, available at http://www.hisoftware.com/access/vlndex.html. These accessibility compliance programs operate similarly to Bobby, but include a graphic interface that accepts fixes for accessibility violations and automatically revises the HTML code for the original resource to create a revised, accessible resource.

At step 80, the accessibility compliane program searches a resource for accessibility violations using a set of patterns; if the code for a resource matches the patterns, then the program determines that an accessibility standards violation exists. At step 85, the program advises its user, an editor, that a violation has been found. At step 90, the program receives a change from the editor that may enable the resource to comply with the accessibility standards. That is, although the editor supplies a change, nothing checks whether the editor's change actually cures the accessibility violation. Since few editors are experts on accessibility issues, it is likely that most editors supply inadequate or inappropriate information for at least some of their edits. At step 95, the program revises the resource to incorporate the editor's change. This process repeats until there are no accessibility violations detected in the resource.

Drawbacks of the above-described programs include:
The programs are driven by a list of accessibility violation patterns. If a problem is not one of the predefined patterns, it escapes the program's attention;
The programs merely describe instances where the resource includes an instance of a violation pattern, that is, no guidance is given to the editor as to how to best fix the violation. If the editor does not understand accessibility issues, then the editor's change is frequently inadequate or inappropriate;
The programs require that the original resource be changed to conform to accessibility guidelines. However, resource owners are typically very nervous about changes to the original resource, particularly since the editor doing the accessibility compliance may not understand why things were designed in the original resource;
The programs result in only one accessibility-compliant version of the resource. However, users that are differently disabled may require different versions: a deaf person requires all visual, a blind person prefers more text over images, a learning-disabled person usually prefers more images than text and so on. Thus, the end result of the programs will be suboptimal for almost all disabled users;
There is an inherent conflict between optimizing a resource for accessibility by various parties and providing a highly stylized design for a website; thus, the programs may interfere with the look and feel of the website intended by the author;
The programs have no way of evaluating the overall meaning or importance of a resource; and
The programs have limited ability to restructure a resource to improve its accessibility, either by simplifying the existing structure or by adding additional structure such as an index. The programs' restructuring typically depends on the resource being configured for restructuring, such as using XHTML headers rather than embedded font description information.

Thus, there is enormous room to improve the functionality of programs that improve the accessibility of resources.

A resource accessibility engine according to the present invention uses a resource-specific knowledge base and user preferences to convert a resource into an improved accessibility resource. Examples of a resource include a website, document, webpage image file, multimedia file, auditory file or any other text and/or non-text record. The resource-specific knowledge includes content and formatting information which reduces ambiguities, translates implied information into explicit information and improves the accessibility of the resource content for persons having perceptual disabilities/preferences and/or presentation devices with limited capabilities and other devices such as knowledge processing systems, translation engines and middleware. The user preferences represent the physical capabilities of the user's access device, and the user's semantic and personal preferences for how content should be displayed.

An editor uses an annotation wizard to create the resource-specific knowledge base based on the original resource. The annotation wizard uses rules for guiding the editor through providing knowledge, specifically, providing explicit knowledge that is missing, converting implicitly provided knowledge into explicit knowledge, and confirming that the annotation wizard's rules are properly interpreting the meaning of content in the resource.

Advantages of programs according to the present invention include:
The present programs are driven by levels of information organization to engage an editor in a dialog about what is meant. Accordingly, everything not sufficiently understood is presented to the editor for review. This approach is fundamentally akin to “make sure everything is good enough”, and is much more powerful than the approach of the above-described programs of “find things known to be bad”.
The present programs guide the editor in at least the following ways:
   the present programs often guess what the correct information is, so that the editor can simply agree, or has a more directed way of providing the correct information; and
   the present programs prompt the editor for meaning at a variety of levels, for example, a description of an image might be “c inside a circle” while the meaning of the image is “there exists artistic expression protected by copyright”; and
   the present programs prompt the editor for implicit meaning, such as is conveyed by formatting information;
The present programs do not change the original resource. Instead, the present programs enable the user to dynamically create a version of the original resource best suited to the user's perceptual abilities, while leaving the original resource unchanged, which minimizes anxiety on the part of the resource owner;
The present programs produce a converted resource in accordance with the user's preferences, referred to herein as alternative renderings. Thus, the end result of the present programs will be optimal for each user's perceptual abilities;
The present programs have multiple ways of evaluating the overall meaning or importance of a resource:
   directly asking the editor, usually via a series of simple questions;
   guessing, and asking the editor to evaluate the correctness of the guess;
   guessing with a sufficiently high degree of certainty that editor confirmation is not needed, although the editor is always welcome to edit;
   giving the editor multiple opportunities to describe a single portion of the resource, spurring the editor to think more carefully about the portion and thus provide more information;
   the present programs assign roles, defined in the RDF statements, to portions of the resource, which helps organize the editor's description of the portions. A role represents how an element or section of a resource is used within the context of the resource and the function it performs. A role is expressed in computer-comprehensible form so they are inherently extendable, and new roles can be derived from existing roles, and the relationships between roles can also be defined in a programmatically understandable way. This is useful in groups that need their own type of content, e.g., an educational community may have a “tutor” button. The role of tutor can be derived from the role of help, as tutoring is a special case of helping. Rendering agents that do not know how to deal with the tutor role can deal with it as a help role. Specialized rendering agents will be able to properly use the special meaning of tutor as compared to help;
The present programs can change the structure of the converted resource relative to the original resource by providing additional structure such as a intra-page map showing how the portions of a long page are related, or an inter-page map showing how the pages of a resource are related;
The present programs can substantially change content in alternative renderings, in a way that would be unacceptable to the resource owner if the changes were applied to the original resource; these substantial changes require understanding the meaning of the resource, the relative importance of resource elements and similar concepts. Examples of this type of rendering include replacing text with symbols and simple words, and removing or hiding less important content, replacing ambiguous wording such as predicates and confusing word ambiguities with clear terms, providing extra help or text when it aids comprehension;
The present programs enable new types of transformations to be employed to create new types of renderings without requiring any new knowledge from the editor or user. For example, if a new method of displaying complex content to blind persons becomes available, the new method can be applied to existing resources based on the resource's knowledge base;
The present programs enable a third party to make a resource accessible even if the third party is unable to modify the original resource due to the non-invasive nature of the present programs;
The present programs re-use knowledge supplied by an editor to minimize the burden on the editor. For example, an editor needs to enter the expansion of an acronym only once, and thereafter the program uses the already-supplied definition instead of asking the editor to define the acronym again.

The following terms are used herein: a “user” is someone who wants a resource presented to them, preferably in accessible form in view of the user's perceptual preferences and abilities. An “author” is someone who created a resource. An “editor” is someone who interacts with an annotation wizard according to the present invention to provide information so that the resource can be presented in accessible form; the editor may, but need not be, the same person as the author.

The present invention uses techniques from the so-called semantic web to add knowledge to resources so that programs can better interact with the resources:
unique fragment identifiers or resource identifiers such as uniform resource identifiers (URIs) identify resources in general, both resources that are network retrievable and have a uniform resource locator (URL), and resources that are not network retrievable such as a person or a tangible thing. Unlike traditional RDF, discussed below, the invention is not limited in its use of identifiers to extensible markup language (XML) compatible identifiers; for example, by mapping cascaded style sheets to XML, the mapped cascaded style sheets can be identified. In other words, a mechanism for pointing is needed, and the mechanism can be other than XML;
resource description framework (RDF), discussed below, is used for capturing meaning and relationship in content;
an ontology, or list of terms used in RDF statements that specify a variety of relationship among data elements and ways of making logical inferences among them; and
An optional XML based platform for converted resource that contains tags and attributes for adding extra knowledge from the RDF statements to the XHTML or similar resource.

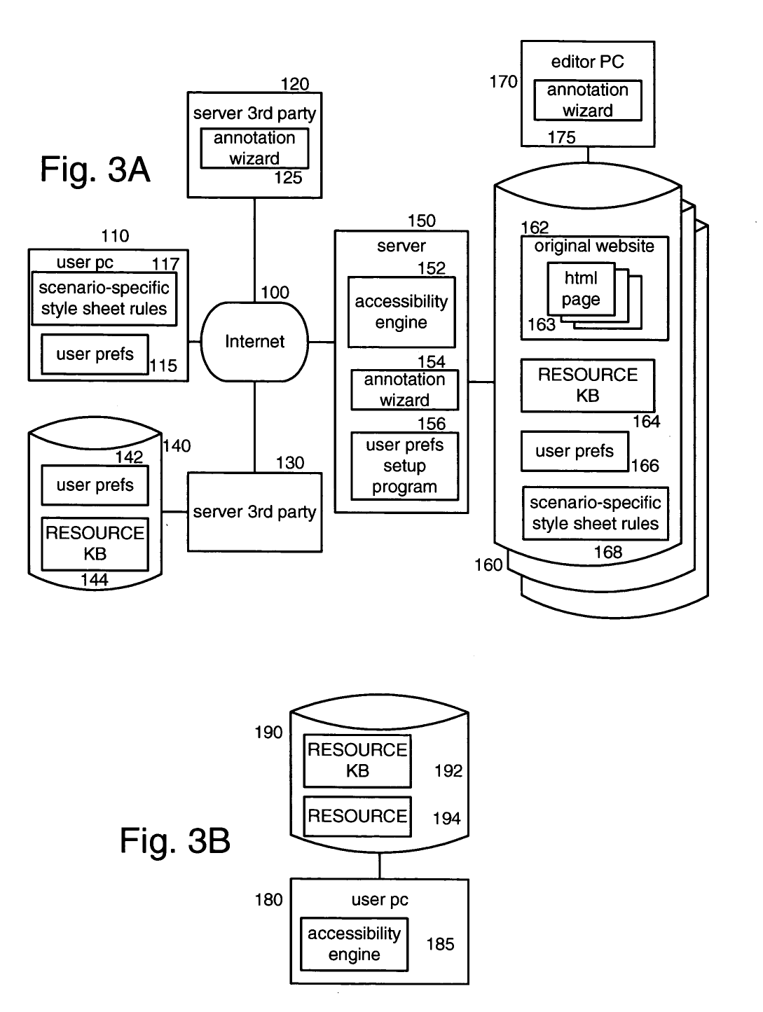

FIGS. 3A-3B are diagrams showing example configurations in which the present invention is applied. FIG. 3A shows a configuration involving the Internet, while FIG. 3B shows a standalone configuration.

FIG. 3A shows Internet 100 coupled to user personal computer (pc) 110, third party servers 120, 130 and accessibility server 150. A personal computer is a general purpose computer having an operating system and a web browser.

Server 150 is a general purpose computer or set of computers having storage 160 coupled thereto. Storage 160 is one or more high volume storage devices employing magnetic, optical, or any other suitable devices. Editor pc 170 is also coupled to storage 160. Any suitable coupling technique may be used, for example, a local area network may connect server 150, storage 160 and editor pc 170.

Server 150 functions to execute software programs, in particular, accessibility engine 152, annotation wizard 154 and user preferences setup program 156, as well as conventional web-server programs (not shown). Annotation wizard 154 is used by an editor to set up a knowledge base for a resource, so that accessibility engine 152 can apply the knowledge base to the resource to create a converted resource having improved accessibility. Annotation wizard 154 is used during a set-up phase. Accessibility engine 152 is called by annotation wizard 154 during the set-up phase, discussed below. Accessibility engine 152 is used by a user either dynamically, in real time, or at a preparation time, depending on the nature of the resource and user convenience. The exact locations of wizard 154 and engine 152 are not important. For example, the accessibility engine could be located on the user's pc, as is the case with accessibility engine 185 in FIG. 3B; and the annotation wizard can be located at editor pc 170, as is the case with annotation wizard 175, or on third party server 120, as is the case with annotation wizard 125.

User preferences setup program 156 is needed only if a user preferences file must be setup. In other cases, user preferences setup program 156 is omitted.

Storage 160 functions to store a resource—such as website 162—comprising pages 163 of hypertext markup language (HTML) code, resource knowledge base 164 relating to a specific resource such as website 162, user preferences 166, and scenario-specific style sheet rules 168. The exact locations of the resource, knowledge base, user preferences and scenario-specific style sheet rules are not important. For example, the resource could be at a third party server or distributed to users on a recording medium, as discussed with regard to FIG. 3B; the resource knowledge base could be on a third party server, as is the case with resource kb 144; and the user preferences can be on a third party server, as is the case with user preferences 142, or on user pc 100, as is the case with user preferences 175. More specifically, the user preferences can be an explicit file, included in a user's profile that is part of another party's data, or dynamically expressed through selections such as from a drop-down menu. The scenario-specific style sheet rules are typically proximate to an accessibility engine. FIG. 3A shows user pc 110 having scenario-specific style sheet rules 117; in other embodiments, user pc 110 does not have scenario-specific style sheet rules at its location. Optionally, a resource could have its own scenario-specific style sheet rules.

FIG. 3B corresponds to a situation where a content provider distributes recording medium 190 such as a compact disc (CD) having recorded thereon resource 192, such as a multimedia book, resource knowledge base 192 and an executable version of accessibility engine 185 that is loaded into user pc 180. As used herein, a resource is “local” to a user when the resource is accessible directly from the user's computer, without using the Internet. Thus, if a user uses a resource on a local area network or virtual private network that is private to an enterprise, the resource is local to the user.

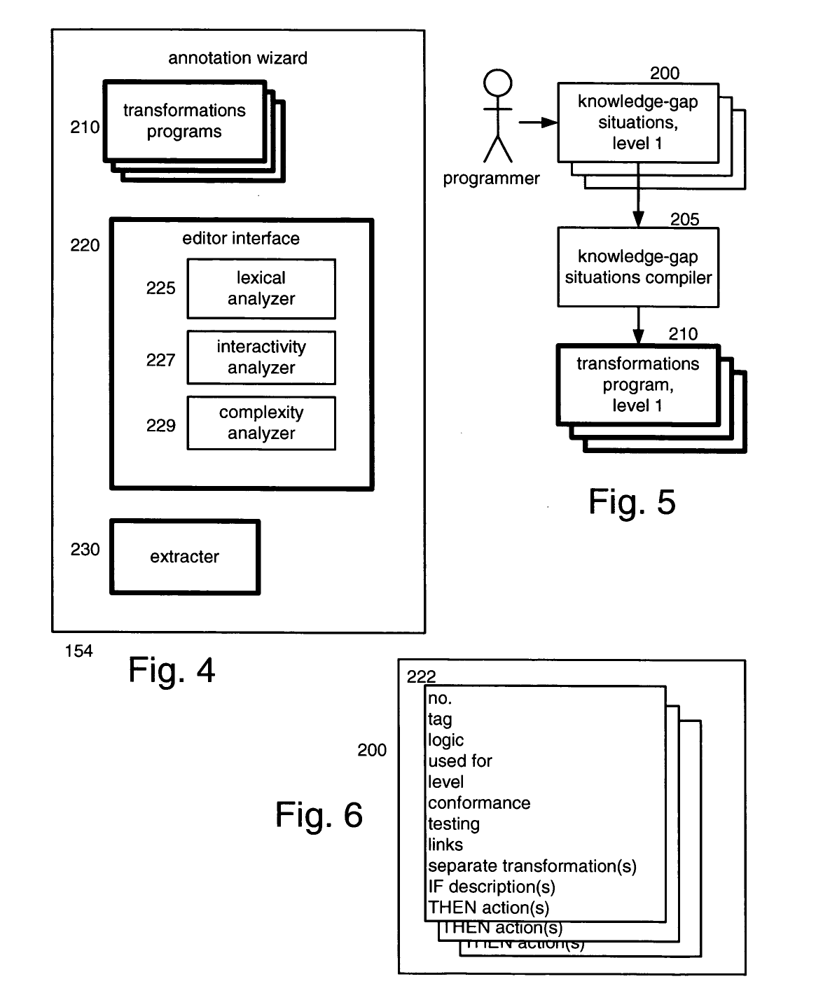

FIGS. 4-9 describe creation of the resource knowledge base, and are discussed below.

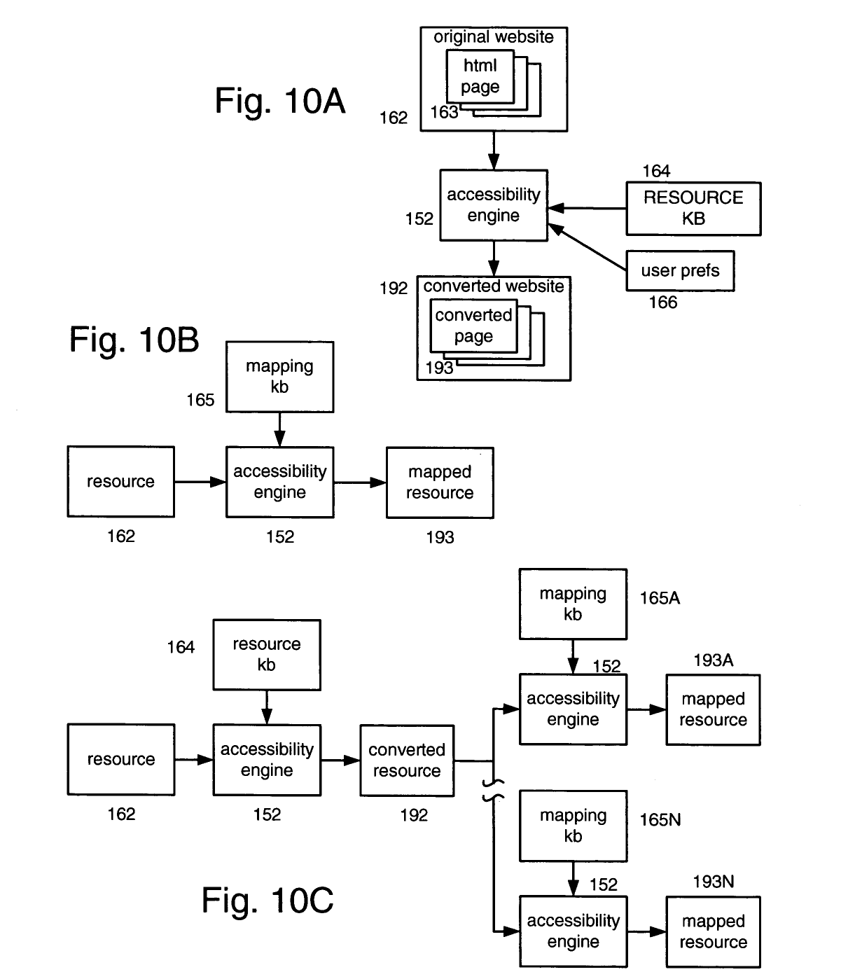

As shown in FIG. 10A, accessibility engine 152 (or accessibility engine 185 in the case of FIG. 3B) uses as inputs website 162 (or resource 190 in the case of FIG. 3B), resource knowledge base 164 (or resource knowledge base 192 in the case of FIG. 3B) and user preferences file 166 (chosen dynamically, rather than from a file, in the case of FIG. 3B), to create converted resource 192 that includes knowledge necessary for proper presentation to the user in accordance with the user's perceptual preferences and/or end device presentation capabilities. Converted resource 192 is then presented to the user by the user's presentation device (user pc 180, in the case of FIG. 3B).

In some embodiments, instead of the knowledge base being directed to a specific resource, the knowledge base can be directed to how to map from one format to another; in this case, the knowledge base is referred to as a “mapping kb”. Examples of format pairs include WORD to WORDPERFECT, HTML to XML, Flex or Flash (www.macromedia.com) to Xforms (www.w3c.org) and so on.

FIG. 10B shows resource 162 and mapping kb 165 supplied to accessibility engine 152, which functions to create mapped resource 193 by applying the mapping information in mapping kb 165 to the elements of resource 162.

The resource knowledge and the mapping knowledge can be combined sequentially. FIG. 10C shows resource 162 and resource kb 164 supplied to accessibility engine 152 which functions to create converted resource 192. Next, a variety of mappings represented by mapping kb 165A . . . mapping kb 165N are supplied with respective copies of converted resource 192 to instances of accessibility engine 152 which functions to create respective mapped resources 193A . . . 193N.

An example of using this flexibility is as follows. A newsfeed really simple syndication (RSS) provider can provide a knowledge base accompanying the RSS feed, so that any content provider incorporating the RSS feed can use the feed in alternative renderings or in an alternative form.

The process of creating a knowledge base will now be discussed. Although an automated process is described, it will be appreciated that a knowledge base can be created manually or through a different process such as integration with resource authoring tools.

FIG. 4 is a chart showing the components of an annotation wizard: transformations programs 210, editor interface 220 and extracter 230.

Transformations programs 210 are fact-specific programs incorporating expertise about how to analyze different resources, identify knowledge gaps that indicate missing information and make implicit information into explicit information. Transformations programs 210 assume that human editors are unaware of various accessibility guidelines and the problems encountered by people lacking “normal” perceptual abilities and/or having disabilities, so transformation programs 210 function to meticulously comb through resources to find situations, referred to herein as knowledge gaps, where meaning can be readily augmented by a dialog with a human editor, and to collect the knowledge into a resource knowledge base. Using a knowledge base to address the knowledge gaps is an important aspect of how the present invention is able to convert a resource to convey clearer meaning in the resource to a user.

Editor interface 220 functions to present dialog regarding the output of transformations programs 210 to a human editor. Transformations programs 210 may operate in parallel, both for their own program modules and on different portions of a resource, so processing time is reduced. Additionally, the dialogs often present both resource code and screen displays corresponding to the resource code to an editor; editor interface 220 is responsible for managing the information flow to and from the human editor.

Editor interface includes lexical analyzer 225, interactivity analyzer 227 and complexity analyzer 229. Each analyzer can be used in standalone form. In some embodiments, each analyzer is a separate “plug-in” for another program such as a third-party website editing tool.

Lexical analyzer 225 uses cascaded lexicons to define the meaning of a word. A lexicon is a file having at least one word and an associated meaning for the word. Generally, there is a default lexicon, and optional editor-indicated special lexicons. Any number of special lexicons can be cascaded. The editor specifies the priority of the cascaded lexicons, which may differ by location in the resource. Editor interface 220 enables the editor to place a cursor over words in the resource and see the meaning assigned to the word; if the editor wishes to override a meaning, or supply a missing meaning, the editor's knowledge is captured as a new lexicon entry.

Lexicons can be selected by the editor based on the intended user, such as age group, educational level, and so on.

Symbol lexicons function in similar manner. An example of a symbol is an “i” inside a circle, meaning “information (help) is available here”. Another example of a symbol is a “c” inside a circle, meaning “protected by copyright”. Symbol lexicons are particularly useful for autistic children, who may have a vocabulary of 200 words and 500 symbols.

Interactivity analyzer 227 helps convert interactive content, such as Macromedia Flash files, to accessible content. Editor interface 220 collects at least the following information from the resource and the editor:
Element integrity (what is a page, what is an element);
Conditions (time, state—like selected, values);
Data types/role of data and form controls (like Date Email . . . );
Action types/role of data and form controls (Submit Validate . . . );
Hierarchal information (like Heading Label . . . );
Other relationships and roles (help, glossary);
Event information ( Focus, Mouse click . . . );
Text equivalencies;
Presentational information;
   and the interaction between them.

Complexity analyzer 229 serves to simplify complicated text. Complexity analyzer 229 parses the resource using a simple language dictionary; if there are difficult words, analyzer 229 suggests simpler words to the editor, and adds the editor's response to resource kb 164. This allows an editor to see where simple words have been used, and when they have not. When a simple word has not been used the editor can supply a simple alternative or glossary entry. Complexity analyzer 229 parses the resource for long sentences and complex word and sentence structures and the like, suggests areas for simplification to the editor, and adds the editor's response to resource kb 164. Complexity analyzer 229 parses the resource for long paragraphs that require high comprehension ability, and if they exist, suggests areas for simplification to the editor, and adds the editor's response to resource kb 164.

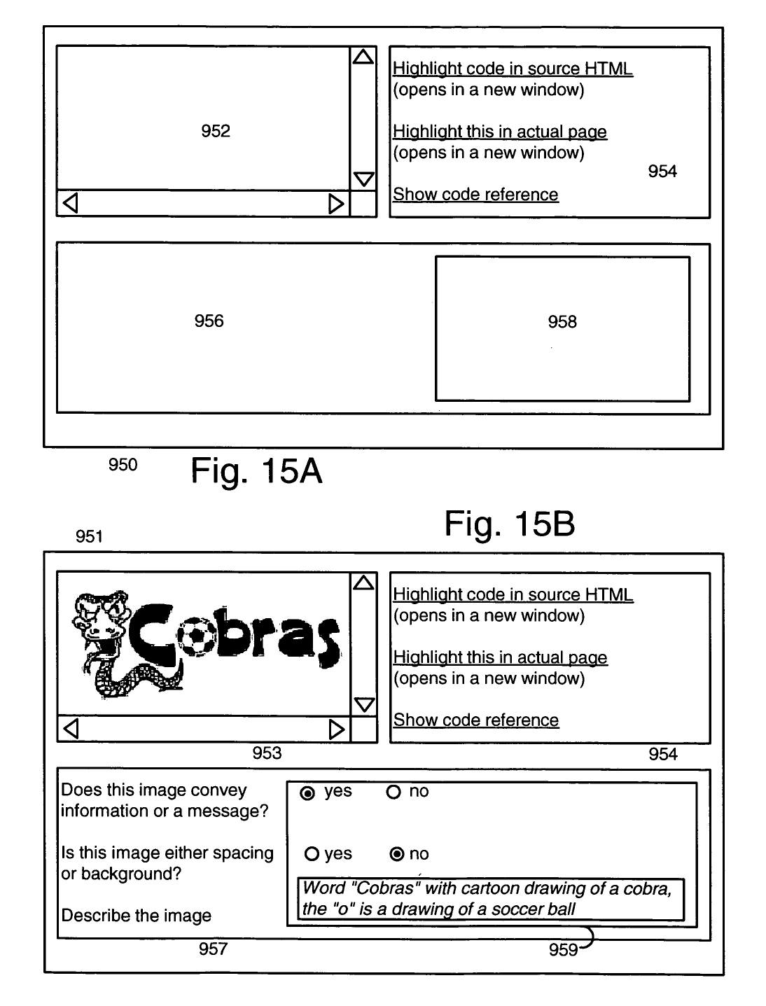

FIG. 15A is a chart showing the screen layout of an editor interface. Display 950 includes window 952 for presenting an element for which knowledge is being obtained from the editor, window 954 including hyperlinks for providing more detail about the element in window 952, window 956 for providing text from annotation wizard 154 to the editor, and window 958 for receiving input from the editor.

FIG. 15B is a chart showing an instance of image and dialog presented to the editor. Display 957 includes window 953 showing an image for which knowledge is being obtained. Window 957 shows dialog from annotation wizard 154 to the editor. Window 959 provides sequentially presented “radio buttons” for the editor to answer yes or no to the dialog questions, and provides a text box for free-form text entry. In this example, the editor has entered text describing the image as “Word “Cobras” with cartoon drawing of a cobra, the “o” is a drawing of a soccer ball.” In a subsequent dialog screen, the editor provides the additional information that this image is the logo for a soccer team having the team name is “Cobras”. The sequence of dialog depends on the editor's input. In this way, the questions guide the editor into providing the correct knowledge.

Extracter 230 functions to convert the intermediate form of a knowledge base, used by annotation wizard 154, into a final form that is more efficiently used by an accessibility engine.

FIG. 5 is a chart showing how manually specified knowledge gaps are compiled into transformation programs 210.

A programmer manually creates and edits knowledge gap file 200 using conventional text editing tools. Knowledge gap file 200 is organized into multiple levels, such as eight levels; in different embodiments different organizations and numbers of levels are used. The levels of the knowledge gap file 200 are used for sequencing the discovery of knowledge.

Accessibility standards are typically organized into levels or priorities; knowledge gap file 200 accommodates many standards, so its organization does not necessarily directly correspond to the organization of any of the accessibility standards. When using annotation wizard 154, an editor can indicate that only knowledge needed to satisfy a certain accessibility compliance level or task should be obtained, to avoid the lengthy process of providing knowledge for all possible gaps.

The conformance levels of accessibility standards are distinct from and essentially independent of the levels of the knowledge gap file 200.

FIG. 6 is a diagram showing a data structure for knowledge gap file 200, which comprises knowledge gap records 222. Knowledge gap file 200 is also referred to as master transformations file (MTF) 220. Each knowledge gap record has the information shown in Table 2.

TABLE 2

| field | meaning |
|---|---|
| number | A unique number also referred to as a transformation number, assigned to |
| | each knowledge gap record, also referred to as a transformation record. |
| tag | Indicates the HTML tag that this knowledge gap record relates to. For |
| | example, a knowledge gap record relating to an HTML image (“img”) |
| | tag would be applicable to the following HTML code: |
| | <img SRC=“images/bb1.gif” > |
| logic | Essentially, a comment for programmers reading the file, describing what |
| | the transformation record is trying to do, that is, what kind of conversion |
| | should be applied to the resource. |
| used for | Knowledge gap and accessibility issues that the knowledge to be |
| | obtained from the editor is used for. |
| level | The knowledge gap (transformations) records are organized into levels |
| | that determine processing order. This field indicates the level that the |
| | instant record corresponds to. |
| conformance | Indicates the various standards checkpoints and so on that correspond to |
| | the transformation in this knowledge gap record. |
| testing | If a report of knowledge gaps is to be produced, then the comment found |
| | in the testing field is what is included in the knowledge gap report if this |
| | type of knowledge gap is found. |
| links | Hyperlinks to information about the accessibility violation that this |
| | knowledge gap is relevant to. |
| separate | Separate transformation is a rule that indicates characteristics of a new |
| transformation(s) | occurrence of a situation; if this occurrence exists in the resource, then a |
| | knowledge gap exists each time that situation addressed by the |
| | knowledge gap record is found. In contrast, if no separate transformation |
| | is specified, then the knowledge supplied at the first occurrence of the |
| | situation is assumed to be useful in all other occurrences of the situation |
| | in the resource. That is, separate transformations indicate new |
| | knowledge gaps. |
| case | Indicates the specific situations that will trigger this transformation, that |
| | is, for a knowledge rule in the form IF (case) THEN (actions), the “case” |
| | part of the rule. |
| action | Indicates the specific actions for obtaining of knowledge that should be |
| | taken when this transformation is applied, that is, for a knowledge rule in |
| | the form IF (case) THEN (actions), the “actions” part of the rule. |
| | Actions typically are used to write RDF statements possibly with best |
| | guesses to encapsulate and encode missing knowledge. |

An instance of knowledge gap record 222 is shown in Table 3. This particular record is concerned with a situation where there is a hyperlink indicated by an image, but no text or “alt” information is associated with the image. WCAG checkpoint 1.1 (see Table 1), inter alia, requires that where there is an image with no text or “alt” information, then a text equivalent must be provided. This record specifies that in this situation, a knowledge entry is created associating alternative text of value “go to /page title/” where /page title/ is the title of the linked-to page.

```
TABLE 3
<transformation>
  <number>1.1.6</number>
  <tag>img</tag>
  <logic>locate images used as the content of a link. If no alt attribute and no link text are
provided for text equivalency, then provide useful Alternate content that directs the user to the
linked to page</logic>
  <usedFor>A</usedFor>
  <level>Transformations 2</level>
  <conformance>
  <WCAG01-p1/>
  <WCAG01-p2/>
  <WCAG01-guideline1/>
  <WCAG01-checkpoint1.1/>
  <Section508/>
  <Section508-paragraph22a/>
  <dependency-level2/>
  </conformance>
  <testing>
  <en>Missing text equivalent. (Suggestion: Put the name of the page that you are linking to in
the “alt” tags.)</en>
  </testing>
  <links>
  <WCAG01-text>http://www.w3.org/TR/WAI-WEBCONTENT-TECHS/#gl-provide-
equivalents</WCAG01-text>
  <Section508-text>http://www.access-board.gov/sec508/guide/1194.22.htm#(a)</Section508-
text>
  <WCAG01-examples>http://www.w3.org/TR/WCAG10-HTML-TECHS/#link-text-
images</WCAG01-examples>
  </links>
  <separateTransformation>
  <description>an href of the ancestor A is unique</description>
  <information action=“distinct” name=“href” type=“attribute” path=“ancestor::a/”/>
  </separateTransformation>
  <separateTransformation>
  <description>a src of the image is unique</description>
  <information type=“attribute” name=“src” action=“distinct”/>
  </separateTransformation>
  <case>
  <description>an image is used as the content of a link and
      neither link text nor alt attribute is provided
      </description>
  <if type=“tag” name=“img” path=“//a/”/>
  <if action=“missing” name=“alt” path=“” type=“attribute”/>
  <if action=“empty” type=“content” path=“ancestor::a”/>
  </case>
  <action>
  <description>alternate text with value “go to URI” of the page</description>
  <then action=“Altext” path=“” type=“attribute”>
  <literal> go to </literal>
  <pattern>URL#pointer (descendant::title)</pattern>
  </then>
  </action>
</transformation>
```

Appendix A describes the knowledge gap records used in an embodiment of the invention. Table 4 shows the information provided for each of the knowledge gap records in Appendix A.

TABLE 4

| Field | Description |
|---|---|
| Transformation | A unique number assigned to each knowledge gap record, also referred to as |
| Number | a transformation record. |
| Dependency | The knowledge gap (transformations) records are organized into levels. This |
| | field indicates the level that the instant record corresponds to. |
| Knowledge gap | A description of the knowledge that is missing from the original resource so |
| | that the contents of the resource can be converted in a way that retains the |
| | meaning intended in the original. |
| Logic | An example of how the logic, described in the about field, might refer to an |
| | HTML document. |
| Used for | Knowledge gap and accessibility issues that the knowledge to be obtained |
| | from the editor is used for. |
| About | Description of what the transformation record is trying to do, that is, what |
| | kind of conversion should be applied to the resource. |
| Best guess | To make knowledge capture faster, the annotation wizard offers best guesses |
| | to the editor. The editor can change the best guesses. |
| Editor supplied | “None” if there is high confidence that the best guess is correct. Otherwise, a |
| knowledge | description of the knowledge to be gleaned from the editor. In either case, |
| | the editor can always edit knowledge responsive to a knowledge gap. |
| Example case | Examples of occurrences that would trigger the instant transformation in an |
| (HTML | HTML document. |
| description) | |
| Example use, | Example of how knowledge is applied to an HTML page to make a WCAG |
| WCAG | conformant page. |
| description | |

Knowledge gap compiler 205 converts knowledge gap file 200 into transformations programs 210. Knowledge gap compiler 205 operates on the entire set of knowledge gap records 222 to generate transformations programs 210.

Transformations programs 210 function to enable a computer to recognize knowledge gap situations in a file. The knowledge gap situations include situations where knowledge is simply missing and explicitly needs to be provided, situations where it appears there is implicit knowledge in the resource, and a human editor needs to be prompted to provide the knowledge, and situations where there is missing knowledge but enough context for the computer to guess what the knowledge is. The situations where the computer guesses knowledge are either “high confidence” situations where the editor need not confirm the guessed knowledge—but always may overwrite the guessed knowledge—or “other” situations where a human editor needs to confirm or correct the guess.

Transformations programs 210 are organized into levels corresponding to the levels of knowledge gap file 200. Each level is sometimes referred to herein as a separate transformations program for a respective level. For example, if there are eight levels, there is a set of transformations programs 211, 212, 213, . . . 218. However, each transformations program is actually a portion of an organic entity, the set of transformations programs 210.

Transformations programs 210 additionally function to create a “starter” resource knowledge base comprising records corresponding to each missing knowledge gap and best guesses as to knowledge to fill the knowledge gaps. The starter resource knowledge base is augmented with knowledge collected from the human editor. Each level of transformations program may use knowledge collected from a previous level in determining whether there is a knowledge gap. Accordingly, although some transformation programs may be executed in parallel, there are some transformations programs that must be executed according to a sequential schedule. There is a project plan file (not shown) used by annotation wizard 154 to ensure proper scheduling during parallel processing. The project plan file is created by a human programmer and reused for different resources of the same type; when a new level of processing is added, then the project plan is modified.

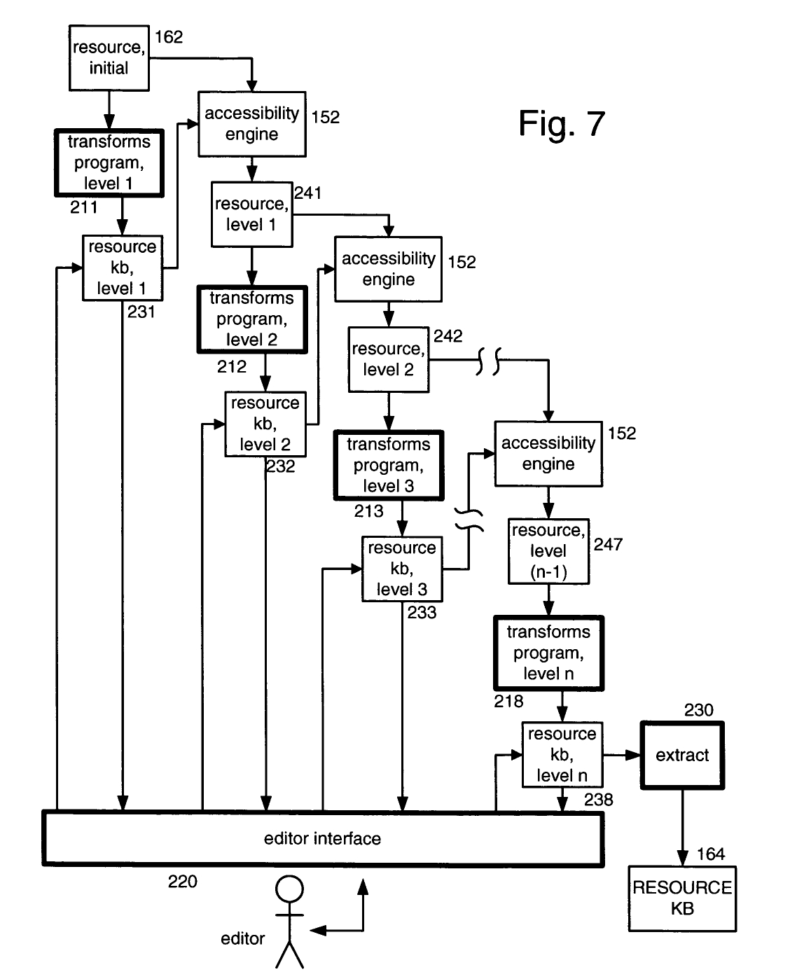

FIG. 7 is a chart showing the activity involved in creating a resource knowledge base. Annotation wizard 154 is invoked by a human editor to process resource 162, which serves as an initial resource. Transformations program level one 211 is executed on the initial resource to create resource knowledge base (kb) level one 231. After transformations program level one 211 has been run, annotation wizard 154 causes editor interface 220 to engage in a dialog with a human editor to obtain information and confirm guessed information.

Accessibility engine 152 is invoked by annotation wizard 154 to process the initial resource and resource kb level one 231 to generate resource level one 241, corresponding to the initial resource augmented with the knowledge provided by transformations program level one 211. Transformations program level two 212 is executed on resource level one 241 to create resource kb level two 232. After transformations program level two 212 has been run, annotation wizard 154 causes editor interface 220 to engage in a dialog with a human editor to obtain information and confirm guessed information.

Accessibility engine 152 is invoked by annotation wizard 154 to process the resource level one 241 and resource kb level two 232 to generate resource level two 242, corresponding to the initial resource augmented with the knowledge provided by transformations programs levels one and two 211, 212. Transformations program level three 213 is executed on resource level two 242 to create resource kb level three 233. After transformations program level three 213 has been run, annotation wizard 154 causes editor interface 220 to engage in a dialog with a human editor to obtain information and confirm guessed information.

Accessibility engine 152 is invoked by annotation wizard 154 to process the resource level two 242 and resource kb level three 233 to generate resource level three 243, corresponding to the initial resource augmented with the knowledge provided by transformations programs levels one, two and three 211, 212, 213. Transformations program level four 214 is executed on resource level three 243 to create resource kb level four 234. After transformations program level four 214 has been run, annotation wizard 154 causes editor interface 220 to engage in a dialog with a human editor to obtain information and confirm guessed information.

This processing sequence continues until the nth level of transformations program, in this example, transformations program level eight 218, is executed on resource level seven 247 to create resource kb level eight 238. Annotation wizard 154 causes editor interface 220 to engage in a dialog with a human editor to obtain information and confirm guessed information.

Extracter 230 then extracts relevant information from resource kb level eight 238, specifically, applicable graphs 262, to create a final resource knowledge base, in this example, resource kb 164. If a resource is configured with components, such as pages, groups of pages with a lot of common content, separate knowledge bases can be created for the respective components; this provides the advantage of enabling only a selected portion of a resource to have its accessibility improved, and another advantage of making the knowledge quicker to apply.

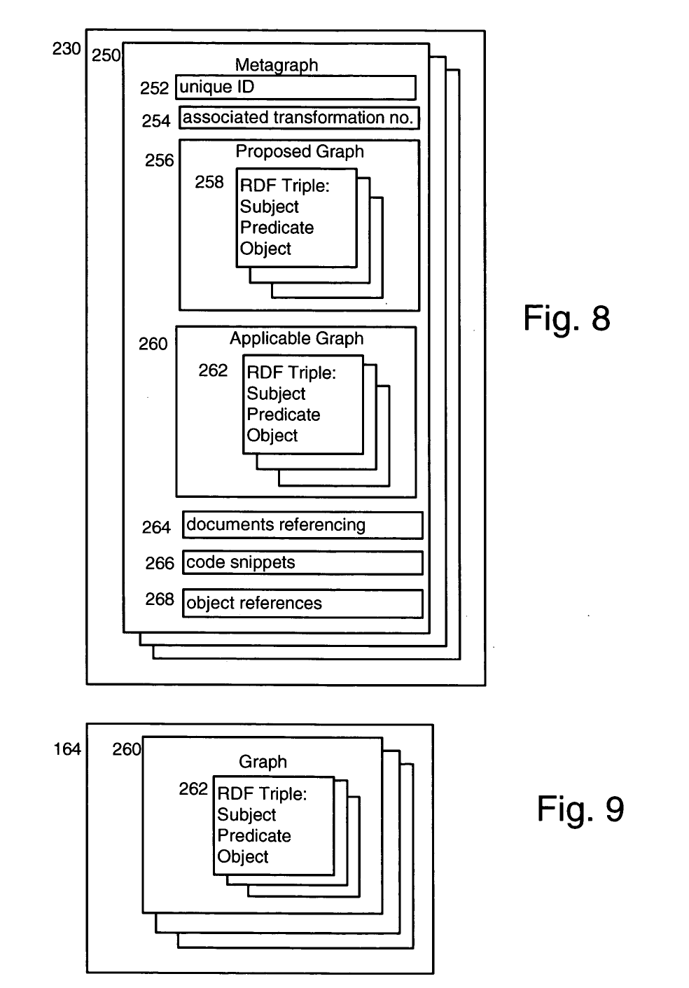

FIG. 8 is a diagram showing data structures for the intermediate levels of resource kb 230, that is resource kb levels one, two, three . . . eight 231, 232, 233 . . . 238. Intermediate resource kb 230 is a set of metagraphs 250. Each metagraph 250 has the information shown in Table 5.

TABLE 5

| field | meaning |
|---|---|
| unique ID | A unique number assigned to each metagraph. |
| associated | Number of the knowledge gap rule (see Appendix A) associated with |
| transformation | constructing this metagraph. |
| number | |
| proposed graph | Best guess of knowledge that fills the knowledge gap, written in RDF |
| | form. |
| applicable graph | The knowledge that fills the knowledge gap, being the best guess, the |
| | best guess confirmed by the editor, explicit knowledge supplied by the |
| | editor and/or implicit knowledge supplied by the editor, written in RDF |
| | form. |
| documents | The individual documents that the knowledge applied to, across a website |
| referencing | or document collection. |
| code snippet | The code for the element that is the subject of the metagraph. The code |
| | snippet is used by editor interface 220 to show the editor the element that |
| | is the subject of the editing. |
| object references | Reference to the equivalent of the code snippet in the application |
| | memory, for fast referencing and processing. |

Resource description framework (RDF) is described in detail at http://www.w3.org/RDF/. RDF is a language for representing information about resources in the World Wide Web. By generalizing the concept of a “Web resource”, RDF can also be used to represent information about things that can be identified, even when they cannot be directly retrieved on the Web. RDF is intended for situations in which this information needs to be processed by applications, rather than being only displayed to people. RDF provides a common framework for expressing this information so it can be exchanged between applications without loss of meaning. RDF is based on the idea of identifying things using Web identifiers, such as Uniform Resource Identifiers, or URIs, and describing resources in terms of simple properties and property values. This enables RDF in its simplest form to represent simple statements about resources as a graph of nodes and arcs representing the resources, and their properties and values. Sometimes it is not convenient to draw graphs when discussing them, so an alternative way of writing down the statements, called triples, is also used. In the triples notation, each statement in the graph is written as a simple triple of subject, predicate, and object, in that order. Each triple corresponds to a single arc in the graph, complete with the arc's beginning and ending nodes (the subject and object of the statement).

An example of an RDF triple is as follows:

<http://www.example.org/index.html>
<http://www.example.org/terms/creation-date>
“August 16, 1999”.

This RDF triple represents the knowledge that the resource index.html was created on Aug. 16, 1999.

FIG. 9 is a diagram showing the data structure for final resource knowledge base 164. Resource kb 164 comprises applicable graphs 260 from metagraphs 250. Thus, it will be appreciated that extracter 230 functions to simply copy applicable graphs 260 from metagraphs 250 into a separate file that is resource kb 164.

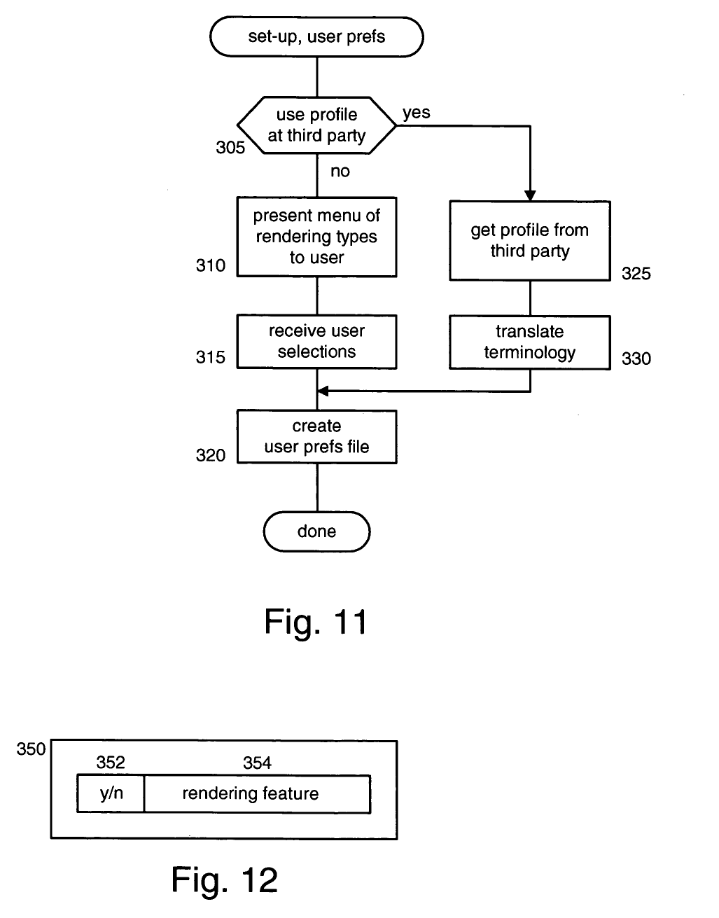

FIGS. 10A-10C are discussed above. FIG. 11 is a flowchart showing set-up of a user preferences file.

At step 305, user preferences setup program 156 determines whether to use a profile for the user maintained by a third party based on input from the user. In some embodiments, this step is automatically established for groups or users known to be likely to have such profiles, such as a group of students. If so, at step 325, user preferences setup program 156 gets the profile from the third party, and at step 330, user preferences setup program 156 translates the terminology of the third party profile into local terminology by mapping the third party profile's known terms to the options offered by the accessibility-improved resource and combination of scenario-specific transformations. Processing continues at step 320.

As used herein, a “pipeline” refers to a combination of scenario-specific transformations, which are different than the transformations discussed above for obtaining knowledge to fill knowledge gaps.

If a third party profile is not to be used, at step 310, user preferences setup program 156 presents a menu of different rendering features to the user; exemplary rendering features are shown in Table 6, discussed below. At step 315, user preferences setup program 156 receives the user's selections. In some embodiments a user preferences set up file is not used at all and the user is directed to an alternate rendering by activating a link on the resource.

At step 320, user preferences setup program 156 creates the user preferences file, and processing is complete.

FIG. 12 is a diagram showing a data structure for user preferences file 350, which comprises records having flag field 352 and feature field 354. Flag field 352 is set to a binary value, such as “yes” or “no”, or “0” or “1”, or “true” or “false”, indicating whether the feature in feature field 354 is or is not desired by the user. Feature field 354 indicates a rendering preferences of the user. Table 6 shows representative values for feature field 354.

TABLE 6

| Field | Meaning |
|---|---|
| BW | This style is used for black and white renderings. It changes all the layout |
| | attributes to black and white as well as changes the links for any external |
| | stylesheet to connect to the black and white version of the stylesheet. In |
| | addition it redirects the images to go through a grayscale image filter that |
| | increases contrast. |
| disableColors | This style is also used for black and white renderings. It deletes all the |
| | color attributes used in the page, so that all color information will be only |
| | in the external stylesheet for black and white rendering. |
| linearizeTables | This stylesheet is used for linear rendering. It eliminates all the tables and |
| | creates a linear version of the page. |
| AccessKeys | This stylesheet is used for all the renderings except the pagemap and true |
| | text rendering. It deletes the text of the access keys or author preferred |
| | keyboard shortcuts written in the converted resource element, in order |
| | not to change the look of the page. An access key is a predetermined |
| | keyboard sequence that provides a shortcut to a destination, for example |
| | “alt-H” for the home page. Access keys are very important to users |
| | lacking a mouse, and to blind users who want to navigate other than by |
| | tabbing through a resource. |
| Basic | This stylesheet is used for all the renderings. It deletes the unnecessary or |
| | obsolete tags and attributes, as well as irrelevant or used converted |
| | resource attributes. |
| ClarifiedText | This stylesheet is used for simple text rendering. For each element that |
| | has an offshoot of the converted resource alternative tag with |
| | clarifiedText, it replaces the content of the original tag with the content |
| | of the alternative tag. Clarified text is an alternative clearer version of |
| | the text of a resource element. |
| CSS (Cascaded Style | This stylesheet is used for all the renderings. It deletes all the style and |
| Sheet) | layout tags as well as the attributes used in the page. All the layout and |
| | style information should by then be in the external stylesheet. A |
| | transformation is sometimes referred to as a style sheet. A cascaded style |
| | sheet is not a transformation. |
| Enhanced | The result of this rendering is insertion of a chunk of text at the start of a |
| Navigation | page, with the chunk comprising the hyperlinks to the headings and sub- |
| | headings of the page and blocks of content such as menus and sub menus, |
| | akin to a table of contents. |
| PageMap | A page map rendering creates a section at the beginning of a page with an |
| | interactive schematic diagram of a web resource or rerenders the |
| | document in pictorial form. This stylesheet creates a pagemap section at |
| | the beginning of the page with links to all the sections identified as |
| | ‘pagemap blocks’, as well as to all the headings on the page. The result |
| | of this stylesheet is a graph of boxes, with the page title being in the |
| | central box, main headings being in respective boxes connected directly |
| | to the central box, and sub-headings being in respective boxes connected |
| | directly to their main heading. This format graphically depicts how the |
| | sections of a document are related. |
| TrueText | This stylesheet is used for true text renderings. It replaces all the images |
| | with alternative text on the page with a text box. If the image is inside a |
| | link, or is part of an image map, then a link will be created. |
| CleanUp | Removes unwanted features and tags from the converted resource that |
| | are not needed by the end user, such as alternative clarified text that will |
| | not be seen by the average user. |

It will be appreciated that in some cases, multiple renderings are desired by a user, such as “bw” and “pagemap”.

Operation of the annotation wizard to create a resource knowledge base will now be discussed. In some embodiments, different interfaces and/or processes are more useful for filling knowledge gaps than the particular interface and process described below.

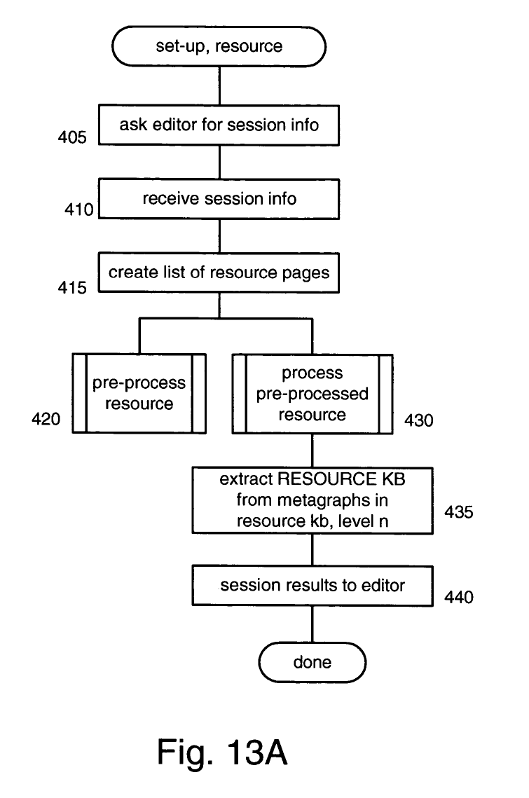

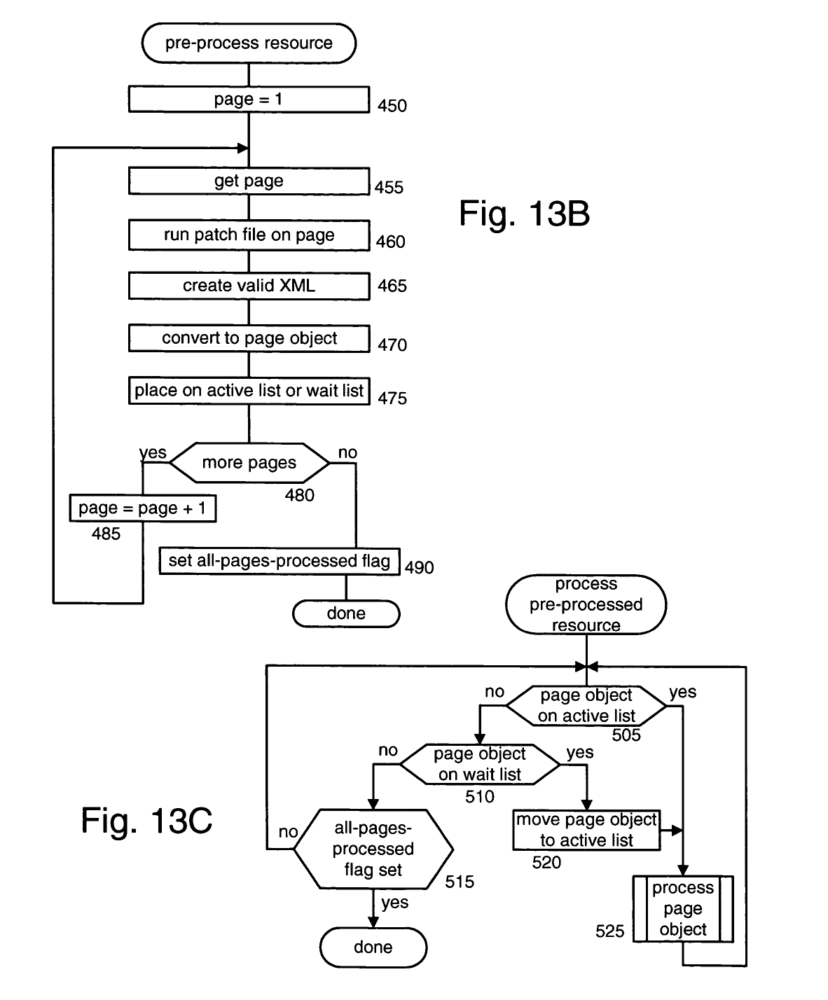

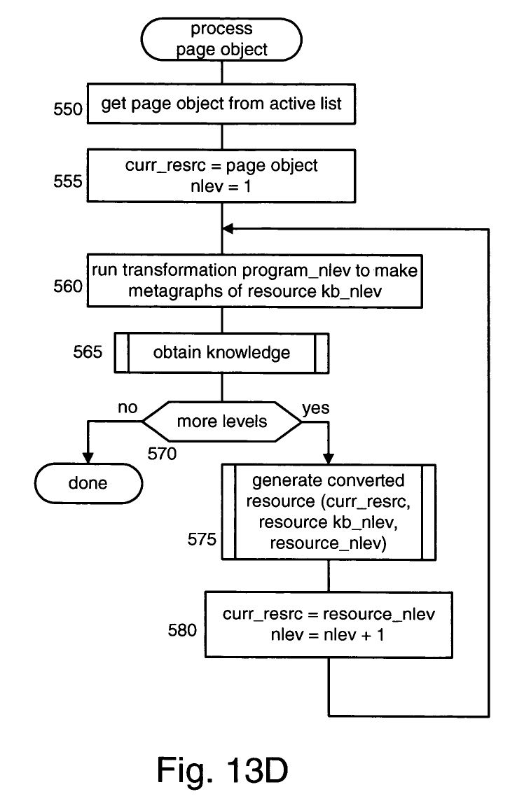

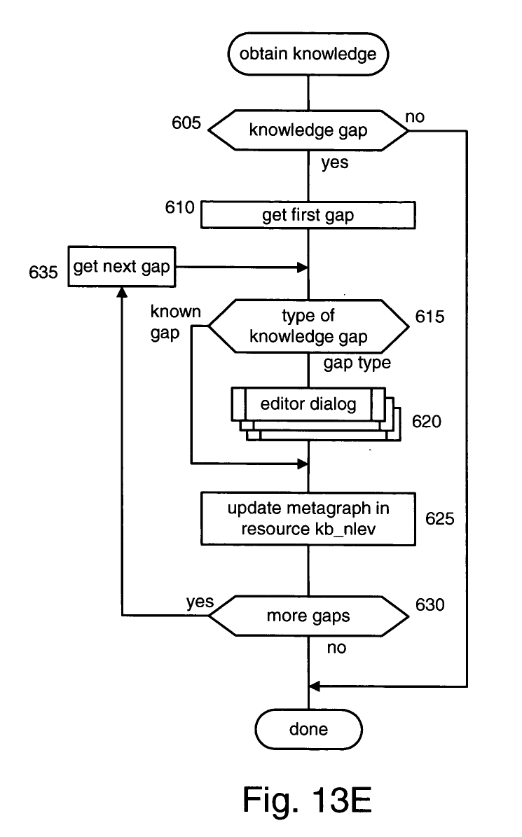

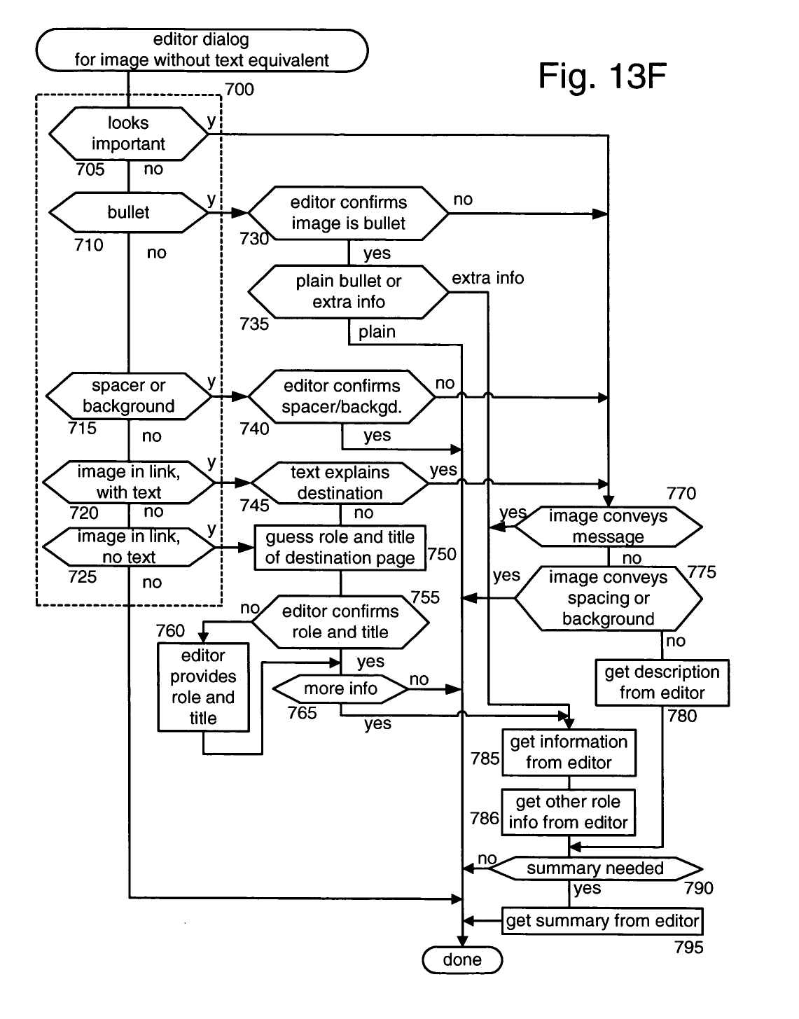

FIGS. 13A-13F are a flowchart showing how a resource knowledge base is created for a resource.

Turning to FIG. 13A, at step 405, annotation wizard 154 prompts the editor for session information. Session information includes the editor's username and password, a project name, the address of the resource, which standard needs to be complied with, e.g., WCAG level 1 or Section 508, and any other conversions of content that may be required, such as conversion of web content to a digital talking book. At step 410, annotation wizard 154 receives the session information provided by the editor.

At step 415, annotation wizard 154 retrieves the resource specified by the editor and creates a list of pages in the resource. For example, if the resource is a website, the list of pages sequentially lists each page in the website.

To make best use of the editor's time and the computing capacity of server 150, pages are pre-processed in parallel, and as soon as a page is pre-processed, it is available to be edited by the editor in parallel with any remaining page pre-processing. Step 420, shown in detail in FIG. 13B, indicates that pre-processing occurs in parallel with step 430, shown in detail in FIG. 13C, processing of pre-processed resources. After step 420 completes, step 430 continues to completion. The result of step 430 is resource kb level n 238, comprising metagraphs as shown in FIG. 8.

At step 435, extracter 230 of annotation wizard 154 extracts resource kb 164 from resource kb level n 238. Specifically, extracter 230 selects applicable graphs 260 from resource kb level n 238 and places them into a file to create resource kb 164.

At step 440, annotation wizard 154 provides the results of the editing session to the editor, such as code for drop-down menus enabling the user to choose an alternative rendering, and the locations of alternate renderings and combinations of scenario-specific transformations, referred to as pipelines. The code for the drop-down menus includes hyperlinks to the alternate renderings that the menu items correspond to. Processing is now complete.

Let it be assumed that accessibility engine 152 resides on a server at www.ubapps.com.

A link to an accessibility enhanced version of a website may be of the form:
http :/nds.ubapps.com/truetext/solutions_and_services.html
   where nds is a large client, and the accessibility enhanced site is a truetext version of the page solutions_and_services. “Truetext” is a scenario-specific transformation, also referred to as a pipeline. The resource kb is in a corresponding location available to accessibility engine 152.

Alternatively, a link may be of the form:
http://ubapps.com/truetext/www.nds.com/solutions_and_services/solutions_and_services.html
   if nds is a smaller client that does not require its own sub-domain and shortened URL address.

The resource owner now decides which of the drop-down menus or links should be linked to from the resource, and manually inserts the drop-down menus and/or links into the resource. Since the insertion is completely under the resource owner's control, the resource owner avoids the anxiety experienced when accessibility-enhancing software rewrites the resource.

FIG. 13B is a flowchart showing pre-processing of the pages of a resource. In short, common problems due to author sloppiness with the HTML (or XML) code are cleaned up, the page is converted to a page object, and placed on a list to await processing.

At step 450, annotation wizard 154 sets its page pointer to the first page in the list of pages created at step 415.

At step 455, annotation wizard 154 gets the page indicated by its page pointer.

At step 460, annotation wizard 154 runs a patch file on the page. The patch file includes corrections for extreme instances of bad encoding that can crash or confuse the software that creates valid XML. At step 465, annotation wizard 154 creates valid XML using third party software such as Cyberneco, available at http://www.apache.org/˜andyc/neko/doc/html/index.html, or HTML Tidy, available at http://www.w3.org/People/Raggett/tidy/. At step 470, annotation wizard 154 converts the valid XML to a page object by loading it into an XML Java object which is faster to process than an XML file. At step 475, annotation wizard 154 places the page object on either the active list or the wait list. Generally, the active list has a predetermined capacity, such as three pages. If there is room on the active list, the page object is placed on the active list; otherwise, the page object is placed on the wait list.

At step 480, annotation wizard 154 determines whether there are more pages in the list of resource pages. If so, then at step 485, annotation wizard sets its page pointer to the next page in the list of pages, and processing returns to step 455. When there are no more pages to process, at step 490, annotation wizard 154 sets an “all-pages-processed” flag, and processing is complete.

FIG. 13C is a flowchart showing processing the pre-processed resource. In short, a page is selected for page processing, then waiting pages are moved to the active list.

At step 505, annotation wizard 154 checks whether there is a page object on the active list. If so, at step 525, the page object is processed as shown in FIG. 13D, and processing returns to step 505. If there are no page objects on the active list, then at step 510, annotation wizard 154 checks whether there are page objects on the wait list. If so, then at step 520, annotation wizard 154 moves the page object to the active list and processing continues at step 525. If there are no page objects on the wait list, then at step 515, annotation wizard checks whether the “all-pages-processed” flag is set. If not, that means that some pages remain to be pre-processed, so processing returns to step 505. If the “all-pages-processed” flag is set, then processing is complete, since all pages have been pre-processed, and all pages have been processed.

FIG. 13D is a flowchart showing processing a page of a pre-processed resource. The processing depicted herein is also shown in FIG. 7.

At step 550, annotation wizard 154 gets a page object from the active list. At step 555, annotation wizard 154 sets the current resource, curr_resrc to be the just obtained page object, and sets nlev=1.

At step 560, annotation wizard 154 executes the transformations program for nlev on the current resource to create the resource kb for nlev. During the first iteration, this corresponds to executing transformations program level one 211 on page object 162 to produce resource kb level one 231 shown in FIG. 7.

At step 565, annotation wizard 154 invokes editor interface 220 to obtain knowledge for the knowledge gaps in the resource kb for nlev, shown in detail in FIG. 13E. This corresponds to providing the proposed graphs to editor interface 220 and receiving the applicable graphs from editor interface 220, shown in FIG. 7.

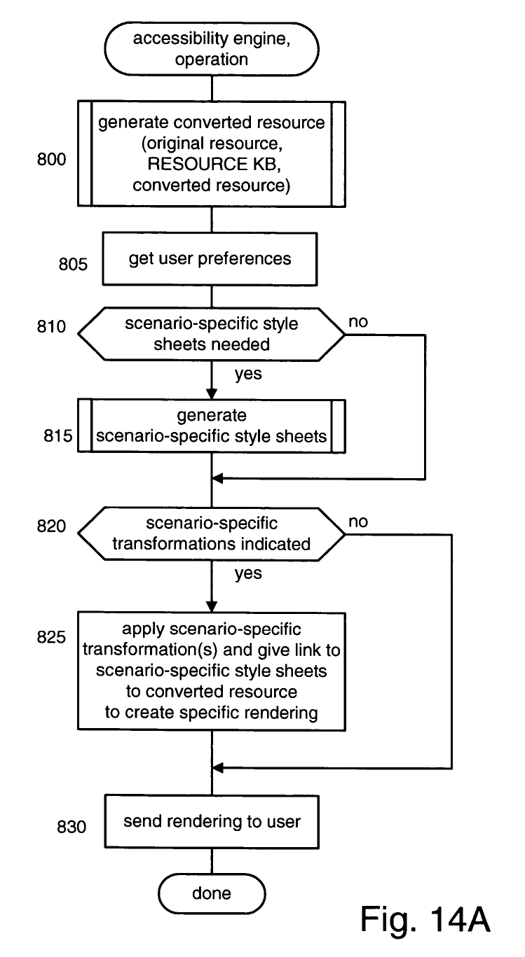

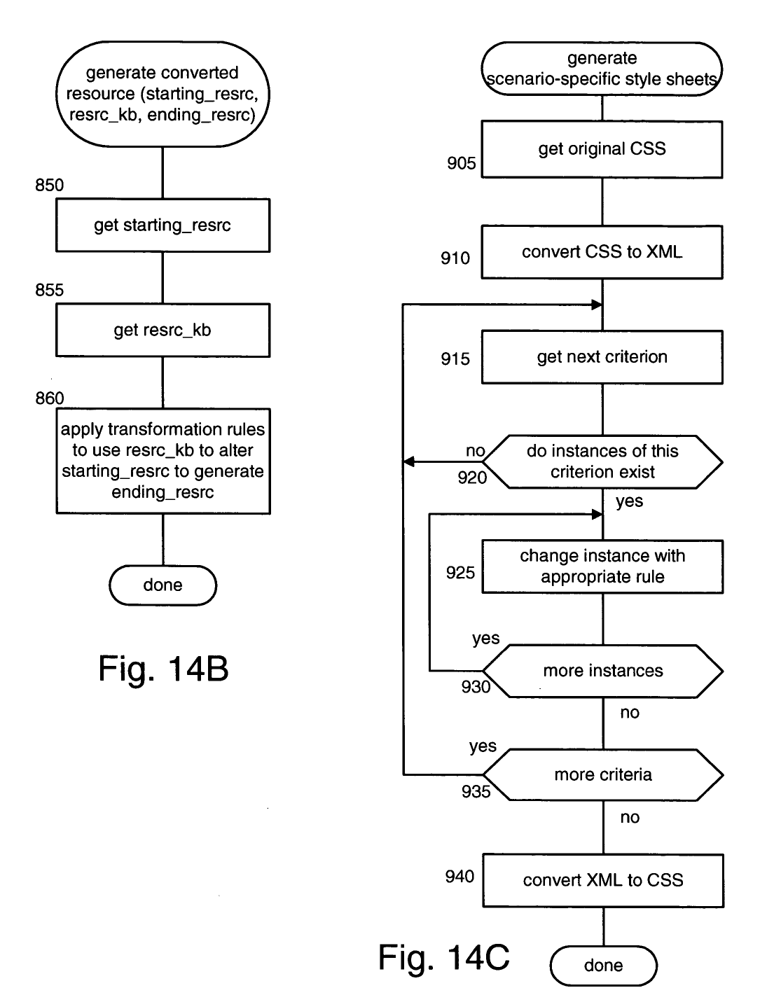

At step 570, annotation wizard 154 checks if there are more levels, that is, whether nlev equals the maximum number of levels of transformations programs. If so, then processing is complete. If not, at step 575, annotation wizard 154 invokes accessibility engine 152 to generate a resource at nlev, resource_nlev, shown in detail in FIG. 14B. During the first iteration, this corresponds to executing accessibility engine 152 with page object 162 and resource kb level one 231 as inputs to produce resource level one 241 shown in FIG. 7. At step 580, annotation wizard 154 sets the current resource, curr_resrc to be the just generated resource_nlev, and increments nlev. Processing continues at step 560.

FIG. 13E is a flowchart showing obtaining knowledge from an editor. Generally, wizard 154 finds the next knowledge gap in the page object and either uses an appropriate editor dialog to obtain knowledge from the editor to fill the gap or makes a “highly confident” guess as to what should fill the gap, updates proposed graph 258 with the just obtained or just guessed knowledge to create applicable graph 262, and continues until all knowledge gaps have been addressed.

At step 605, annotation wizard checks if there are any knowledge gaps. More specifically, annotation wizard checks if there are any metagraphs 250 having proposed graph 258 and lacking applicable graph 262. If not, processing is complete. If so, at step 610, annotation wizard gets the first knowledge gap.

At step 615, annotation wizard 154 checks the type of knowledge gap. It is noted that missing presentation information for the page can be a type of knowledge gap. If the knowledge gap does not require information from the editor, such as style information superseded by a style sheet, shown in Table A-1 in Appendix A, then processing continues at step 625. If the knowledge gap does require information from the editor, then at step 620, annotation wizard engages in an appropriate dialog with the editor to obtain the missing information. An example of a dialog is shown in FIG. 13F.

At step 625, annotation wizard stores the missing knowledge obtained from its own guess or from the editor. More specifically, annotation wizard 154 writes an applicable graph 262.

Tables 7-9 show examples of RDF graphs. In both of the cases discussed, information obtained by annotation wizard 154 from the editor is used to make an alternative equivalent for the given image.

Table 7 is a graph obtained by guessing that an image is a bullet (altText value=“*”, in the penultimate line), which was confirmed by the editor, so the proposed graph in Table 7 is the same as the applicable graph.

TABLE 7
<rdf:Description about=“//dt/img[count(preceding-sibling::node( )[(self::*) or (normalize-
space(.))]) &lt; 1][not(ancestor::a)][not(@alt)][not(@width &gt; 30)][not(@width &lt;
5)][not(@height &gt; 30)][not(@height &lt; 5)][not(@ismap)][not(@usemap)][normalize-
space(@src)=‘http://www.yadsarah.org.il/english/images/Gates/bb1.gif’] |
//dd/img[count(preceding-sibling::node( )[(self::*) or (normalize-space(.))]) &lt;
1][not(ancestor::a)][not(@alt)][not(@width &gt; 30)][not(@width &lt; 5)][not(@height &gt;
30)][not(@height &lt; 5)][not(@ismap)][not(@usemap)][normalize-
space(@src)=‘http://www.yadsarah.org.il/english/images/Gates/bb1.gif’] |
//li/img[count(preceding-sibling::node( )[(self::*) or (normalize-space(.))]) &lt;
1][not(ancestor::a)][not(@alt)][not(@width &gt; 30)][not(@width &lt; 5)][not(@height &gt;
30)][not(@height &lt; 5)][not(@ismap)][not(@usemap)][normalize-
space(@src)=‘http://www.yadsarah.org.il/english/images/Gates/bb1.gif’]”>
<ub:technique>1.1.5</ub:technique>
<ub:altText value=“*”/>
</rdf:Description>

Table 8 shows a proposed graph in which annotation wizard 154 guessed that the image is a spacer (altText value=“”, in the penultimate line). The editor did not agree with this guess and instead provided the information that the image represents “Services” resulting in the applicable graph shown in Table 9 (altText value=“Services”, in the penultimate line).

TABLE 8
<rdf:Description about=“//img[@width][@height][not(@width
&gt; 5)][not(@height &gt;
5)][not(@alt)][not(@ismap)][not(@usemap)][normalize-
space(@src)=‘http://www.yadsarah.org.il/english/images/Gates/bb1.gif’] |
//img[@width][@height][not(@width &gt; 5)][not(@height &gt;
5)][@alt][normalize-
space(@alt)=”][not(@ismap)][not(@usemap)][normalize-
space(@src)=‘http://www.yadsarah.org.il/english/images/Gates/bb1.gif’]”>
<ub:technique>1.1.22</ub:technique>
<ub:altText value=“”/>
</rdf:Description>

TABLE 9
<rdf:Description about=“//img[@width][@height][not(@width
&gt; 5)][not(@height &gt;
5)][not(@alt)][not(@ismap)][not(@usemap)][normalize-
space(@src)=‘http://www.yadsarah.org.il/english/images/Gates/bb1.gif’] |
//img[@width][@height][not(@width &gt; 5)][not(@height &gt;
5)][@alt][normalize-
space(@alt)=”][not(@ismap)][not(@usemap)][normalize-
space(@src)=‘http://www.yadsarah.org.il/english/images/Gates/bb1.gif’]”>
<ub:technique>1.1.22</ub:technique>
<ub:altText value=“Services”/>
</rdf:Description>

At step 630, annotation wizard checks if there are any more knowledge gaps. If so, annotation wizard 154 gets the next gap and processing continues at step 615. If not, processing is complete.

FIG. 13F is a flowchart showing the logic for a dialog with the editor for an image without a text equivalent. It will be understood that dialogs for different situations are different, but usually follow the general format described herein.

Generally, annotation wizard 154 guesses what the missing knowledge is, then asks the editor to confirm the guess, supply implicit knowledge that is likely to exist, or supply explicit knowledge if the guess is wrong. Importantly, the editor is often prompted for information about a situation multiple times, since multiple levels of information may be conveyed in the page, and most human editors need multiple prompts to provide a full response. In other words, annotation wizard 154 is built to work with a typical human editor, and does not require an editor sensitive to various nuances of knowledge and how they might be misperceived by a disabled person.

At step 700, indicated as a box with a dashed line, annotation wizard 154 makes a guess as to the missing knowledge. In this case of an image without a text equivalent, either:
at step 705, the image looks important and so processing continues at step 770; in processing terms, this can be an image large enough to have readable information without text positioned on top of it, see Table A-37, or
at step 710, the image looks like a bullet, and so processing continues at step 730; in processing terms, this is an image of size within the range appropriate for a bullet and positioned at the beginning of a list item, see Table A-24, or
at step 715, the image looks like spacer or background, and so processing continues at step 740; in processing terms, this can be an image that has at least one dimension too small to contain readable information, or an image with content positioned on top thereof, see Table A-27, or
at step 720, the image is in a hyperlink and has text, see Table A-26, such as the following example:
   <a href=“productlaptop.html”><img src=“laptop.gif”>see our laptops</a>so processing continues at step 745, or
at step 725, the image is in a hyperlink without text, see Table A-25, such as the following example:
   <a href=“product/laptop.html”><img src=“laptop.gif”></a>so processing continues at step 750, or
if none of these situations exists, then processing is complete.

At step 730, annotation wizard 154 uses editor interface 220 to confirm whether the image is a bullet a bullet, at step 735, annotation wizard 154 inquires whether it is simply a bullet or whether extra information is conveyed. ff a plain bullet, processing is complete. If extra information, processing continues at step 785.

At step 740, annotation wizard 154 uses editor interface 220 to confirm whether the image is a spacer or background. If not, processing goes to step 770. If the editor confirms the image is a spacer or background, then processing is complete. This is an example of where the missing knowledge relates to presentation information.

At step 745, annotation wizard 154 uses editor interface 220 to confirm whether the text associated with the hyperlink explains the destination. If so, processing continues at step 770 to determine what the meaning of the image is. If not, processing continues at step 750.

At step 750, annotation wizard 154 guesses the role and title of the destination page by either referring to the role and title associated with the linked-to page by annotation wizard 154, or by finding the title and role of the page as it exists in the metadata of the linked-to page. At step 755, annotation wizard 154 uses editor interface 220 to confirm whether the role and title have been correctly guessed. If so, at step 765, annotation wizard 154 inquires whether there is any more information conveyed. If not, processing is complete. If so, processing continues at step 785. If the role and title have not been correctly guessed, at step 760, the editor provides the correct role and title, and processing continues at step 765.

At step 770, annotation wizard 154 uses editor interface 220 to determine whether the image conveys a message. If so, processing continues at step 785. If not, at step 775, annotation wizard 154 inquires, via editor interface 220, whether the image conveys spacing or background information. If so, processing is complete. If not, at step 780, the editor provides a description of what the image means, and processing continues at step 790.

At step 785, the editor provides the information that she or he has indicated exists. Generally, the information is provided as free-form text, without length limitation.

At step 786, the editor provides other role information such as whether this image is used as a header.

At step 790, annotation wizard 154 checks whether a summary is needed, typically, whether the information from the editor exceeds a predetermined number of characters, such as 80 characters. If not, processing is complete. If so, at step 795, annotation wizard 154 obtains, via screen interface 220, a summary from the editor, and processing is complete.

Thus, the processing depicted in FIG. 13F obtains at least the following knowledge for an image without a text equivalent:
the meaning of the image, if any;
whether the image is a bullet, and if so, any extra information associated therewith;
whether the image is a spacer or background; and
the role and title of a destination page, for a hyperlink.

Operation of the accessibility engine to provide a resource with improved accessibility will now be discussed.

FIGS. 14A-14C are a flowchart showing how a resource is converted to an accessible resource.

FIG. 14A depicts the overall processing of converting a resource to an accessible resource. In this embodiment, the resource is converted in real-time, in response to a request from a user; this approach is most practical when there are a large number of variations in how a user may prefer the final converted resource. In other embodiments, the conversion occurs during a set-up phase, and the converted resource is given directly to the user; this approach is suited to a situation where there is a small number of possibilities in how the resource may be converted.

In other embodiments, some of the conversion is performed during set-up, and the remainder is performed in response to a user request.

In still other embodiments, only one version of converted content is available and the user is another device or application such as middleware or a translation service.

At step 800, accessibility engine 152 generates a converted resource from the original resource and the resource kb. FIG. 14B shows this conversion in detail. For the case of a website, FIG. 10 depicts converting original website 162 to converted website 192 using resource kb 164 and user preferences 166.

At step 805, accessibility engine 152 gets user preferences. Typically, user preferences are provided via one or more of the following ways. First, by the drop-down menu from which accessibility engine 152 was invoked; this drop-down menu was provided to the resource owner as part of set-up session results at step 440 of FIG. 13A. Second, via a file provided by the user to accessibility engine 152, such as a cookie 115 on user pc 110. Third, via a file stored at a third party's location, such as user preferences 142 at server 130.

At step 810, accessibility engine 152 determines whether scenario-specific style sheets are needed based on the choice of rendering, where rendering specific transformations associate the correct style sheet to the page. If not, the original resource's style sheet, possibly as modified and referenced by the resource kb, for example to increase color contrast, is used and processing continues at step 820. If so, at step 815, accessibility engine 152 generates scenario-specific style sheets, as shown in FIG. 14C.

At step 820, accessibility engine 152 determines whether scenario-specific transformations should be performed. If not, the converted resource is to be delivered to the user as-is and processing continues at step 830. If so, at step 825, accessibility engine 825 applies scenario-specific transformations to the converted resource from step 805.

At step 830, the rendering is sent to the user with, if produced at step 825, a link to the scenario-specific style sheets and processing is complete. The user's browser functions to apply the scenario-specific style sheet to the rendering when presenting the rendering to the user.

FIG. 14B depicts creating a converted resource based on an original resource and a resource kb.

At step 850, accessibility engine 152 gets the original resource. At step 855, accessibility engine gets the resource kb created via annotation wizard 154, created using a different tool, or created manually.

At step 860, accessibility engine 152 uses the resource kb to alter the original resource to produce a converted resource, and processing is complete.

FIG. 14C depicts generating scenario-specific style sheets, which are a powerful mechanism for affecting the presentation of a resource. For example, a scenario specific style sheet enables a user to specify “red colors always display as bold and underlined in my black-and-white rendering”.

At step 905, accessibility engine 152 gets the original cascaded style sheet (CSS) from the converted resource; the CSS was created as part of the original resource or referenced in the converted resource. In a converted resource, CSS references were created by extracting presentation information from the original resource that had not been separated into content.

At step 910, accessibility engine 152 converts the CSS to XML so it can be parsed using the parser developed for parsing the XML knowledge gap rules.

At step 915, accessibility engine 152 gets the next criterion from scenario-specific style sheet rules 168. An example of a criterion is “turn all red text into bold and underlined text”, and is expressed as a pattern to be matched in the resource's code.

An example of a scenario-specific style sheet rule is shown in Table 10. This rule converts colors to grayscale.

TABLE 10
<transformation>
<number>3</number>
<logic>Convert colours into either black or white. This is based on the
background colour</logic>
<usedFor>Black-white renderings.</usedFor>
<typeReference>2</typeReference>
<case>
<description>Matched on a background-color attribute</description>
<if path=“//” type=“attribute” name=“background-color”/>
</case>
<case>
<description>There is a css:color attribute but no background-color
in the same node</description>
<if path=“//” type=“attribute” name=“color”/>
</case>
<action>
<description>Change the background colour to the base colour and the
font colour to the inverse of that</description>
<then action=“changeColourValue”/>
<then action=“changeBackgroundValue”/>
</action>
</transformation>

Exemplary rules in scenario-specific style sheet rules 168 are:
Convert the base font size in the body element tag to em so that it is relative;
Convert any font-size that is not relative (em) to relative. Either to the base font-size that has already been set or to the default which is lem;
Convert colours into either black or white. This is based on the background colour;
Convert bolder or underlined text to louder;
Convert font-weight bold to stress: 90; pitch-range: 80;
Take a font-size and add richness tag depending on what the relative font-size is.

At step 920, accessibility engine 152 determines whether instances of this criterion exist in the resource. If so, at step 925, the instance is changed with the appropriate rule, and at step 930, accessibility engine 152 determines if there are any more instances. If so, processing returns to step 925. If not, processing continues at step 935. If no instances of this criterion exist, then processing returns to step 915.

At step 935, accessibility engine 152 determines if there are any more criteria. If so, processing returns to step 915. If not, at step 940, accessibility engine 152 converts the XML code back to a CSS, and processing is complete. Using a mapping of CSS to XML enables use of XML type identifiers such as URIs or Xpointers, to describe rules and relationships in a non-XML based platform.

Although the present invention has been described with regard to websites, it will be appreciated that it is also useful with regard to any electronic resource. That is, the present invention is adapted for converting documents such as graphics animations or presentations to be accessible by visually impaired persons.

Usage examples are now discussed.

Consider an indefinite object, such as “it”, appearing in a sentence. In context, the average user will have little difficulty determining the definite object referred to, but the cognitively challenged user may find understanding the implied meaning of the word “it” difficult. If the sentence or phrase containing the word “it” is cut and pasted into another document, the meaning of the word “it” will be lost. If however, the definite object referred to by the word “it” is determined and stored in the knowledge base, a link to the implied meaning of the word may be transported with the phrase between documents maintaining accessibility to the meaning.

Another application that illustrates the advantages of this approach is translation. Translation tools that automatically translate between languages are known. However it will be appreciated that sentence construction, word order and basic assumptions regarding the connection between words vary between languages. It is well known that most written material ‘loses something in the translation’, even when the translation is performed manually by a bilingual individual. Where translation is performed by a machine, for the translation to be comprehensible, the machine working with the text must be very sophisticated; unfortunately, state of the art automatic translators are inadequate. By including appropriate supplementary material, a knowledge base as described above enables better translations to be performed.

Another example of knowledge, implicit in a page, is the role of different interactive elements. If we know that a page hyperlink has the role of taking the user to the site's home page, and we store that piece of knowledge in the knowledge base, then that knowledge can be used to create enhanced accessibility in different ways in many different scenarios. For example, the home page hyperlink and all similar elements can be rendered for a user, across all pages, with an keyboard access alternative of “alt+h”. However, if we consider a different user, such as a native Russian speaker, and that ‘home’ in Russian, is “dom”, it may be preferable to use “alt+d” to consistently provide keyboard access for links to the home page, across any site. Similarly, a cognitively challenged user may prefer all links to home pages to be represented by an icon of a home, perhaps with the site name displayed underneath. This example illustrates the advantages of comprehending the meaning implicit in a link, rather than merely offering a particular substitute.

Another example is as follows. Let it be assumed that a screen displays the sentence:
“RDF is written in triples.”
   A user can select a zoom feature, which causes accessibility engine 152 to locate an explanation of terms, and revise the displayed sentence to be as follows:
“RDF (Resource Description Framework) is written in triples (triples describe the relationship between two items).”
   This feature allows accessibility engine 152 to expand the content for the user so that the user does not have to remember each term. This is especially useful for memory related disorders where the user is able to understand the concepts but unable to remember terms. It can be appreciated how much easer this interface would be then just providing a glossary look up, or requiring the user to go back and forth looking up the terms via a dictionary or web search. The same type of zoom could be applied to many scenarios such as diagrams and equations, where sections or terms can be expanded into more detail, explanations or dependent sub equations. Legal documents can zoom into defined terms and first usages. Legal document and technical documents, using removing ambiguity and zoom could be made clearer and more comprehensible to many more people.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

### APPENDIX A

The following terms are used herein:

| | |
|---|---|
| CSS | cascaded style sheet |
| SWAP | an embodiment of the present invention that has been reduced |
| | to practice |
| WCAG | Web Content Authoring Guide |

TABLE A-1

| Field | Description |
|---|---|
| Dependency | A-1 |
| Transformation | 3.3.11 |
| Number | |
| Knowledge gap | Associating content and style |
| Logic | Body tag with margin attributes |
| Used for | Take out all the presentational attributes from the body tag and put them into |
| | CSS. |
| About | Presentational information should be separated from other content. Where |
| | they have been mixed up it is useful to separate them. When we do we create |
| | a knowledge base reference linking styled content in the page to style |
| | information in a class in a style sheet. We need to build the knowledge base |
| | relationship and, when we do not have it already add style information to a |
| | CSS that acts as a resource. In this case we know we need to do this because |
| | of the occurrence body tag with margin attributes |
| Best guess | Create CSS class based on presentational information (unless one exists |
| | already). |
| | Create association between content and CSS |
| | This is normally automatic |
| | User can edit if they choose |
| Editor supplied | None |
| knowledge | |
| Example case | Case 1: if there are explorer margin attributes in the body tag, we need to |
| (HTML | transfer them all to CSS |
| description) | Case2: if there are explorer margin attributes in the body tag, we need to |
| | transfer them all to CSS |
| Example use, | writeToCSSFile creates a new class with attribute of current node deletes all |
| WCAG | these attributes from the node and adds to the node attribute class with the |
| description | value of the new class name created All presentational attributes are deleted |
| | in SWAPML rendering SWAPCSS.xsl. NOTE: there may be a problem |
| | because this transformation now will not have an rdf statement |

TABLE A-2

| Field | Description |
|---|---|
| Dependency | A-1 |
| Transformation | 3.3.12 |
| Number | |
| Knowledge gap | Associating content and style |
| Logic | body tag with margin attributes |
| Used for | take out all the presentational attributes from the body tag and put them to |
| | css. |
| About | Presentational information should be separated from other content. Where |
| | they have been mixed up it is useful to separate them. When we do we create |
| | a knowledge base reference linking styled content in the page to style |
| | information in a class in a style sheet. We need to build the knowledge base |
| | relationship and, when we do not have it already add style information to a |
| | css that acts as a resource. In this case we know we need to do this because |
| | of the occurrence body tag with margin attributes |
| Best guess | Create CSS class based presentational information (unless one exists already) |
| | Create association between content and CSS |
| | This is normally automatic |
| | User can edit if they choose |
| Editor supplied | None |
| knowledge | |
| Example case | Case 1: if there are netscape margin attributes in the body tag and no explorer |
| (HTML | attributes, we need to transfer them all to css |
| description) | Case2: if there are netscape margin attributes in the body tag, we need to |
| | transfer them all to css |
| Example use, | writeToCSSFile creates a new class with attribute of current node deletes all |
| WCAG | these attributes from the node and adds to the node attribute class with the |
| description | value of the new class name created All presentational attributes are deleted |
| | in SWAPML rendering SWAPCSS.xsl. NOTE: there may be a problem |
| | because this transformation now will not have an rdf statement |

TABLE A-3

| Field | Description |
|---|---|
| Dependency | A-2 |
| Transformation | 15.1.1 |
| Number | |
| Knowledge gap | Role of content |
| Logic | for every page, identify its type (front matter, bodymatter, rearmatter) |
| Used for | convert to daisy book |
| About | Role of content is important piece of knowledge about a resource. |
| | For every page, identify its type and role (front matter, bodymatter, |
| | rearmatter) |
| | Note on roles: |
| | Adding new roles and classes - Extendibility: |
| | SWAP Roles and Types are defined in RDF and OWL classes. That makes |
| | them inherently extendable and new classes and types of roles can be derived |
| | from old existing roles. The relationship between new classes and types and |
| | preset types can also be defined in a programmatically understandable way. |
| | This implies web communities can have their own, derived, content types. |
| | For example IMPS and educational content typically use: |
| | tutor, help, glossary, back, up, next |
| | This implies that, if you customers feel an element usage is not fully |
| | described in the given role libraries then they can create a new role. This is |
| | especially important to niche web communities such as bloggers, who may |
| | expect different types of content on a web site. |
| | The invention can also come with an easy interface to create new types of |
| | content types. New sets of content types can be down loaded and used by r |
| | customers |
| | What happens at the user agent does not know about a new type? |
| | If the user agent is only familiar with the base classes, then it can handle a |
| | derived class the same way it would handle its parent. However tools geared |
| | to a certain target audience (such as educational) would have special features |
| | for a derived schema created by that community. |
| | Popular downloaded set of types are also supported by SWAP interpretation |
| | engine |
| Best guess | If the CSS classes of the page (body class) has a role associated then we will |
| | guess that role |
| | Guess depends on where the page is in the hierarchy of the site/content |
| | (contact us is more likely to be a link off the home page, table of content |
| | comes at the front of a book, etc.) |
| | Also the content itself helps us guess the role (lots of links - may be a site |
| | map) |
| | And the content of a page header, title etc helps us guess the role. |
| Editor supplied | Confirm edit or change the best guess |
| knowledge | |
| Example case | Case 1: get a container with page class |
| (HTML | |
| description) | |
| Example use, | ask the user for the role attribute |
| WCAG | |
| description | |

TABLE A-4

| Field | Description |
|---|---|
| Dependency | A-3 |
| Transformation | 13.2.1 |
| Number | |
| Knowledge gap | Description of page |
| Logic | meta tag with description name is missing in the text |
| Used for | insert essential metadata to the document |
| About | meta tag with description name is missing in the text |
| | (note this may have been added when |
| | another page was run in the wizard and |
| | referenced this page. In that case we will |
| | already know this information, - in which case we |
| | will not run this transformation, as it is added |
| | at level 1 transformations) |
| Best guess | insert essential metadata to the document |
| | from first paragraph of the main |
| | content |
| Editor supplied | Confirm edit or change the best guess |
| knowledge | |
| Example case | Case1: meta tag with name = description |
| (HTML | is not found |
| description) | |
| Example use, | need to add meta tag with |
| WCAG | name = description |
| description | |

TABLE A-5

| Field | Description |
|---|---|
| Dependency | A-3 |
| Transformation | 13.2.2 |
| Number | |
| Knowledge gap | Title and role of a page |
| Logic | title tag is missing in the text |
| Used for | insert title for the document |
| About | Meta data for Role and Title for a page is |
| | important to help users find the |
| | page that they need and navigate a site \. |
| | title tag is missing in the text |
| | Title tag was used by another page |
| | role is not known |
| | (note this may have been added when |
| | another page was run in the wizard and |
| | referenced this page. In that case we |
| | will already know this information, - in |
| | which case we will not run this transformation, |
| | as it is added at level 1 transformations) |
| Best guess | Role may be associated with CSS of the |
| | body of a page, or be associated |
| | from the page. |
| | Title can be guessed as being equal to |
| | the Role Otherwise, |
| | insert title for the document - if there is a first header |
| | in the content then that may be there title. Role can be |
| | guessed from title keywords or may have been |
| | provided when this page was referenced by a page we |
| | already processed All titles should be |
| | unique (pages on a site should not have the |
| | same title, but can have the same role) |
| Editor supplied | Confirm edit or change the best guess |
| knowledge | |
| Example case | Case1: title tag is not found in the document |
| (HTML | Case2: role is not known |
| description) | Case 3: title has been used by a page |
| | that is already processed. |
| Example use, | need to add title tag |
| WCAG | |
| description | |

TABLE A-6

| Field | Description |
|---|---|
| Dependency | A-3 |
| Transformation | 13.3.1 |
| Number | |
| Knowledge gap | n/a |
| Logic | add a class for pagemap in CSS file |
| Used for | create a page map for a document |
| About | add a class for pagemap sections in CSS file |
| Best guess | automatic |
| Editor supplied | None |
| knowledge | |
| Example case | if there is no tag with id or class “pagemap”, |
| (HTML | add one as a first node of the body |
| description) | |
| Example use, | add a CSS class for pagemap |
| WCAG | |
| description | |

TABLE A-7

| Field | Description |
|---|---|
| Dependency | A-4 |
| Transformation | 9.5.01 |
| Number | |
| Knowledge gap | Author preferred keyboard access |
| Logic | pagemap anchor tag - need to provide an |
| | accesskey for appropriate pagemap link |
| Used for | provide keyboard access to pagemap links |
| About | provide keyboard access (so users who cannot |
| | use a mouse can easily access links) |
| | pagemap anchor tag - need to provide an accesskey |
| | for appropriate pagemap link |
| Best guess | Suggest pagemap standard defaults |
| Editor supplied | None |
| knowledge | |
| Example case | pagemap anchor tag will need an accesskey |
| (HTML | |
| description) | |
| Example use, | need to add accesskey |
| WCAG | |
| description | |

TABLE A-8

| Field | Description |
|---|---|
| Dependency | A-4 |
| Transformation | 9.5.6 |
| Number | |
| Knowledge gap | Author preferred keyboard access |
| | Relative importance of links |
| Logic | a tag without accesskey attribute |
| Used for | provide keyboard access to important links |
| About | a tag without accesskey attribute |
| Best guess | If the role is known then suggest using |
| | role defaults access keys and not |
| | overriding. Recommend assigning |
| | the next available page accesskey for |
| | keyboard access to important links without |
| | roles by marking their relative importance |
| | Important tags will get higher priority |
| | to receive keys allocated first. |
| | Allow editor to override, automatic |
| | allocation by assigning specific |
| | access keys |
| Editor supplied | Confirm edit or change the best guess |
| knowledge | Allow editor to override, automatic |
| | allocation by assigning specific access keys |
| Example case | Case1: a tag with no accesskey attribute, |
| (HTML | with href and content |
| description) | Case2: a tag with no accesskey attribute, |
| | with href and tag inside |
| Example use, | need to add accesskey with next value |
| WCAG | available We make a suggestion for the accesskey |
| description | value, using java extension function that |
| | each time returns the next letter. |

TABLE A-9

| Field | Description |
|---|---|
| Dependency | A-4 |
| Transformation | 9.5.7 |
| Number | |
| Knowledge gap | Author preferred keyboard access |
| | Relative importance of links |
| Logic | area tag without accesskey attribute |
| Used for | provide keyboard access to important links |
| About | area tag without accesskey attribute |
| Best guess | If the role is known then suggest using role |
| | defaults access keys and not overriding. |
| | Recommend assigning the next available |
| | page accesskey for keyboard access to |
| | important links without roles by marking |
| | their relative importance |
| | Important tags will get higher priority to receive |
| | keys allocated first. Allow editor to override, |
| | automatic allocation by assigning specific |
| | access keys |
| Editor supplied | Confirm edit or change the best guess. Allow |
| knowledge | editor to override, automatic allocation |
| | by assigning specific access keys |
| Example case | area tag with no accesskey attribute |
| (HTML | |
| description) | |
| Example use, | need to add accesskey with next |
| WCAG | value available |
| description | |

TABLE A-10

| Field | Description |
|---|---|
| Dependency | B-3 |
| Transformation | 1.1.13 |
| Number | |
| Knowledge gap | Function, role and equivalency of applet |
| Logic | applet with no or empty alt attribute or empty content |
| Used for | applet |
| About | Applets are little programs running on a page. |
| | If they are without a text equivalent then |
| | knowledge and/or functionality is missing |
| Best guess | Parser in screen should help build Knowledge |
| | to include functional equivalent. |
| Editor supplied | Confirm edit or change the best guess |
| knowledge | |
| Example case | Case1: applet with no alt attribute |
| (HTML | Case2: applet with empty alt attribute |
| description) | Case3: applet with empty content |
| Example use, | Adds an alt attribute. Add a text |
| WCAG | content for applet |
| description | |

TABLE A-11

| Field | Description |
|---|---|
| Dependency | B-4 |
| Transformation | 1.1.3 |
| Number | |
| Knowledge gap | Possible Function, role and equivalency of applet |
| Logic | applet with non-empty alt - should verify |
| | that the alt is sufficient |
| Used for | applet |
| About | Applets are little programs running on a page. |
| | If they have a text equivalent then we |
| | should verify and test that this knowledge is full |
| Best guess | Confirm with user |
| Editor supplied | Confirm edit or change the best guess |
| knowledge | |
| Example case | applet whose alt attribute is not empty |
| (HTML | |
| description) | |
| Example use, | Verify that alt attribute is sufficient. If not, |
| WCAG | edit text content |
| description | |

TABLE A-12

| Field | Description |
|---|---|
| Dependency | C-2 |
| Transformation | 11.2.7 |
| Number | |
| Knowledge gap | Map to XHTML |
| Logic | deprecated embed tag is used in the document |
| Used for | replace embed tag with object tag |
| About | deprecated embed tag is used in the document |
| Best guess | map embed tag to object and attributes |
| Editor supplied | None |
| knowledge | |
| Example case | embed tag is found in the document |
| (HTML | |
| description) | |
| Example use, | replace deprecated embed tag with object |
| WCAG | |
| description | |

TABLE A-13

| Field | Description |
|---|---|
| Dependency | C-3 |
| Transformation | 1.1.14 |
| Number | |
| Knowledge gap | Possible Function, role and equivalency |
| Logic | a programmatic object with no text content (object |
| | doesn't have any child object nodes) |
| Used for | object |
| About | A programmatic object such as FLASH that is |
| | contained in the page - full interaction mapping |
| | is needed in wizard for full text equivalent (object |
| | doesn't have any child object nodes) |
| Best guess | Parser called by screen and pre known |
| | mappings should help build knowledge to |
| | include functional equivalent in html or x-form. |
| Editor supplied | Confirm edit or change the best guess add |
| knowledge | new information where no guess exists |
| Example case | programmatic object with no text content that doesn't |
| (HTML | have any child object nodes (if there are few objects |
| description) | nested in one another, description is provided |
| | in content of the innermost one) if object has |
| | embed tag as a child, required text content is |
| | provided in content of embed tag, and not in |
| | object tag - transformation 1.1.23 |
| Example use, | put UBcodeAdd to the object content and |
| WCAG | also add a long description |
| description | |

TABLE A-14

| Field | Description |
|---|---|
| Dependency | C-6 |
| Transformation | 1.1.24 |
| Number | |
| Knowledge gap | Knowledge if this element contains flicker |
| | Possible Function, role and equivalency |
| Logic | for any object, verify its alt attribute is provided, and |
| | check if it flickers |
| Used for | confirm alt attributes and deal with flickering |
| About | for any object that seems to have a text equivalent we |
| | need to verify that all information and text is captured, |
| | and check if it flickers and moving |
| | Check that this is not used as a header or other role |
| Best guess | This is not a header and does not have structural |
| | importance |
| Editor supplied | Confirm edit or change the best guess |
| knowledge | |
| Example case | for any programmatic object, verify alt and check |
| (HTML | for flickering |
| description) | |
| Example use, | Remove flickering objects with an equivalent that does |
| WCAG | not flicker for photosensitive epilepsy |
| description | |

TABLE A-15

| Field | Description |
|---|---|
| Dependency | D-3 |
| Transformation | 12.1.1 |
| Number | |
| Knowledge gap | frame title, role, content type and description |
| Logic | a frame without title and longdesc attributes |
| Used for | frame |
| About | Frames are sections of a screen that function |
| | independently. |
| | They can be hard to navigate with assistive technology. |
| | This case looks at frames without titles and descriptions |
| Best guess | Title/role of page referenced by frame. Meta data |
| | summary or description of referenced page |
| Editor supplied | Confirm edit or change the best guess |
| knowledge | |
| Example case | frame without both title and longdesc |
| (HTML | |
| description) | |
| Example use, | provide title and write longdesc for the frame |
| WCAG | |
| description | |

TABLE A-16

| Field | Description |
|---|---|
| Dependency | D-3 |
| Transformation | 12.1.2 |
| Number | |
| Knowledge gap | frame title, role, content type and description |
| Logic | a frame without title attribute but with longdesc attribute |
| Used for | frame |
| About | a frame without title attribute but with longdesc attribute |
| Best guess | Title/role of page referenced by frame |
| Editor supplied | Confirm edit or change the best guess |
| knowledge | |
| Example case | frame without title attribute but with longdesc attribute |
| (HTML | |
| description) | |
| Example use, | provide title for the frame |
| WCAG | |
| description | |

TABLE A-17

| Field | Description |
|---|---|
| Dependency | D-3 |
| Transformation | 12.1.3 |
| Number | |
| Knowledge gap | frame description |
| Logic | a frame without longdesc but with title attribute |
| Used for | frame |
| About | a frame without longdesc but with title attribute |
| Best guess | Meta data summary or description of referenced page |
| | or ask user to provide additional information when a title |
| | does not suffice to adequately convey the function |
| | or role of a frame |
| Editor supplied | Confirm edit or change the best guess |
| knowledge | |
| Example case | frame without longdesc but with title attribute |
| (HTML | |
| description) | |
| Example use, | write longdesc for the frame |
| WCAG | |
| description | |

TABLE A-18

| Field | Description |
|---|---|
| Dependency | D-4 |
| Transformation | 1.1.27 |
| Number | |
| Knowledge gap | frame description |
| Logic | frame tag with no longdesc attribute |
| Used for | provide additional information when a title does not |
| | suffice to adequately convey the function or role |
| | of a frame |
| About | frames are when sections of a page act independently. |
| | Sometimes a long description of the frame is |
| | useful but missing attribute |
| Best guess | Meta data summary or description of referenced page |
| | or ask user to provide additional information when a |
| | title does not suffice to adequately convey the |
| | function or role of a frame |
| Editor supplied | Confirm edit or change the best guess add new |
| knowledge | information where no guess exists |
| Example case | Case1: longdesc attribute is missing in frame |
| (HTML | Case2: longdesc attribute is empty in frame |
| description) | |
| Example use, | write longdesc for the frame |
| WCAG | |
| description | |

TABLE A-19

| Field | Description |
|---|---|
| Dependency | E-3 |
| Transformation | 1.2.1 |
| Number | |
| Knowledge gap | Role of map, |
| | equivalent of map |
| | Titles/role of each linked to region, and link address |
| | information, summary |
| Logic | img tag is used to insert server-side image map |
| Used for | provide an alternative list of links after it and indicate |
| | the existence and location of the alternative list |
| About | An image map sits on the server and is harder for |
| | assistive technology to understand. we need more |
| | knowledge of all the destination links or indicate |
| | the existence and location of the alternative list |
| Best guess | Titles/role of each linked to region, and link address |
| | information |
| Editor supplied | Confirm edit or change the best guess |
| knowledge | |
| Example case | img is used to present server-side map |
| (HTML | |
| description) | |
| Example use, | need to provide a paragraph with alternative list of links |
| WCAG | after the a tag |
| description | |

TABLE A-20

| Field | Description |
|---|---|
| Dependency | E-3 |
| Transformation | 1.5.1 |
| Number | |
| Knowledge gap | knowledge missing includes provide redundant text in |
| | the links for each active region of a client-side |
| | image map |
| Logic | “A” tag is used in client-side image map instead of area |
| | but no content for links is provided |
| Used for | provide redundant text in the links for each active region |
| | of a client-side image map |
| About | a link tag is used in client-side image map instead of |
| | area but no content for links is provided |
| Best guess | Titles/role of each linked to region |
| | (if roles are not yet allocated to linked to pages we |
| | can set them now) |
| Editor supplied | Confirm edit or change the best guess |
| knowledge | |
| Example case | no link text is provided when a tag is used inside the |
| (HTML | client-side image map |
| description) | |
| Example use, | need to provide textual link |
| WCAG | |
| description | |

TABLE A-21

| Field | Description |
|---|---|
| Dependency | F-3 |
| Transformation | 2.1.1 |
| Number | |
| Knowledge gap | What is meant by text |
| Logic | check that color names do not appear together with words |
| | like select/if/choose/click |
| Used for | check that color names are not used to convey |
| | information that is not presented in other ways |
| About | If colors are used to give instructions, then other way |
| | of capturing that knowledge needs to be provided. |
| | For example saying “select the blue button” is not |
| | helpful for or clear for color blind people. This is |
| | likely to happen when instructions contain color names |
| | together with words like select/if/choose/click etc |
| Best guess | Need to bind color (eg blue) with control |
| | (eg. The blue button) |
| Editor supplied | Confirm edit or change the best guess add new |
| knowledge | information where no guess exists |
| Example case | for each text content, check if it contains a sentence, that |
| (HTML | contains both a common color name and a selection word |
| description) | |
| Example use, | Supply clarified text. |
| WCAG | |
| description | |

TABLE A-22

| Field | Description |
|---|---|
| Dependency | H-1 |
| Transformation | 1.1.18 |
| Number | |
| Knowledge gap | Role of button may need to be FULLY captured |
| Logic | Input as an image with existing alt tag - need to verify it |
| Used for | text equivalency can be used as an alt attribute or as the |
| | text on a button in a true text rendering. The text |
| | equivalent of every single button on the page has |
| | to be unique. |
| About | Form control input has a text equivalent but we need |
| | to check that it is good enough. The text equivalent |
| | of every single button on the page should be |
| | unique. And text should be clear (not like ‘click hear’..) |
| Best guess | Role of a control can often be guessed by its tag, type |
| | and form in which it belongs |
| Editor supplied | Confirm edit or change the best guess |
| knowledge | |
| Example case | input (inside a form) is a graphic with alt attribute |
| (HTML | |
| description) | |
| Example use, | verify the uniqueness of alt attribute - replace |
| WCAG | with a more specific and useful alt when necessary |
| description | |

TABLE A-23

| Field | Description |
|---|---|
| Dependency | H-1 |
| Transformation | 1.1.19 |
| Number | |
| Knowledge gap | more knowledge may need to be captured as to role |
| | of button |
| Logic | Button contains an image with alt attribute |
| Used for | text equivalency can be used as an alt attribute or as |
| | the text on a button in a true text rendering. Image button |
| | alt text should be unique for every single button |
| | on the page. |
| About | What happens when we click a button needs to be fully |
| | clear unique. |
| Best guess | Add role/name of form to button |
| | If form role is not known it can be provided now |
| Editor supplied | Confirm edit or change the best guess add new |
| knowledge | information where no guess exists |
| Example case | button (inside a form) is a graphic and the alt attribute |
| (HTML | exists for the descendant img tag set |
| description) | |
| Example use, | set the alt attribute to “go [form name]” |
| WCAG | |
| description | |

TABLE A-24

| Field | Description |
|---|---|
| Dependency | H-2 |
| Transformation | 1.1.5 |
| Number | |
| Knowledge gap | Role of image |
| Logic | images at the beginning of definition lists created with |
| | DL, DT, and DD and unordered lists - LI, where there |
| | is no alt attribute for text equivalency |
| Used for | dt, dd and li with image as a first child |
| About | Image without text equivalent - Small images at the |
| | beginning of list items, are probably bullets |
| Best guess | this image is a bullet? Is other additional information |
| | in this image? |
| Editor supplied | Confirm edit or change the best guess add new |
| knowledge | information where no guess exists |
| Example case | Case1: img inside a dt that has no alt attribute, is small, |
| (HTML | not inside a link and in the first position |
| description) | Case2: img inside a dd that has no alt attribute, not inside |
| | a link and in the first position |
| | Case3: img inside an li that has no alt attribute, not inside |
| | a link and in the first position |
| Example use, | add alt attribute |
| WCAG | |
| description | |

TABLE A-25

| Field | Description |
|---|---|
| Dependency | H-2 |
| Transformation | 1.1.6 |
| Number | |
| Knowledge gap | The role of the image, |
| Logic | when an image is used as the content of a link, but no alt |
| | attribute and no link text are provided |
| | for text equivalency |
| Used for | links |
| About | Image without text equivalent - when an image is used |
| | inside a link, but no text equivalents the text equivalent |
| | should probably be were the link goes to |
| Best guess | this image is used as a link to page of |
| | known title and/or role |
| Editor supplied | Confirm edit or change the best guess add new |
| knowledge | information where no guess exists |
| Example case | Case1: an image is used as the content of a link and |
| (HTML | neither link text nor alt attribute is provided |
| description) | Case2: an image is used as the content of a |
| | link and alt attribute is empty |
| Example use, | Eg. |
| WCAG | add alt attribute with value go to title of the page |
| description | |

TABLE A-26

| Field | Description |
|---|---|
| Dependency | H-2 |
| Transformation | 1.1.7 |
| Number | |
| Knowledge gap | Role of image - is it decoration only? |
| Logic | when an image is used as the content of a link, there is a |
| | link text, but no alt attribute is provided |
| Used for | links |
| About | Image without text equivalent - when an image is used |
| | inside a link, but there is linked text the text |
| | equivalent may not be necessary |
| Best guess | Role of image - is it decoration only? |
| | knowledge may be needed . . . |
| Editor supplied | Confirm edit or change the best guess add new |
| knowledge | information where no guess exists |
| Example case | Case1: an image is used as the content of a link there is a |
| (HTML | link text but alt attribute is not provided |
| description) | Case2: an image is used as the content of a link there is a |
| | link text but alt attribute is not provided |
| Example use, | add alt attribute with value “ “(alt should be blank) |
| WCAG | |
| description | |

TABLE A-27

| Field | Description |
|---|---|
| Dependency | H-2 |
| Transformation | 1.1.22 |
| Number | |
| Knowledge gap | Role of image |
| Logic | spacer image - relatively small one |
| Used for | need an empty alt attribute - if has one, check that the |
| | value of alt is blank, else set the alt to be blank |
| About | Image without text equivalent that has very small |
| | dimensions may be a spacer image used for |
| | indentions, or background. For example, an image |
| | with a low width (smaller the a word) or |
| | height shorter then a letter. |
| Best guess | this image has no knowledge behind it, Its |
| | role is formatting only |
| Editor supplied | Confirm edit or change the best guess add new |
| knowledge | information where no guess exists |
| Example case | Case1: “small” img without an alt attribute |
| (HTML | Case2: “small” img with empty attribute |
| description) | |
| Example use, | set alt attribute to be (blank) |
| WCAG | |
| description | |

TABLE A-28

| Field | Description |
|---|---|
| Dependency | H-2 |
| Transformation | 1.1.10 |
| Number | |
| Knowledge gap | Equivalents and function and role of a map area |
| Logic | a client side image map with no or empty alt in area tag |
| Used for | map/area |
| About | An Image map is a picture with different clickable |
| | regions. If there is no text equivalent, knowledge capture |
| | should probably be about were each regain |
| | links to (such as the title or role of a destination page |
| Best guess | capture the name/title role of each linked to resource. |
| Editor supplied | Confirm edit or change the best guess add new |
| knowledge | information where no guess exists |
| Example case | Case1: an area inside a map with empty alt attribute |
| (HTML | Case2: an area inside a map with no alt attribute |
| description) | |
| Example use, | Add alt attribute with go to name/title of the page |
| WCAG | |
| description | |

TABLE A-29

| Field | Description |
|---|---|
| Dependency | H-2 |
| Transformation | 1.1.12 |
| Number | |
| Knowledge gap | Role of the image ma |
| Logic | for any image used for client or server-side image |
| | map, need to provide an alt |
| Used for | provide alt attribute for image used for a map |
| About | With an image map, knowledge is needed about the |
| | whole map - Eg, a summary on how to use the map and |
| | what content is contained, expected, and other |
| | information such as how clickable areas connect |
| Best guess | Ask editor |
| Editor supplied | General knowledge about the whole map |
| knowledge | |
| Example case | Case1: for image used as a server-side image map, |
| (HTML | provide an alt attribute, if doesn't have one |
| description) | Case2: for image used as a client-side image map, |
| | provide an alt attribute, if doesn't have one |
| Example use, | add alt attribute |
| WCAG | |
| description | |

TABLE A-30

| Field | Description |
|---|---|
| Dependency | H-2 |
| Transformation | 1.1.16 |
| Number | |
| Knowledge gap | Role of control |
| Logic | Input as an image where there is no alt attribute |
| | for text equivalency |
| Used for | text equivalency can be used as an alt attribute or as the |
| | text on a button in a true text rendering |
| About | Form controls sometimes need text equivalent (such as |
| | an image used as a input control) |
| Best guess | Often we can get this information from the control type |
| | and form name and action |
| | If we do not have the form role, we can get it now |
| Editor supplied | Confirm edit or change the best guess add new |
| knowledge | information where no guess exists |
| Example case | Case1: input (inside a form) is a graphical |
| (HTML | button without alt attribute |
| description) | Case2: input (inside a form) is a graphic |
| | with empty alt attribute |
| Example use, | set the alt attribute to “go [form name]” |
| WCAG | |
| description | |

TABLE A-31

| Field | Description |
|---|---|
| Dependency | H-2 |
| Transformation | 1.1.17 |
| Number | |
| Knowledge gap | Role of control |
| Logic | Button contains an image where there is no |
| | alt attribute for text equivalency |
| Used for | text equivalency can be used as an alt attribute or as the |
| | text on a button in a true text rendering |
| About | Form controls sometimes need text equivalent In this |
| | case we have a button that does not have text |
| | explaining its role (may use an image) |
| Best guess | we can get this information from the control |
| | type and form name and action |
| Editor supplied | Confirm edit or change the best guess add new |
| knowledge | information where no guess exists |
| Example case | Case1: button (inside a form) is a graphic and there |
| (HTML | is no alt attribute for the descendant img tag set |
| description) | Case2: button (inside a form) is a graphic and there is |
| | an empty alt attribute for the descendant img tag |
| Example use, | set the alt attribute to “go [form name]” |
| WCAG | |
| description | |

TABLE A-32

| Field | Description |
|---|---|
| Dependency | H-2 |
| Transformation | 1.1.30 |
| Number | |
| Knowledge gap | Full description and information in an image |
| Logic | img tag that needs additional information to be provided |
| | and doesn't have a longdesc attribute img needs |
| | additional information, if it is “big” enough. |
| | Also, need to provide description link for user agents |
| | that don't support longdesc |
| Used for | provide additional information when a short text |
| | equivalent does not suffice to adequately convey |
| | the function or role of an image |
| About | img may need additional information This is typical of |
| | large images, provide additional information when a |
| | short text equivalent does not suffice to adequately |
| | convey the function or role of an image and all |
| | text that may be on it |
| Best guess | |
| Editor supplied | knowledge is needed about the long description |
| knowledge | |
| Example case | Case1: longdesc is missing in “big” img and d-link is |
| (HTML | missing and the img is not inside a link |
| description) | Case2: longdesc is missing in “big” img and d-link is |
| | missing and the img is not inside a link |
| | Case3: longdesc is missing in “big” img and d-link is |
| | missing and the img is inside a link |
| | Case4: longdesc is missing in “big” img and d-link is |
| | missing and the img is inside a link |
| Example use, | Add d link and long desc attribute to img |
| WCAG | |
| description | |

TABLE A-33

| Field | Description |
|---|---|
| Dependency | H-2 |
| Transformation | 15.1.2 |
| Number | |
| Knowledge gap | |
| Logic | For every tag with a style, move the style to css |
| | and get a class attribute |
| Used for | daisy book |
| About | For every tag with a style, move the style to css |
| | and get a class attribute |
| Best guess | daisy book |
| Editor supplied | None |
| knowledge | |
| Example case | Move style attribute to css, and construct a |
| (HTML | class attribute. The positioning should stay in the |
| description) | style (position, top and left properties), the |
| | order of the properties should be insignificant. |
| Example use, | create class attribute and maybe leave style |
| WCAG | attribute with positioning predicates |
| description | |

TABLE A-34

| Field | Description |
|---|---|
| Dependency | H-2 |
| Transformation | 3.4.1 |
| Number | |
| Knowledge gap | Map to relative units |
| Logic | For each attribute that specifies units of measure, check that relative rather |
| | than absolute units are used, e.g. that em and % are used instead of pt, cm |
| | etc. |
| Used for | check for use of relative rather than absolute units of measure |
| About | Relative units are ones that expand easy at the user request which is good for |
| | enlargements. For each attribute that specifies units of measure, check that |
| | relative rather than absolute units are used, e.g. that em and % are used |
| | instead of pt, cm etc. When non expandable units are sued we need to map to |
| | relative ones |
| Best guess | Automatically convert absolute to relative equivalent |
| | Algorithm takes cascading affect into account and them maps the “total” size |
| | relative to the base size, and maps to equivalent non relative size |
| Editor supplied | None |
| knowledge | |
| Example case | Case1: if there is an attribute that contains measure units, it should contain |
| (HTML | em or %, otherwise it uses absolute units. The only exception is img tag |
| description) | where absolute measure units are allowed. |
| | Case2: if there is a style attribute that contains css property that needs |
| | measure unit, it should contain em or %, otherwise it uses absolute units. |
| | Case3: if there is a style tag that contains css property that needs measure |
| | unit, it should contain em or %, otherwise it uses absolute units. |
| Example use, | Put relative units and sizes in HTML |
| WCAG | |
| description | |

TABLE A-35

| Field | Description |
|---|---|
| Dependency | H-2 |
| Transformation | 3.4.2 |
| Number | |
| Knowledge gap | Map to relative units |
| Logic | For each attribute that specifies units of measure, check that relative rather |
| | than absolute units are used, e.g. that em and % are used instead of pt, cm |
| | etc. |
| Used for | check for use of relative rather than absolute units of measure |
| About | When non expandable units are sued we need to map to relative ones. For |
| | each attribute that specifies units of measure, check that relative rather than |
| | absolute units are used, e.g. that em and % are used instead of pt, cm etc. |
| Best guess | Automatically convert absolute to relative equivalent |
| | Algorithm takes cascading affect into account and them maps the “total” size |
| | relative to the base size, and maps to equivalent non relative size |
| Editor supplied | None |
| knowledge | |
| Example case | Case1: if there is a style attribute that contains css property that needs |
| (HTML | measure unit, it should contain em or %, otherwise it uses absolute units. |
| description) | Case2: if there is a style tag that contains css property that needs measure |
| | unit, it should contain em or %, otherwise it uses absolute units. |
| Example use, | Put relative units and sizes in HTML |
| WCAG | |
| description | |

TABLE A-36

| Field | Description |
|---|---|
| Dependency | H-2 |
| Transformation | 3.4.3 |
| Number | |
| Knowledge gap | Map to relative units |
| Logic | If font tag has size attribute, it should contain + or − |
| | signs, e.g. it shouldn't use absolute measure units |
| Used for | check for use of relative rather than absolute units of |
| | measure |
| About | When non expandable units are sued we need to map to |
| | relative ones. If font tag has size attribute, it should |
| | contain + or − signs, e.g. it shouldn't use absolute |
| | measure units |
| Best guess | Automatically convert absolute to relative equivalent |
| | Algorithm takes cascading affect into account and them |
| | maps the “total” size relative to the base size, |
| | and maps to equivalent non relative size |
| Editor supplied | None |
| knowledge | |
| Example case | if there is a size attribute in font tag, it should |
| (HTML | contain + or −, otherwise it uses absolute units. |
| description) | |
| Example use, | Put relative units and sizes in HTML |
| WCAG | |
| description | |

TABLE A-37

| Field | Description |
|---|---|
| Dependency | H-3 |
| Transformation | 1.1.8 |
| Number | |
| Knowledge gap | Meaning, information and description of an image |
| Logic | an image with no alt attribute for text equivalency. |
| | An image is not a bullet and it's not a spacer image |
| | and not in a link |
| Used for | Images |
| About | Image without text equivalent - not a known case |
| | but large enough width and height to have content, |
| | although it is not embedded in a link or positioned |
| | as a button or bullet |
| Best guess | if the image has meaning or information, then that needs |
| | to be known. If not then the image should probably |
| | be described |
| Editor supplied | Editor need to supply knowledge |
| knowledge | |
| Example case | Case1: an image without an alt and is not a spacer image |
| (HTML | and not a bullet (from dependencies) |
| description) | Case2: an image with empty alt and is not a spacer image |
| | and not a bullet (from dependencies) |
| Example use, | add alt attribute with value |
| WCAG | |
| description | |

TABLE A-38

| Field | Description |
|---|---|
| Dependency | H-3 |
| Transformation | 3.5.3 |
| Number | |
| Knowledge gap | Structural role of the paragraphs |
| Logic | header tag used for formatting |
| Used for | Replace header tag used for formatting with p tag using bold (options may be |
| | p with stylesheet or blockquote tag). |
| About | Header tags are sometimes used for formatting text that in fact is not a |
| | header. In other words - tags have been used incorrectly and provide |
| | misinformation to assistive technologies. The true structural information |
| | needs to be captured. Headers the are relatively long, is an example were this |
| | may occur |
| Best guess | These are paragraphs and not headers |
| Editor supplied | Confirm, edit or change the best guess add new information where necessary |
| knowledge | |
| Example case | h1 tag is used for formatting - content is too long - more than 100 characters |
| (HTML | (may be changed |
| description) | |
| Example use, | replace the header tag with p and class name we need to create css classes |
| WCAG | h1-h6 for each heading level |
| description | |

TABLE A-39

| Field | Description |
|---|---|
| Dependency | H-3 |
| Transformation | 3.5.4 |
| Number | |
| Knowledge gap | Structural role of the paragraphs |
| Logic | header tag used for formatting |
| Used for | replace header tag used for formatting with p tag using |
| | bold (options may be p with stylesheet or blockquote tag) |
| About | other catches for header tag used for formatting |
| Best guess | These are paragraphs and not headers |
| Editor supplied | Confirm, edit or change the best guess add new |
| knowledge | information where necessary |
| Example case | h2 tag is used for formatting - content is too |
| (HTML | long - more than 100 characters(may be changed) |
| description) | |
| Example use, | replace the header tag with p and class name we need |
| WCAG | to create css classes h1-h6 for each heading level |
| description | |

TABLE A-40

| Field | Description |
|---|---|
| Dependency | H-3 |
| Transformation | 3.5.5 |
| Number | |
| Knowledge gap | Structural role of the paragraphs |
| Logic | header tag used for formatting |
| Used for | replace header tag used for formatting with p tag using |
| | bold (options may be p with stylesheet or blockquote tag) |
| About | other catches for header tag used for formatting |
| Best guess | These are paragraphs and not headers |
| Editor supplied | Confirm, edit or change the best guess add new |
| knowledge | information where necessary |
| Example case | h3 tag is used for formatting - content is too |
| (HTML | long - more than 100 characters(may be changed) |
| description) | |
| Example use, | replace the header tag with p and class name we |
| WCAG | need to create CSS classes h1-h6 for each heading level |
| description | |

TABLE A-41

| Field | Description |
|---|---|
| Dependency | 3.5.6 |
| Transformation | H-3 |
| Number | |
| Knowledge gap | Structural role of the paragraphs |
| Logic | header tag used for formatting |
| Used for | replace header tag used for formatting with p tag using |
| | bold (options may be p with stylesheet or blockquote |
| | tag). |
| About | other catches header tag used for formatting |
| Best guess | These are paragraphs and not headers |
| Editor supplied | Confirm, edit or change the best guess add new |
| knowledge | information where necessary |
| Example case | Case 1: h4 tag is used for formatting - content is too |
| (HTML | long - more than 100 characters(may be changed) |
| description) | |
| Example use, | replace the header tag with p and class name we need |
| WCAG | to create css classes h1-h6 for each heading level |
| description | |

TABLE A-42

| Field | Description |
|---|---|
| Dependency | 3.5.7 |
| Transformation | H-3 |
| Number | |
| Knowledge gap | Structural role of the paragraphs |
| Logic | header tag used for formatting |
| Used for | Replace header tag used for formatting with p tag using |
| | bold (options may be p with stylesheet or blockquote |
| | tag). |
| About | other catches header tag used for formatting |
| Best guess | These are paragraphs and not headers |
| Editor supplied | Confirm, edit or change the best guess add new |
| knowledge | information where necessary |
| Example case | Case 1: h5 tag is used for formatting - content is too |
| (HTML | long - more than 100 characters(may be changed) |
| description) | |
| Example use, | replace the header tag with p and class name we need |
| WCAG | to create css classes h1-h6 for each heading level |
| description | |

TABLE A-43

| Field | Description |
|---|---|
| Dependency | 3.5.8 |
| Transformation | H-3 |
| Number | |
| Knowledge gap | Structural role of the paragraphs |
| Logic | header tag used for formatting |
| Used for | Replace header tag used for formatting with p tag using |
| | bold (options may be p with stylesheet or blockquote |
| | tag). |
| About | other catches header tag used for formatting |
| Best guess | These are paragraphs and not headers |
| Editor supplied | Confirm, edit or change the best guess add new |
| knowledge | information where necessary |
| Example case | Case 1: h5 tag is used for formatting - content is too |
| (HTML | long - more than 100 characters(may be changed) |
| description) | |
| Example use, | replace the header tag with p and class name we need |
| WCAG | to create css classes h1-h6 for each heading level |
| description | |

TABLE A-44

| Field | Description |
|---|---|
| Dependency | 5.0.1 |
| Transformation | H-3 |
| Number | |
| Knowledge gap | What is the base role of the table |
| Logic | check conditions for data table |
| Used for | make a control rdf statement for each distinct table |
| About | Data tables need to be identified and known. Indicates for a data table include |
| | a table with borders, a table with cells that contain numbers, or short |
| | text without links etc . . . |
| Best guess | This is a data table |
| Editor supplied | Confirm, edit or change the best guess |
| knowledge | |
| Example case | Case1: One case of data table is if table doesn't contain any other |
| (HTML | tables, has more then two column and rows, and content of each td is |
| description) | less than a threshold. td tag inside first tr tag of the data table |
| | Case2: Another case of data table is if table's border attribute is set |
| | td tag inside first tr tag of the data table. |
| | Case3: Another case of data table is if there is at least one td in the |
| | table with just a number in it td tag inside first tr tag of the data table. |
| | Case4: This case is when there is at least one th in the table. If so, we |
| | want to confirm that this is a data table. |
| Example use, | The action will create a special “control” action in rdf statement to |
| WCAG | reference another transformations that are dealing with the same |
| description | data table. And also will add a temporary dataT attribute, that will |
| | identify this table as data table |

TABLE A-45

| Field | Description |
|---|---|
| Dependency | 5.1.1 |
| Transformation | H-3 |
| Number | |
| Knowledge gap | Table structure |
| Logic | td tag in the first tr of data table (must be header) The substitution of |
| | td cell to th cells is done only if there are no th cells in the table at |
| | all. Otherwise, if there is something in the table, it means that the |
| | author intentionally left some td's instead of th's. |
| Used for | identifying table headers |
| About | if we know a table is a dtata table then we should identify what is |
| | it's structure and what cells are headers. The first cell is typically a |
| | header. (must be header)But we are only confident of that if there |
| | are no cells marked as a header in the table at all. Otherwise, if there |
| | are some th (header) in the table, it means that the author intentionally left |
| | some td's (non headers) instead of th's. |
| Best guess | First columns act as headers |
| Editor supplied | Confirm, edit or change the best guess add new information where |
| knowledge | necessary |
| Example case | Case1: td tag inside first tr tag of the data table.The table is missing |
| (HTML | th tags One case of data table is if table doesn't contain any other |
| description) | tables, has more then two column and rows, and content of each td is |
| | less than a threshold. |
| Example use, | replace td with th. If there is a td tag in first tr in the table, we need |
| WCAG | to delete it and put a th tag instead with scope = “col” and content |
| description | remains as it was in td tag |

TABLE A-46

| Field | Description |
|---|---|
| Dependency | 5.1.2 |
| Transformation | H-3 |
| Number | |
| Knowledge gap | Table structure |
| Logic | First td tag in not first tr (must be header) This transformation is |
| | dependent on the previous one, ie for sure there are th's in the table, |
| | either inserted by the author or the previous one. We need to add row |
| | headers in this transformation only if the column headers were added by the |
| | previous transformation and not by the author. We check it (for now) |
| | by looking at the first th in the first tr - if it contains scope attribute, we |
| | decide to add row headers. This algorithm may change in the future. |
| Used for | identifying table headers |
| About | first cell in each column (may be header) This transformation is |
| | dependent on the previous one, ie for sure there are th's in the table, |
| | either inserted by the author or the previous one. We need to add |
| | row headers in this transformation only if the column headers were |
| | added by the previous transformation and not by the author. We |
| | check it (for now) by looking at the first th in the first tr (cell) - if it |
| | contains scope attribute, we decide to add row headers. This |
| | algorithm may change in the future. |
| Best guess | First row act as headers (user need to confirm and add any rows that |
| | act as headers) |
| Editor supplied | Confirm, edit or change the best guess add new information where |
| knowledge | necessary |
| Example case | Case1: first td tag inside non-first tr tag. Table doesn't have any th |
| (HTML | tags. |
| description) | |
| Example use, | Replace td with th. If there is a first td tag in non-first tr in the table, |
| WCAG | we need to delete it and put a th tag instead with scope = “row” and |
| description | content remains as it was in td tag |

TABLE A-47

| Field | Description |
|---|---|
| Dependency | 5.2.1 |
| Transformation | H-3 |
| Number | |
| Knowledge gap | Association of data table cells with headers |
| Logic | If none of column table cells have scope or headers attributes, need to |
| | assign scope attributes for header cells. |
| Used for | Associate data table cells with headers. |
| About | We need to define what cells fall under what header cells if none of column |
| | table cells have scope or headers attributes, need to assign scope attributes |
| | for header cells. Our first guess will be the headers under which each cell falls |
| | (vertical and horizontal) is its ‘headers’. |
| Best guess | Table cells are logically under the any column headers that they fall |
| | under visually |
| Editor supplied | Confirm, edit or change the best guess add new information where |
| knowledge | necessary |
| Example case | Case1: for th tag with no scope attribute in the data table, add scope |
| (HTML | attribute to the th |
| description) | |
| Example use, | add scope attribute with value col to the th |
| WCAG | |
| description | |

TABLE A-48

| Field | Description |
|---|---|
| Dependency | 5.5.1 |
| Transformation | H-3 |
| Number | |
| Knowledge gap | Summary of a data tables |
| Logic | check the conditions for the data table, |
| | and if it doesn't contain a |
| | summary attribute, add one |
| Used for | assigning summary attribute for data tables |
| About | A complex data table, needs a summary attribute, |
| Best guess | Ask editor for the summary |
| Editor supplied | Table summary |
| knowledge | |
| Example case | Case1: If there is a complex data table |
| (HTML | without a summary attribute, |
| description) | need to provide a summary |
| Example use, | add summary attribute with data table |
| WCAG | |
| description | |

TABLE A-49

| Field | Description |
|---|---|
| Dependency | 5.5.2 |
| Transformation | H-3 |
| Number | |
| Knowledge gap | Table title and caption |
| Logic | for data table without caption child tag and without title attribute, |
| | but with a simple text right after it, need to provide either one |
| Used for | provide caption tag or title attribute for every data table |
| About | A data table should have a caption or title associated with it, Often a |
| | caption need has been provide in the page, but not pragmatically marked |
| | as a caption |
| Best guess | Associate short simple text after a table as a caption |
| Editor supplied | Confirm, edit or change the best guess add new information where |
| knowledge | necessary |
| Example case | Case1: table tag with no caption child tag, and the first node after |
| (HTML | the table is simple text, that is probably instead of caption |
| description) | |
| Example use, | add caption tag, put the simple text that is after the table as a content of |
| WCAG | caption. Also, add title attribute for a table. The user will choose either |
| description | to do caption or title |

TABLE A-50

| Field | Description |
|---|---|
| Dependency | 5.5.3 |
| Transformation | H-3 |
| Number | |
| Knowledge gap | Table title and caption |
| Logic | for data table without caption child tag and without title attribute, but |
| | with a simple text right before it, need to provide either one |
| Used for | provide caption tag or title attribute for every data table |
| About | A data table should have a caption or title associated with it, Often a |
| | caption need has been provide in the page, but not pragmatically marked |
| | as a caption |
| Best guess | Associate short simple text before a table as a caption |
| Editor supplied | Confirm, edit or change the best guess add new information where |
| knowledge | necessary |
| Example case | Case1: table tag with no caption child tag, and the first node before |
| (HTML | the table is simple text, that is probably instead of caption |
| description) | |
| Example use, | add caption tag, put the simple text that is before the table as a content |
| WCAG | of caption. Also, add title attribute for a table. The user will choose |
| description | either to do caption or title |

TABLE A-51

| Field | Description |
|---|---|
| Dependency | 5.5.4 |
| Transformation | H-3 |
| Number | |
| Knowledge gap | Table title and caption |
| Logic | for data table without caption child tag |
| | and without title attribute, |
| | need to provide either one |
| Used for | provide caption tag or title attribute for every data table |
| About | for data table without caption or title we need to get this |
| | information |
| Best guess | Ask editor to caption or title |
| Editor supplied | Confirm, edit or change the best guess add |
| knowledge | new information where necessary |
| Example case | Case1: table tag with no caption |
| (HTML | child tag, and the first node after the table |
| description) | is simple text, that is probably instead of caption |
| Example use, | add caption tag. Also, add title attribute for a table. |
| WCAG | The user will choose either to do caption or title |
| description | |

TABLE A-52

| Field | Description |
|---|---|
| Dependency | 1.1.9 |
| Transformation | H-4 |
| Number | |
| Knowledge gap | Role, equivalent or function of an image |
| Logic | image not inside a link with alt attribute |
| | with non meaningful content |
| Used for | provide a meaningful content for alternative text |
| About | Image not inside a link with a text equivalent with |
| | non meaningful content such as “click here”. |
| Best guess | 3^{rd} party OCR called by screen |
| Editor supplied | Confirm, edit or change the best guess |
| knowledge | add new information where necessary |
| Example case | Case1: image not inside a link with alt |
| (HTML | attribute with non-meaningful text |
| description) | |
| Example use, | add notification of non-meaningful alt text |
| WCAG | |
| description | |

TABLE A-53

| Field | Description |
|---|---|
| Dependency | 1.1.1 |
| Transformation | H-4 |
| Number | |
| Knowledge gap | Role, equivalent or function of an image |
| Logic | image inside a link with alt attribute with non |
| | meaningful content |
| Used for | provide a meaningful content for alternative text |
| About | image inside a link with a text equivalent with |
| | non meaningful content |
| Best guess | meaningful alternative text - that should |
| | probably be the role or title of the linked to page |
| Editor supplied | Confirm, edit or change the best guess |
| knowledge | add new information where necessary |
| Example case | Case1: image inside a link with alt |
| (HTML | attribute with non-meaningful text |
| description) | |
| Example use, | add notification of non-meaningful alt text |
| WCAG | |
| description | |

TABLE A-54

| Field | Description |
|---|---|
| Dependency | 1.1.2 |
| Transformation | H-4 |
| Number | |
| Knowledge gap | Role of each image map regain |
| Logic | area with alt attribute with non meaningful content |
| Used for | provide a meaningful content for alternative text |
| About | an Image map is a picture with different |
| | clickable regions. If there is a text equivalent, |
| | but it is not very meaningful then we may need |
| | more knowledge. Knowledge capture should |
| | probably be about were each regain links to |
| | (such as the title or role of a destination page |
| Best guess | Role of linked to page where each regain links to |
| Editor supplied | Confirm, edit or change the best guess |
| knowledge | add new information where necessary |
| Example case | Case1: area with alt attribute with non-meaningful text |
| (HTML | |
| description) | |
| Example use, | add notification of non-meaningful alt text |
| WCAG | |
| description | |

TABLE A-55

| Field | Description |
|---|---|
| Dependency | 1.1.11 |
| Transformation | H-4 |
| Number | |
| Knowledge gap | Role of form control |
| Logic | input as an image with alt attribute with |
| | non meaningful content |
| Used for | provide a meaningful content for alternative text |
| About | A form control input button without text (such as |
| | an image) knowledge is missing as to what |
| | happens when the button is selected |
| Best guess | Typically the input type (such as submit) and |
| | form name and destination may provide help as to |
| | build this information |
| Editor supplied | Confirm, edit or change the best guess |
| knowledge | add new information where necessary |
| Example case | Case1: input (inside a form) is a graphical button with |
| (HTML | non-meaningful alt attribute |
| description) | |
| Example use, | add notification of non-meaningful alt text |
| WCAG | |
| description | |

TABLE A-56

| Field | Description |
|---|---|
| Dependency | 1.5.2 |
| Transformation | H-4 |
| Number | |
| Knowledge gap | Extra link may be needed |
| Logic | if area tag is used inside a client-side image map, and there doesn't |
| | exist any a tag with the same href as this area tag, need to add ‘a’ tag |
| | with redundant text link right after the map. |
| Used for | provide redundant text links for client-side image maps |
| About | Image maps can be hard to use, we need to know when there only |
| | way to get to a page is through an image map area. |
| Best guess | If a link to the same resource is not provided though a link tag then a redundant |
| | link may be needed |
| Editor supplied | Confirm, edit or change the best guess add new information where |
| knowledge | necessary |
| Example case | Case1: for each area tag, if there is no redundant text link for it on the page, |
| (HTML | provide one. |
| description) | |
| Example use, | provide redundant text links for client-side image maps |
| WCAG | |
| description | |

TABLE A-57

| Field | Description |
|---|---|
| Dependency | 3.5.01 |
| Transformation | H-4 |
| Number | |
| Knowledge gap | Structure of page |
| Logic | If there is strong/em/b/i/u/span tag that formats short text and is not |
| | part of container identified as header, maybe need to identify this as a |
| | header. |
| Used for | identify headers |
| About | Identify headers and structural information. if there is formats that |
| | look like they have been used to emphasize text eg |
| | strong/em/b/i/u/span tag that formats short text and is not part of |
| | container identified as header, maybe need to identify this as a |
| | header. Short text before a long text may also be a header. |
| Best guess | This is a header - that follows the structure of the page so far |
| Editor supplied | Confirm, edit or change the best guess add new information where |
| knowledge | necessary |
| Example case | Case1: formatting tag with short text, not part of short formatting container |
| (HTML | |
| description) | |
| Example use, | identify this tag as a header |
| WCAG | |
| description | |

TABLE A-58

| Field | Description |
|---|---|
| Dependency | 3.5.1 |
| Transformation | H-4 |
| Number | |
| Knowledge gap | Structure of page |
| Logic | container that may be a header, well encoded |
| Used for | when container text is formatted to look like a header, identify it as a |
| | header |
| About | more catches for when container text all the text is formatted to look |
| | like a header, identify it as a header |
| Best guess | This is a header - that follows the structure of the page so far |
| Editor supplied | Confirm, edit or change the best guess add new information where |
| knowledge | necessary |
| Example case | Case1: container tag that doesn't contain any bad formatting tags or |
| (HTML | attributes that format all the content of the container and contain |
| description) | some well written formatting tags that format all the content of the container. |
| Example use, | |
| WCAG | |
| description | |

TABLE A-59

| Field | Description |
|---|---|
| Dependency | 3.5.2 |
| Transformation | H-4 |
| Number | |
| Knowledge gap | Structure of page |
| Logic | container that may be a header, badly encoded |
| Used for | when container text is formatted to look like a header, identify it as a |
| | header |
| About | when container text is formatted to look like a header, identify it as a |
| | header. Container that may be a header, badly encoded and not identified |
| | so far |
| Best guess | This is a header - that follows the structure of the page so far |
| Editor supplied | Confirm, edit or change the best guess add new information where |
| knowledge | necessary |
| Example case | Case1: container tag that contain some bad formatting tags or |
| (HTML | attributes (and maybe also some good formatting tags as well) that |
| description) | format all the content of the container. |
| Example use, | |
| WCAG | |
| description | |

TABLE A-60

| Field | Description |
|---|---|
| Dependency | 5.4.1 |
| Transformation | H-4 |
| Number | |
| Knowledge gap | Structure of table |
| Logic | For th tag in a layout table, need to turn it into td with css class. |
| | Layout table is a table without caption or title, because this |
| | transformation is dependent on transformation assigning |
| | caption/title for data tables |
| Used for | replace th tags in layout tables with appropriate markup |
| About | if there are header cells (th) in a table that we know has just been |
| | used for layout (and not data) then that use of table header tags is |
| | incorrect and misinformation. The header tag was probably used for |
| | formatting. Steps need are: to capture what there real structure of the |
| | document, capture the reference for alternate style in a style sheet. |
| | And create the class if necessary. (for th tag in a layout table, need |
| | to turn it into td with css class. Layout table is a table without |
| | caption or title, because this transformation is dependent on |
| | transformation assigning caption/title for data tables) |
| Best guess | This is a normal table cell |
| Editor supplied | None |
| knowledge | |
| Example case | Case1: if there is a th in the table that doesn't have caption and title, it |
| (HTML | means that it was marked as not data table by the user, hence we |
| description) | need to change all th tags to td. |
| Example use, | replace th with td and write a css class |
| WCAG | |
| description | |

TABLE A-61

| Field | Description |
|---|---|
| Dependency | 5.4.2 |
| Transformation | H-4 |
| Number | |
| Knowledge gap | Structure of table |
| Logic | For th tag in a layout table, need to turn it into td with css class. |
| | Layout table is a table without caption or title, because this |
| | transformation is dependent on transformation assigning |
| | caption/title for data tables |
| Used for | replace th tags in layout tables with appropriate markup |
| About | If there are header cells (th) in a table that we know has just been |
| | used for layout (and not data) then that use of table header tags is |
| | incorrect and misinformation. The header tag was probably used for |
| | formatting. Steps need are: to capture what there real structure of the |
| | document, capture the reference for alternate style in a style sheet. |
| | And create the class if necessary. for th tag in a layout table, need to |
| | turn it into td with css class. Layout table is a table without caption |
| | or title, because this transformation is dependent on transformation assigning |
| | caption/title for data tables |
| Best guess | This is a normal table cell |
| Editor supplied | None |
| knowledge | |
| Example case | Case1: if there is a th in the table that is not a data table |
| (HTML | |
| description) | |
| Example use, | replace th tags in layout tables with appropriate markup |
| WCAG | |
| description | |

TABLE A-62

| Field | Description |
|---|---|
| Dependency | 5.5.5 |
| Transformation | H-4 |
| Number | |
| Knowledge gap | Summary of a table |
| Logic | for a layout table without a summary |
| | attribute, need to add empty summary |
| Used for | assigning summary attribute for layout tables |
| About | for a layout table without a summary attribute, |
| | probably does not need one summary |
| Best guess | Summary = “” |
| Editor supplied | None |
| knowledge | |
| Example case | Case1: If there is a layout table without |
| (HTML | a summary attribute, need to |
| description) | provide an empty summary. The layout |
| | table is table without caption and title, |
| | because of the Dependency |
| Example use, | add empty summary attribute |
| WCAG | |
| description | |

TABLE A-63

| Field | Description |
|---|---|
| Dependency | 5.6.1 |
| Transformation | H-4 |
| Number | |
| Knowledge gap | Abbreviation for header |
| Logic | if th tag content is too long, need to provide an abbreviation for the |
| | header |
| Used for | adding abbr attribute to long headers |
| About | if table headers are too long then an abbreviation of the header is |
| | useful when letting the user know what headers each cell is |
| | identified with |
| Best guess | Use look up table with lexicon rules |
| | Or the first letter of each word in the header. |
| Editor supplied | Confirm, edit or change the best guess add new information where |
| knowledge | necessary |
| Example case | Case1: th with long content and without abbr attribute |
| (HTML | Case2: th with long content and with empty abbr attribute |
| description) | Case3: td which will be converted to th with long content and |
| | without abbr attribute |
| | Case4: td which will be converted to th with long content and with empty |
| | abbr attribute |
| Example use, | add abbr attribute with th |
| WCAG | |
| description | |

TABLE A-64

| Field | Description |
|---|---|
| Dependency | 13.6.12 |
| Transformation | H-4 |
| Number | |
| Knowledge gap | Page sections - Start of main content |
| Logic | if there is a skip over navigational links, don't need |
| | to try and identify it again |
| Used for | check if there is a skip link to main content |
| About | if there is a skip over navigational links, we know were |
| | the navigation ends and main content section of a |
| | page starts |
| Best guess | Destination of a skip link to main content is the start |
| | of the section of main content |
| Editor supplied | Confirm, edit or change the best guess add new |
| knowledge | information where necessary |
| Example case | Case1: for all in-site links, ask the user if any of them |
| (HTML | is a skip over navigation link. Here catch only the first |
| description) | link as a default. All others will be fetched in the |
| | wizard process. |
| Example use, | if there is a skip link on the page, a special attribute |
| WCAG | will be added to the body tag, that will be deleted in |
| description | the rendering |

TABLE A-65

| Field | Description |
|---|---|
| Dependency | 15.1.8 |
| Transformation | H-4 |
| Number | |
| Knowledge gap | Caption for layout tables |
| Logic | Every table (even layout) must have a caption for the |
| | daisy linking |
| Used for | daisy book |
| About | Every table (even layout) must have a caption for the |
| | daisy linking |
| Best guess | Ask editor for captions |
| Editor supplied | Confirm, edit or change the best guess add new |
| knowledge | information where necessary |
| Example case | Case1: every table without caption needs to be provided |
| (HTML | one |
| description) | |
| Example use, | ask to provide a caption |
| WCAG | |
| description | |

TABLE A-66

| Field | Description |
|---|---|
| Dependency | 3.3.13 |
| Transformation | H-4 |
| Number | |
| Knowledge gap | Associating content and style |
| Logic | move content of style tags to css |
| Used for | Use style sheets to control layout and presentation |
| About | Presentational information should be separated from |
| | other content. Where they have been mixed up it is |
| | useful to separate them. When we do we create a |
| | knowledge base reference linking styled content in |
| | the page to style information in a class in a style sheet. |
| | We need to build the knowledge base relationship and, |
| | when we do not have it already add style information |
| | to a css that acts as a resource, and catch implications |
| | of the style. In this case we move content of style |
| | tags to css and presentation |
| Best guess | Create CSS class based presentational information |
| | (unless one exists already) |
| | Create association between content and CSS |
| | This is normally automatic |
| | User can edit if they choose |
| Editor supplied | None |
| knowledge | |
| Example case | Case1: for any style tag, move it's content to stylesheet |
| (HTML | and delete the tag. |
| description) | |
| Example use, | Move content to stylesheet - path content indicates that |
| WCAG | there should be a for-each in the xslB for given XPath to |
| description | construct the CSS string. |

TABLE A-67

| Field | Description |
|---|---|
| Dependency | 3.3.14 |
| Transformation | H-4 |
| Number | |
| Knowledge gap | Associating, role and implication of style |
| Logic | move content of comment inside style attributes to css |
| Used for | Use style sheets to control layout and presentation |
| About | Content of comment inside style attributes may have |
| | useful knowledge about the style. |
| Best guess | Ask user for associations, or just put comment in css |
| | resource |
| Editor supplied | Confirm, edit or change the best guess add new |
| knowledge | information where necessary |
| Example case | Case1: for any comment inside style tag, move it's |
| (HTML | content to stylesheet and delete the tag. |
| description) | |
| Example use, | Move content to stylesheet - path content indicates that |
| WCAG | there should be for-each in the xslB for given XPath to |
| description | construct the CSS string. |

TABLE A-68

| Field | Description |
|---|---|
| Dependency | 3.3.15 |
| Transformation | H-4 |
| Number | |
| Knowledge gap | Associating content and style |
| Logic | for every a tag that is inside a body with link, alink or |
| | vlink attributes, and doesn't have a class name, |
| | need to asign a class name for the link within |
| | this type of body. |
| Used for | move styles to css and not override over several pages. |
| About | for every a tag that is inside a body with link, alink or |
| | vlink attributes, and doesn't have a class name, |
| | need to asign a class name for the link within this |
| | type of body. |
| Best guess | Create CSS class based presentational information |
| | (unless one exists already) |
| | Create association between content and CSS |
| | This is normally automatic |
| | User can edit if they choose |
| Editor supplied | None |
| knowledge | |
| Example case | Case1: link without class, inside body that defines |
| (HTML | link style |
| description) | |
| Example use, | assign class attribute basd on body link style definition |
| WCAG | |
| description | |

TABLE A-69

| Field | Description |
|---|---|
| Dependency | 3.7.1 |
| Transformation | H-4 |
| Number | |
| Knowledge gap | Associating content and style |
| | Structure of a document |
| Logic | if the blockquote tag doesn't contain quote marks, |
| | e.g. it is used just for formatting purposes, then it |
| | must be replaced with paragraph with indentation. |
| Used for | ensure that blockquote is not used for formatting |
| | purposes |
| About | if the blockquote tag doesn't contain quote marks, it is |
| | used just for formatting purposes, as a paragraph with |
| | indentation. Steps need is to capture what there real |
| | value/structure of the document, capture the reference |
| | for alternate style in a style sheet. And create the class |
| | if necessary |
| Best guess | Create CSS class based presentational information |
| | (unless one exists already) |
| | Create association between content and CSS |
| | This is normally automatic |
| | User can edit if they choose |
| Editor supplied | None |
| knowledge | |
| Example case | Case1: blockquote doesn't contain any quote |
| (HTML | marks - used only for formatting purposes The |
| description) | blockquote is not empty, and doesn't contain only nbsp. |
| Example use, | blockquote tag should be replaced with paragraph with |
| WCAG | indentation through css |
| description | |

TABLE A-70

| Field | Description |
|---|---|
| Dependency | 3.7.2 |
| Transformation | H-4 |
| Number | |
| Knowledge gap | Associating content and style |
| | Structure of a document |
| Logic | blockquotes cannot be nested - it is not allowed - need |
| | to replace them with indentation |
| Used for | replace nested blockquotes with indentation |
| About | blockquotes cannot be nested - it is not logic but is used |
| | to increase indentation. Steps need is to capture what |
| | there real value/structure of the document, capture the |
| | reference for alternate style in a style sheet. And create |
| | the class if necessary |
| Best guess | Create association between content and CSS class that |
| | indents |
| | This is normally automatic |
| | User can edit if they choose |
| Editor supplied | None |
| knowledge | |
| Example case | Case1: if there is a blockquote tag that is nested inside |
| (HTML | another one, two of them must be replaced with |
| description) | indentation |
| Example use, | replace blockquotes with indentation |
| WCAG | |
| description | |

TABLE A-71

| Field | Description |
|---|---|
| Dependency | 3.7.4 |
| Transformation | H-4 |
| Number | |
| Knowledge gap | Associating content and style |
| | Structure of a document |
| Logic | if the blockquote tag has empty content, it means that |
| | it is used for formatting purposes and should be |
| | replaced with CSS |
| Used for | ensure that blockquote is not used for formatting |
| | purposes |
| About | If the blockquote tag has empty content, it means that |
| | it is used for formatting purposes Steps need is to |
| | capture what there real value/structure of the document, |
| | capture the reference for alternate style in a style sheet. |
| | And create the class if necessary |
| Best guess | Create association between content and CSS class that |
| | indents |
| | This is normally automatic |
| | User can edit if they choose |
| Editor supplied | None |
| knowledge | |
| Example case | Case1: blockquote with no text - used only for |
| (HTML | formatting purposes |
| description) | Case2: blockquote with no text - contains only nbsps |
| Example use, | blockquote tag should be replaced with paragraph with |
| WCAG | indentation through css |
| description | |

TABLE A-72

| Field | Description |
|---|---|
| Dependency | 1.1.20 |
| Transformation | H-5 |
| Number | |
| Knowledge gap | What resources are flickering |
| | Full information on each image |
| | Is image used as a header |
| Logic | for any img, verify its alt attribute provided, and check if |
| | it flickers |
| Used for | confirm alt attributes and deal with flickering |
| About | for any image, that seems to have a text equivalent we |
| | need to verify that all information and text is captured, |
| | and check if it flickers and moving |
| | Is image used as text fro a heading? |
| Best guess | Check flicker, |
| | Confirm all information is provided |
| | This is not a header and does not have structural |
| | importance or other such role |
| Editor supplied | Confirm, edit or change the best guess add new |
| knowledge | information where necessary |
| Example case | Case1: for any image not inside link, verify alt and |
| (HTML | check flashing |
| description) | |
| Example use, | Replace flickering content with non flickering equivalent |
| WCAG | for users with photosensitive epilepsy, or who get |
| description | easily distracted |

TABLE A-73

| Field | Description |
|---|---|
| Dependency | 1.1.21 |
| Transformation | H-5 |
| Number | |
| Knowledge gap | What resources are flickering |
| | Full information on each image |
| | Role of image |
| Logic | for any img inside link, verify its alt attribute provided, |
| | and check if it flickers |
| Used for | confirm alt attributes and deal with flickering |
| About | for any image inside a link, that seems to have a text |
| | equivalent we need to verify that all information and |
| | text is captured, and check if it flickers and moving |
| Best guess | Check flicker, |
| | Confirm all information is provided |
| | This is not a header and does not have structural |
| | importance or other such role |
| Editor supplied | Confirm, edit or change the best guess add new |
| knowledge | information where necessary |
| Example case | Case1: for any image inside link, verify alt and check |
| (HTML | flashing |
| description) | |
| Example use, | Replace flickering content with non flickering equivalent |
| WCAG | for users with photosensitive epilepsy, or who get |
| description | easily distracted |

TABLE A-74

| Field | Description |
|---|---|
| Dependency | 1.1.23 |
| Transformation | H-5 |
| Number | |
| Knowledge gap | What resources are flickering |
| | Full information on each applet |
| Logic | for any applet, verify its alt attribute provided, and check if it |
| | flickers |
| Used for | confirm alt attributes and deal with flickering |
| About | for any applet, that seems to have a text equivalent we need to verify |
| | that all information and text is captured, and check if it flickers and |
| | moving, or other roles |
| Best guess | Check flicker, |
| | Confirm all information is provided |
| | This is not a header and does not have structural importance or other |
| | such role |
| Editor supplied | Confirm, edit or change the best guess add new information where |
| knowledge | necessary |
| Example case | Case1: for any applet, verify alt and check flashing |
| (HTML description) | |
| Example use, | Replace flickering content with non flickering equivalent for users |
| WCAG | with photosensitive epilepsy, or who get easily distracted |
| description | |

TABLE A-75

| Field | Description |
|---|---|
| Dependency | 3.3.1 |
| Transformation | H-5 |
| Number | |
| Knowledge gap | Association of styles with semantic content |
| Logic | table tag with bgcolor, background or bordercolor attribute |
| Used for | Take out the bgcolor, background and bordercolor (if any) attributes |
| | from the table tag and put it to css. |
| About | Presentational information should be separated from other content. |
| | Where they have been mixed up it is useful to separate them. When |
| | we do we create a knowledge base reference linking styled content |
| | in the page to style information in a class in a style sheet. We need |
| | to build the knowledge base relationship and, when we do not have |
| | it already add style information to a css that acts as a resource. In |
| | this case we know we need to do this because of the occurrence of |
| | table tag with bgcolor, background or bordercolor attribute |
| Best guess | This can be reliably captured automatically without user input. |
| | However the user may wish to edit the generated knowledge and |
| | styles anyway |
| Editor supplied | None |
| knowledge | |
| Example case | Case1: if there is a table container tag(table, tr, td, th) that has layout |
| (HTML description) | attributes, and is not identified as a header by transformations 3.5.1, |
| | 3.5.2, need to move the layout attributes to CSS and assign class |
| | name |
| Example use, | Remove style form text and replace with css class |
| WCAG | |
| description | |

TABLE A-76

| Field | Description |
|---|---|
| Dependency | 3.3.2 |
| Transformation | H-5 |
| Number | |
| Knowledge gap | Association of styles with semantic content |
| Logic | any tag with style attribute |
| Used for | Take out the style attribute from the tag and put it to css. |
| About | Presentational information should be separated from other content. |
| | Where they have been mixed up it is useful to separate them. When |
| | we do we create a knowledge base reference linking styled content |
| | in the page to style information in a class in a style sheet. We need |
| | to build the knowledge base relationship and, when we do not have |
| | it already add style information to a css that acts as a resource. In |
| | this case we know we need to do this because of the occurrence of |
| | any tag with style attribute We also need to see how the presentation |
| | affects structural emphasis and any other implications. |
| Best guess | Most of this can be reliably captured automatically without user |
| | input. However the user may wish to edit the generated knowledge |
| | and styles anyway. |
| Editor supplied | None |
| knowledge | |
| Example case | Case1: if style attribute is found in some tag, this tag wasn't caught |
| (HTML description) | as a header by transformations 3.5.1, 3.5.2, and wasn't caught by |
| | transformation 3.3.2, need to move te style to CSS |
| Example use, | move the style attribute into CSS |
| WCAG | |
| description | |

TABLE A-77

| Field | Description |
|---|---|
| Dependency | 3.3.3 |
| Transformation | H-5 |
| Number | |
| Knowledge gap | Association of styles with semantic content |
| Logic | font tag is used for presentation |
| Used for | replace font tag to span and transfer all presentation information |
| | from the font tag to css. |
| About | Presentational information should be separated from other content. |
| | Where they have been mixed up it is useful to separate them. When |
| | we do we create a knowledge base reference linking styled content |
| | in the page to style information in a class in a style sheet. We need |
| | to build the knowledge base relationship and, when we do not have |
| | it already add style information to a css that acts as a resource. In |
| | this case we know we need to do this because of the occurrence of a |
| | font tag is used for. We also need to see how the presentation affects |
| | structural emphasis and any other implications. presentation |
| Best guess | Most of can be reliably captured automatically without user input. |
| | However the user may wish to edit the generated knowledge and |
| | styles anyway |
| Editor supplied | None |
| knowledge | |
| Example case | Case1: if the deprecated font/basefont tag is used, need to replace it |
| (HTML description) | with CSS. This font tag is not a descendant of a container with short |
| | text, formatting all the text inside the container |
| | Case2: layout information may be held either in FONT or |
| | BASEFONT tags - the action is the same |
| Example use, | writeToCSSFile creates a new class with attribute of current node |
| WCAG | deletes all these attributes from the node and adds to the node |
| description | attribute class with the value of the new class name created Deleting |
| | of font attribute is done in SWAPML rendering SWAPCSS.xsl All |
| | attributes are sent to the java extension that will delete CSS |
| | deprecated characters, like #, ., +, −, etc. |

TABLE A-78

| Field | Description |
|---|---|
| Dependency | 3.3.4 |
| Transformation | H-5 |
| Number | |
| Knowledge gap | Relative emphasis and importance in a document |
| Logic | b tag is used to make the visual presentation effect rather than |
| | structural emphasis, thus, it should't be used in the text. |
| Used for | replace b tag with strong tag, which provides structural emphasis |
| | along with visual presentation |
| About | When Text is bolded, it usually means structural emphasis, we need |
| | to capture that as knowledge. Because bold is a depreciated tag we |
| | also need to map it to valid XHTML. |
| Best guess | map b tag with strong tag, which provides structural emphasis along |
| | with visual presentation |
| Editor supplied | None |
| knowledge | |
| Example case | Case1: b tag is found in the document - need to substitute it. This b |
| (HTML description) | tag is not used for formatting a header - transformation 3.5.2 |
| Example use, | need to replace b tag with strong tag |
| WCAG | |
| description | |

TABLE A-79

| Field | Description |
|---|---|
| Dependency | 3.3.5 |
| Transformation | H-5 |
| Number | |
| Knowledge gap | Relative emphasis and importance in a document |
| Logic | i tag is used to make the visual presentation effect rather than |
| | structural emphasis, thus, it should't be used in the text. |
| Used for | replace i tag with em tag, which provides structural emphasis along |
| | with visual presentation |
| About | When Text is formated, it usually means structural emphasis, we |
| | need to capture that as knowledge. Because bold is a depreciated tag |
| | we also need to map it to valid XHTML.. |
| Best guess | replace i tag with em tag, which provides structural emphasis along |
| | with visual presentation |
| Editor supplied | None |
| knowledge | |
| Example case | Case1: i tag is found in the document - need to replace it. This i tag |
| (HTML description) | is not used to format a header - transformation 3.5.2 |
| Example use, | need to replace i tag with em tag |
| WCAG | |
| description | |

TABLE A-80

| Field | Description |
|---|---|
| Dependency | 13.6.1 |
| Transformation | H-5 |
| Number | |
| Knowledge gap | Sections of content in a page |
| Logic | table, has at least 4 links, doesn't contain long text, doesn't have an |
| | embedded table, doesn't have a descendant tag that conforms to |
| | transformation 13.6.02 or 13.6.03 |
| Used for | identify blocks of links |
| About | Identifying what links belong together as a menu or block of links, is |
| | part of identifying what content is on a page and allowing the user to |
| | navigate through it |
| Best guess | identify blocks of links as belonging together |
| Editor supplied | Confirm, edit or change the best guess add new information where |
| knowledge | necessary |
| Example case | Case1: table, has at least 4 links, doesn't contain long text, doesn't |
| (HTML description) | have an embedded table, doesn't have a descendant tag that |
| | conforms to transformation 13.6.02 or 13.6.03 If block of links has a |
| | first preceding or first descendant significant text that is identified as |
| | a header, we don't need to catch it. |
| Example use, | add an anchor before the table |
| WCAG | |
| description | |

TABLE A-81

| Field | Description |
|---|---|
| Dependency | 13.6.2 |
| Transformation | H-5 |
| Number | |
| Knowledge gap | Sections of content on a page |
| Logic | container tag - td, p or div that contains at least 4 links all not in |
| | descendant container, doesn't contain long text and doesn't contain |
| | descendant table or tr that conform to tramsformations 13.6.01 and |
| | 13.6.03 |
| Used for | identify blocks of links |
| About | Identifying what links belong together as a menu or block of links, is |
| | part of identifying what content is on a page and allowing the user to |
| | navigate through it |
| Best guess | identify blocks of links as a section of text with a menu related role |
| Editor supplied | Confirm, edit or change the best guess add new information where |
| knowledge | necessary |
| Example case | Case1: container tag - td, p or div that contains at least 4 links all not |
| (HTML description) | in descendant container, doesn't contain long text and doesn't |
| | contain descendant table or tr that conform to transformations |
| | 13.6.01 and 13.6.03 If block of links has a first preceding or first |
| | descendant significant text that is identified as a header, we don't |
| | need to catch it. |
| Example use, | add a skip links as a first child of the container |
| WCAG | |
| description | |

TABLE A-82

| Field | Description |
|---|---|
| Dependency | 13.6.3 |
| Transformation | H-5 |
| Number | |
| Knowledge gap | Sections of content on a page |
| Logic | tr tag that contains at least 4 links all not in descendant container, |
| | doesn't contain long text and doesn't contain descendant table or |
| | container that conform to tramsformations 13.6.01 and 13.6.02 |
| Used for | identify blocks of links |
| About | Identifying what links belong together as a menu or block of links, is |
| | part of identifying what content is on a page and allowing the user to |
| | navigate through it |
| Best guess | identify blocks of links as a section of text with a menu related role |
| Editor supplied | Confirm, edit or change the best guess add new information where |
| knowledge | necessary |
| Example case | Case1: tr tag that contains at least 4 links all not in descendant |
| (HTML description) | container, doesn't contain long text and doesn't contain descendant |
| | table or container that conform to tramsformations 13.6.01 and |
| | 13.6.02 If block of links has a first preceding or first descendant |
| | significant text that is identified as a header, we don't need to catch |
| | it. |
| Example use, | add in as a first child of the first td in the tr |
| WCAG | |
| description | |

TABLE A-83

| Field | Description |
|---|---|
| Dependency | 13.6.4 |
| Transformation | H-5 |
| Number | |
| Knowledge gap | Sections of content on a page, Roles of sections of content |
| Logic | for a form, add a pagemap anchor before it |
| Used for | identify pagemap block |
| About | Content of a form, should all belong together as a block of content |
| | with a known role (the form role |
| Best guess | identify a form as a section of content with role as the role of the |
| | form (taken from keywords from the name of the form) |
| Editor supplied | Confirm, edit or change the best guess add new information where |
| knowledge | necessary |
| Example case | Case1: for any form, add a pagemap anchor before it |
| (HTML description) | |
| Example use, | add (pagemap)anchor with text of the first text used in the pagemap |
| WCAG | rendering |
| description | |

TABLE A-84

| Field | Description |
|---|---|
| Dependency | 13.6.5 |
| Transformation | H-5 |
| Number | |
| Knowledge gap | Sections of content on a page, Roles of sections of |
| | content |
| Logic | container tag (div or p) with class/id ‘footer’ is probably |
| | a pagemap block |
| Used for | identify pagemap block |
| About | Identify footers as section of text with known role |
| Best guess | identify a section of content with role footer |
| Editor supplied | Confirm, edit or change the best guess add new |
| knowledge | information where necessary |
| Example case | Case1: for footer container, identify it as a block, if |
| (HTML | it wasn't caught by other transformation on |
| description) | pagemap blocks. |
| | Case2: for footer container, identify it as a block |
| Example use, | add pagemap anchor for footer |
| WCAG | |
| description | |

TABLE A-85

| Field | Description |
|---|---|
| Dependency | 13.6.8 |
| Transformation | H-5 |
| Number | |
| Knowledge gap | What are the sections of a page |
| | What is the start of the main content |
| Logic | find the end of navigational links in order to provide a |
| | skip link over it |
| Used for | permit users to skip repetitive navigation links |
| About | find the end of navigational links in order to provide a |
| | skip link over it |
| Best guess | Before first long text after block of links is probably |
| | end of navigation links |
| Editor supplied | Confirm, edit or change the best guess add new |
| knowledge | information where necessary |
| Example case | Case1: find a last link in navigation - last link that has a |
| (HTML | big text or heading after it. Do this only if the page |
| description) | doesn't already have a skip link. |
| Example use, | put an anchor for skip links in the next container |
| WCAG | |
| description | |

TABLE A-86

| Field | Description |
|---|---|
| Dependency | 13.6.11 |
| Transformation | H-5 |
| Number | |
| Knowledge gap | What are the sections of a page |
| Logic | add a skip link over navigational links right after |
| | the body tag. It only needed if the page has more than |
| | two links. |
| Used for | provide a way to skip to the main content |
| About | Where should be a skip link over navigational links right |
| | after the body tag. |
| Best guess | Before first long text after block of links is probably |
| | end of navigation links |
| Editor supplied | Confirm, edit or change the best guess add new |
| knowledge | information where necessary |
| Example case | Case1: add a skip link inside a body tag |
| (HTML | |
| description) | |
| Example use, | add skip link |
| WCAG | |
| description | |

TABLE A-87

| Field | Description |
|---|---|
| Dependency | 3.6.1 |
| Transformation | H-5 |
| Number | |
| Knowledge gap | Associating content and style |
| | Structure of a document |
| Logic | if there is a ul or ol tag with no child tags, this means that the tag is |
| | used for formatting. Need to replace this with CSS. |
| Used for | list containers used for markup |
| About | Sometimes content may be marked as a list when it is not a list |
| | because the author like the format associated with a list. (if there is a |
| | list tag with no child tags, and individual list items this means that |
| | the tag is used for formatting.) Steps need is to capture what there |
| | real value/structure of the document, capture the reference for |
| | alternate style in a style sheet. And create the class if necessary |
| Best guess | Create association between content and CSS class that is similar to |
| | list |
| | This is normally automatic |
| | User can edit if they choose |
| Editor supplied | None |
| knowledge | |
| Example case | Case1: ul with no child tags |
| (HTML | Case2: ol with no child tags |
| description) | |
| Example use, | we need to replace list container with css indent class |
| WCAG | |
| description | |

TABLE A-88

| Field | Description |
|---|---|
| Dependency | 1.1.25 |
| Transformation | H-6 |
| Number | |
| Knowledge gap | Summary of the image |
| Logic | for any image with very long alt attribute (more than |
| | 25 words), and no longdesc, ask to provide a summary |
| | for the alt. image is not inside a link. |
| Used for | provide a longdecs attribute for images that need |
| | it - when alt is not enough to describe the image |
| About | for any image with very long equivalent (more than |
| | 25 words), (and no longdesc,) a summary of the image is |
| | also useful knowledge. If a longer description has also |
| | been provided summary. image is not inside a link. |
| Best guess | First sentence of the description |
| Editor supplied | Confirm, edit or change the best guess add new |
| knowledge | information where necessary |
| Example case | Case1: img with long alt and no longdesc, not inside |
| (HTML | a link |
| description) | |
| Example use, | need to ask for the summary - it will be the new alt, and |
| WCAG | alt will become a longdesc |
| description | |

TABLE A-89

| Field | Description |
|---|---|
| Dependency | 1.1.26 |
| Transformation | H-6 |
| Number | |
| Knowledge gap | Summary of the image |
| Logic | for any image with very long alt attribute (more than |
| | 25 words), and no longdesc, ask to provide a summary |
| | for the alt. image is inside a link. |
| Used for | provide a longdecs attribute for images that need |
| | it - when alt is not enough to describe the image |
| About | for any image with very long equivalent (more than |
| | 25 words), (and no longdesc,) a summary of the image is |
| | also useful knowledge. If a longer description has also |
| | been provided summary. image is inside a link. |
| Best guess | a summary should probably say were the image |
| | goes to. Knolage of the role and or title of the linked |
| | to page will probably do |
| Editor supplied | Confirm, edit or change the best guess add new |
| knowledge | information where necessary |
| Example case | Case1: img with long alt and no longdesc, inside a link |
| (HTML | |
| description) | |
| Example use, | summary can be the new alt, and alt will become |
| WCAG | a longdesc |
| description | |

TABLE A-90

| Field | Description |
|---|---|
| Dependency | 3.5.9 |
| Transformation | H-6 |
| Number | |
| Knowledge gap | Page structure |
| Logic | if there is an improper headers order in the document, need to |
| | correct it |
| Used for | correct improper header nesting |
| About | if there is an improper and illogical order of headers and heading |
| | levels in the document, then the headers are probably being used |
| | incorrectly. For example headers at level 2 may be marked as header |
| | at level 5 because the author preferred the format associated with a |
| | heading 5. The true structure of the document need to be created. |
| Best guess | Restructure based on the logical structure of the page. H1 (heading |
| | of level 1) should be followed by a h2 or h1. H2 can be followed by |
| | a h2 or h3. |
| | The same format is probably used to represent heading of the same |
| | level. |
| | This does not have to be but, the user should not be able to provide |
| | an illogical mapping |
| Editor supplied | Confirm, edit or change the best guess add new information where |
| knowledge | necessary |
| Example case | Case1: if next header after h1 is not h1, h2, need to reorder headers |
| (HTML | Case2: if next header after h2 is not h1, h2, h3, need to reorder |
| description) | headers |
| | Case3: if next header after h3 is not h1, h2, h3, h4, need to reorder |
| | headers |
| | Case4: if next header after h4 is not h1, h2, h3, h4, h5, need to |
| | reorder headers |
| | Case5: if any header except h1 is the first header in the document, |
| | need to reorder headers |
| Example use, | need to replace the current header tag with h1 |
| WCAG | |
| description | |

TABLE A-91

| Field | Description |
|---|---|
| Dependency | 13.6.9 |
| Transformation | H-6 |
| Number | |
| Knowledge gap | Were is the end of navigation links section |
| Logic | if we couldn't identify last navigational link, need |
| | to ask the user to identify it |
| Used for | permit users to skip repetitive navigation links |
| About | if we couldn't identify last navigational link, need |
| | to ask the editor to identify it |
| Best guess | |
| Editor supplied | Confirm, edit or change the best guess add new |
| knowledge | information where necessary |
| Example case | Case1: if there is no anchor to skip links, ask the |
| (HTML | user to identify last navigational link |
| description) | |
| Example use, | add skip link after the last navigational link |
| WCAG | |
| description | |

TABLE A-92

| Field | Description |
|---|---|
| Dependency | 15.1.3 |
| Transformation | H-7 |
| Number | |
| Knowledge gap | Role of classes |
| Logic | For each element with distinct class in distinct page |
| | role need to ask for its role |
| Used for | Div span etc |
| About | For each element that does not have a useful role |
| | from the markup, with distinct class in distinct page role |
| | need to ask for its role |
| Best guess | Role class name ? |
| Editor supplied | Confirm, edit or change the best guess add new |
| knowledge | information where necessary |
| Example case | Case1: for a tag with class attribute, ask for its role |
| (HTML | |
| description) | |
| Example use, | assign a role attribute for the tag |
| WCAG | |
| description | |

TABLE A-93

| Field | Description |
|---|---|
| Dependency | 13.6.6 |
| Transformation | H-7 |
| Number | |
| Knowledge gap | What is the main content in a document |
| Logic | For any header need to add a pagemap anchor before it. |
| Used for | identify pagemap sections |
| About | Headers are used to represent sections of text, but text |
| | is not necessarily all under the heading. |
| | For any header need to add a pagemap section |
| Best guess | Text between headers belong to the same section as |
| | the header before it |
| Editor supplied | Confirm, edit or change the best guess add new |
| knowledge | information where necessary |
| Example case | Case1: for any header tag that doesn't have an |
| (HTML | altTagName attribute, |
| description) | |
| Example use, | add a pagemap anchor before the header. The title |
| WCAG | of pagemap anchor is the text content of the header. But |
| description | since a header can just contain an image, not text, |
| | we also add value of descendant image alt attribute to the |
| | title of the pagemap anchor. |

TABLE A-94

| Field | Description |
|---|---|
| Dependency | 13.6.7 |
| Transformation | H-7 |
| Number | |
| Knowledge gap | What is the main content in a document |
| Logic | For any tag that will be a header need to add a pagemap anchor |
| | before it. |
| Used for | identify pagemap sections |
| About | Headers are used to represent sections of text, but text is not necessarily |
| | all under the heading. |
| | For any header need to add a pagemap section |
| Best guess | Text between headers belong to the same section as the header |
| | before it |
| Editor supplied | Confirm, edit or change the best guess add new information where |
| knowledge | necessary |
| Example case | Case1: for any tag that has an altTagName attribute for header, add a |
| (HTML | pagemap anchor as a child If the tag is an image, title will be the alt |
| description) | text. |
| Example use, | add a pagemap anchor as a child of the header. We add it inside and |
| WCAG | not before, because if the current tag is a table cell, we don't want to |
| description | mess the structure of the table. |

TABLE A-95

| Field | Description |
|---|---|
| Dependency | 13.6.10 |
| Transformation | H-7 |
| Number | |
| Knowledge gap | What is the main content in a document |
| Logic | first container in the document that contains long content, if it is not |
| | preceded by a heading, is probably a main content |
| Used for | Identify a start of document main content and put a pagemap anchor |
| | before. |
| About | identify a start of document main content allows users to navigate |
| | through a page |
| Best guess | first container in the document that contains long content, if it is not |
| | preceded by a heading, is probably a main content |
| Editor supplied | Confirm, edit or change the best guess add new information where |
| knowledge | necessary |
| Example case | Case1: first, try to identify the container with the skip navigation anchor |
| (HTML | as a main content. If its not the main container, will try to |
| description) | identify it in the wizard. |
| Example use, | add a pagemap anchor for a main content as a first node inside the |
| WCAG | container Note: the actual anchor will be added in the wizard |
| description | process. |

TABLE A-96

| Field | Description |
|---|---|
| Dependency | 15.1.4 |
| Transformation | H-7 |
| Number | |
| Knowledge gap | Role of sections |
| Logic | For each header (or tag identified as header) add |
| | a role, depending on the header level |
| Used for | daisy book |
| About | For each header (or tag identified as header) add a |
| | role, depending on the header level |
| Best guess | Follow the logical order of the book, and heading level |
| | assigned to guess if the role is a section or chapter |
| | Also use content to see if there are links, how long it is |
| | ect to guess table of content, index, acknowledgments etc |
| Editor supplied | Confirm, edit or change the best guess add new |
| knowledge | information where necessary |
| Example case | Case1: for header level 1 or 2, set role to be ‘chapter’ |
| (HTML | |
| description) | |
| Example use, | add chapter role attribute |
| WCAG | |
| description | |

TABLE A-97

| Field | Description |
|---|---|
| Dependency | 15.1.5 |
| Transformation | H-7 |
| Number | |
| Knowledge gap | Role of sections |
| Logic | For each header (or tag identified as header) add a |
| | role, depending on the header level |
| Used for | daisy book |
| About | For each header (or tag identified as header) add a |
| | role, depending on the header level |
| Best guess | Follow the logical order of the book, and heading level |
| | assigned to guess if the role is a section or chapter |
| | Also use content to see if there are links, how long it is |
| | ect to guess table of content, index, acknowledgments etc |
| Editor supplied | None |
| knowledge | |
| Example case | Case1: for header level 3, set role to be ‘section’ |
| (HTML | |
| description) | |
| Example use, | add section role attribute |
| WCAG | |
| description | |

TABLE A-98

| Field | Description |
|---|---|
| Dependency | 15.1.6 |
| Transformation | H-7 |
| Number | |
| Knowledge gap | Role of sections |
| Logic | For each header (or tag identified as header) add a |
| | role, depending on the header level |
| Used for | daisy book |
| About | For each header (or tag identified as header) add a |
| | role, depending on the header level |
| Best guess | Follow the logical order of the book, and heading level |
| | assigned to guess if the role is a section or chapter |
| | Also use content to see if there are links, how long it is |
| | ect to guess table of content, index, acknowledgments etc |
| Editor supplied | None |
| knowledge | |
| Example case | Case1: for header level 4, 5 or 6, set role to |
| (HTML | be ‘subsection’ |
| description) | |
| Example use, | add subsection role attribute |
| WCAG | |
| description | |

TABLE A-99

| Field | Description |
|---|---|
| Dependency | 15.1.7 |
| Transformation | H-7 |
| Number | |
| Knowledge gap | Role of content |
| Logic | for content that looks like a page number, ask if this is a |
| | type of page number |
| Used for | daisy book |
| About | for content that looks like a page number, ask if this is |
| | a type of page number |
| Best guess | The role of this text is a page number |
| Editor supplied | Confirm, edit or change the best guess add new |
| knowledge | information where necessary |
| Example case | Case1: for a tag that has only text content and doesn't |
| (HTML | have a role, and looks like a page number, check if it is a |
| description) | page number |
| Example use, | ask if this is a page number, and if this is, ask to |
| WCAG | provide a type |
| description | |

TABLE A-100

| Field | Description |
|---|---|
| Dependency | 15.1.9 |
| Transformation | H-7 |
| Number | |
| Knowledge gap | Role of content |
| Logic | for offsite links, add an offSiteLink role |
| Used for | daisy book |
| About | for offsite links, add an offSiteLink role |
| Best guess | This is a link to a page on a different site were the editor |
| | can not guarantee content |
| Editor supplied | Confirm, edit or change the best guess add new |
| knowledge | information where necessary |
| Example case | Case1: for every off-site link, need to add an |
| (HTML | appropriate role |
| description) | |
| Example use, | add an offsite link warning ? or role |
| WCAG | |
| description | |

TABLE A-101

| Field | Description |
|---|---|
| Dependency | 15.1.10 |
| Transformation | H-7 |
| Number | |
| Knowledge gap | Role of content |
| Logic | for onsite image link need to assign a role |
| Used for | daisy book |
| About | for onsite image link need to assign a role |
| Best guess | The role of the image is to link to the role of the page |
| | that it goes to |
| Editor supplied | Confirm, edit or change the best guess add new |
| knowledge | information where necessary |
| Example case | Case1: for a link that has a descendant image and is |
| (HTML | an on site link, ask what type is it |
| description) | |
| Example use, | add a role attribute |
| WCAG | |
| description | |

TABLE A-102

| Field | Description |
|---|---|
| Dependency | 15.1.11 |
| Transformation | H-7 |
| Number | |
| Knowledge gap | Role of content |
| Logic | for onsite link that is not an image link and is not a part |
| | of table of contents or index page, assign a role |
| Used for | daisy book |
| About | for onsite link that is not an image link and is not a part |
| | of table of contents or index page, assign a role |
| Best guess | If the image always links to the same page The role of |
| | the image is to link to the role of linked to page |
| | If the image often links to different pages try roles: back, |
| | next, up help.. |
| Editor supplied | Confirm, edit or change the best guess add new |
| knowledge | information where necessary |
| Example case | Case1: for a link that is not an image link, ask to |
| (HTML | identify its type |
| description) | |
| Example use, | ask for a type of this link |
| WCAG | |
| description | |

TABLE A-103

| Field | Description |
|---|---|
| Dependency | 3.3.10 |
| Transformation | I-8 |
| Number | |
| Knowledge gap | Associating content and style |
| Logic | body tag with presentational attributes |
| Used for | take out all the presentational attributes from the body tag and put them |
| | to css. |
| About | Presentational information should be separated from other content. |
| | Where they have been mixed up it is useful to separate them. When |
| | we do we create a knowledge base reference linking styled content |
| | in the page to style information in a class in a style sheet. We need |
| | to build the knowledge base relationship and, when we do not have |
| | it already add style information to a css that acts as a resource. In |
| | this case we know we need to do this because of the occurrence |
| | body tag with presentational attributes. We this does not structural |
| | emphasis but may have other implications. |
| Best guess | Create CSS class based presentational information (unless one exists |
| | already) |
| | Create association between content and CSS |
| | This is normally automatic |
| | User can edit if they choose |
| Editor supplied | None |
| knowledge | |
| Example case | Case1: if al least one of the following attributes exists in the body |
| (HTML | tag, we need to transfer them all to css |
| description) | Case2: if al least one of the following attributes exists in the body |
| | tag, we need to transfer them all to css |
| | Case3: if al least one of the following attributes exists in the body |
| | tag, we need to transfer them all to css |
| | Case4: if al least one of the following attributes exists in the body |
| | tag, we need to transfer them all to css |
| | Case5: if al least one of the following attributes exists in the body |
| | tag, we need to transfer them all to css |
| | Case6: if al least one of the following attributes exists in the body |
| | tag, we need to transfer them all to css |
| Example use, | writeToCSSFile creates a new class with attribute of current node |
| WCAG | deletes all these attributes from the node and adds to the node |
| description | attribute class with the value of the new class name created All |
| | presentational attributes are deleted in SWAPML rendering |
| | SWAPCSS.xsl. NOTE: there may be a problem because this |
| | transformation now will not have an rdf statement |

TABLE A-104

| Field | Description |
|---|---|
| Dependency | 12.4.1 |
| Transformation | M-1 |
| Number | |
| Knowledge gap | ID, Role and label of a form control |
| Logic | for text box/textarea in form without id and default text, need to |
| | provide an id, a label, and a default text |
| Used for | provide an id, a label and a default text for a form control |
| About | Sometimes how to use a text box or form control, makes sense |
| | visually but is not clear from the code that is sent to an assistive |
| | technology. The role, label and use of each form control needs to be |
| | known. |
| | for text box/textarea in form we need to have an ID for it, and a |
| | clearly marked up label and default text |
| Best guess | Unformatted text near the box may be the label. Associate label text |
| | as the nearest appropriately sized text |
| | Map role (typically label keywords give the role) |
| | provide an id, automatically |
| | default text can be based of the form label (like “add email text” |
| | were email is the label or role) |
| | Allow the user to add or associate extra help and notes |
| Editor supplied | Confirm, edit or change the best guess add new information where |
| knowledge | necessary |
| Example case | Case1: for text box without id and default text, need to add id, text |
| (HTML description) | and label |
| | Case2: for textarea without id and default text, need to add id, text |
| | and label |
| Example use, | add id, content and label. From two actions for label |
| WCAG | |
| description | |

TABLE A-105

| Field | Description |
|---|---|
| Dependency | 12.4.2 |
| Transformation | M-1 |
| Number | |
| Knowledge gap | ID, Role and label of a form control |
| Logic | for text box/textarea in form without id but with default text, need to |
| | provide an id and a label |
| Used for | provide an id and a label for a form control |
| About | Sometimes how to use a text box or form control, makes sense |
| | visually but is not clear from the code that is sent to an assistive |
| | technology. The role, label and use of each form control needs to be |
| | known. |
| | For text box/textarea in form without id but with default text, need |
| | to provide an id and a label |
| Best guess | Unformatted text near the box may be the label. Or the default text |
| | can be the label. |
| | Associate label text as the nearest appropriately sized text |
| | Map role (typically label keywords give the role) |
| | provide an id, automatically |
| | Allow the user to add or associate extra help and notes |
| Editor supplied | Confirm, edit or change the best guess add new information where |
| knowledge | necessary |
| Example case | Case1: for text box without id need to add id and label |
| (HTML description) | Case2: for textarea without id and default text, need to add id, text |
| | and label |
| Example use, | Add ID and label. From two actions for label |
| WCAG | |
| description | |

TABLE A-106

| Field | Description |
|---|---|
| Dependency | 12.4.3 |
| Transformation | M-1 |
| Number | |
| Knowledge gap | Role and label of a form control |
| Logic | for text box/textarea in form with id but without default text, and |
| | there is no matching label in the document, need to provide a default |
| | text and a label |
| Used for | provide a default text and a label for a form control |
| About | Sometimes how to use a text box or form control, makes sense |
| | visually but is not clear from the code that is sent to an assistive |
| | technology. The role, label and use of each form control needs to be |
| | known. |
| | For text box/textarea in form with id but without default text, and |
| | there is no matching label in the document, need to provide a default |
| | text and a label |
| Best guess | Unformatted text near the box may be the label. Associate label text |
| | as the nearest appropriately sized text |
| | Map role (typically label keywords give the role) |
| | default text can be based of the form label (like “add email text” |
| | were email is the label or role) |
| | Allow the user to add or associate extra help and notes |
| Editor supplied | Confirm, edit or change the best guess add new information where |
| knowledge | necessary |
| Example case | Case1: for text box with id and default text, but without matching |
| (HTML description) | label, need to add text and label |
| | Case2: for textarea with id but without default text and matching |
| | label, need to add text and label |
| Example use, | add label and default text. From two actions for label (makeSimilar |
| WCAG | and addBefore) only one will be left after process, depending on |
| description | user answer. |

TABLE A-107

| Field | Description |
|---|---|
| Dependency | 12.4.4 |
| Transformation | M-1 |
| Number | |
| Knowledge gap | Role and label of a form control |
| Logic | for text box/textarea in form with id and default text, and there is no |
| | matching label in the document, need to provide a default text and a |
| | label |
| Used for | provide a default text and a label for a form control |
| About | for text box/textarea in form with id and default text, and there is no |
| | matching label in the document, need to provide a default text and a |
| | label |
| Best guess | Unformatted text near the box may be the label or default text may |
| | be the lable. Associate label text as the nearest appropriately sized |
| | text |
| | Map role (typically label keywords give the role) |
| | Allow the user to add or associate extra help and notes |
| Editor supplied | Confirm, edit or change the best guess add new information where |
| knowledge | necessary |
| Example case | Case1: for text box with id but without default text and matching |
| (HTML description) | label, need to add text and label |
| | Case2: for textarea with id and default text but without matching |
| | label, need to add text and label |
| Example use, | add label. From two actions for label. |
| WCAG | |
| description | |

TABLE A-108

| Field | Description |
|---|---|
| Dependency | 12.4.5 |
| Transformation | M-1 |
| Number | |
| Knowledge gap | Role and label of a form control |
| Logic | for any form control other than text and hidden without id attribute, |
| | need to provide a default text and a label |
| Used for | provide an id and a label for a form control |
| About | for any form control other than text and hidden without id attribute, |
| | need to provide a default text and a label |
| Best guess | Unformatted text near the box may be the label. Associate label text |
| | as the nearest appropriately sized text |
| | Map role (typically label keywords give the role) |
| | provide an id, automatically |
| | Allow the user to add or associate extra help and notes |
| Editor supplied | Confirm, edit or change the best guess add new information where |
| knowledge | necessary |
| Example case | Case1: for non-text and not hidden form control without id and |
| (HTML description) | matching label, need to provide id and label |
| Example use, | add id and label. |
| WCAG | |
| description | |

TABLE A-109

| Field | Description |
|---|---|
| Dependency | 12.4.6 |
| Transformation | M-1 |
| Number | |
| Knowledge gap | Role and label of a form control |
| Logic | for any form control other than text and hidden with id attribute, but |
| | without matching label, need to provide a default text and a label |
| Used for | provide an id and a label for a form control |
| About | for any form control other than text and hidden with id attribute, but |
| | without matching label, need to provide a default text and a label |
| Best guess | Unformatted text near the box may be the label. Associate label text |
| | as the nearest appropriately sized text |
| | Map role (typically label keywords give the role) |
| | Allow the user to add or associate extra help and notes |
| Editor supplied | Confirm, edit or change the best guess add new information where |
| knowledge | necessary |
| Example case | Case1: for non-text and not hidden form control without id and |
| (HTML description) | matching label, need to provide id and label |
| Example use, | add label. |
| WCAG | |
| description | |

TABLE A-110

| Field | Description |
|---|---|
| Dependency | 10.1.3 |
| Transformation | M-2 |
| Number | |
| Knowledge gap | What page is the user on |
| Logic | if there is any tag with event-handler attribute that contains alert |
| | function, we need to add user notification that pop-up window |
| | appeared. |
| Used for | notify the user that pop-up window appeared |
| About | if there is any tag with event-handler attribute that contains alert |
| | function, we need to add user notification that pop-up window |
| | appeared. |
| Best guess | Provide notice the user that pop-up window appeared |
| Editor supplied | Confirm, edit or change the best guess add new information where |
| knowledge | necessary |
| Example case | Case1: since only event handler attribute can contain alert function, |
| (HTML description) | we just check if any attribute of any tag contains alert function |
| Example use, | need to add to alert function notification of pop-up window |
| WCAG | |
| description | |

TABLE A-111

| Field | Description |
|---|---|
| Dependency | 9.3.1 |
| Transformation | M-2 |
| Number | |
| Knowledge gap | Device independent events |
| | Action to event map |
| Logic | onMouseDown event needed to be complemented with on |
| | onKeyDown event for device-independence |
| Used for | adding device-independent event handlers |
| About | Event handles when activated, are used to change something - |
| | activate a script or change a state of an element. |
| | For device independence these need to activated without requiring |
| | use of a mouse |
| | To provide equivalency we need to map the event with a change of |
| | state or role. |
| | onMouseDown event needed to be complemented with on |
| | onKeyDown event for device-independence |
| Best guess | Map onMouseDown to onKeyDown |
| | Map event to action |
| Editor supplied | None |
| knowledge | |
| Example case | Case1: if there is a onMouseDown event in some tag, but there is no |
| (HTML description) | corresponding onKeyDown event |
| | Case2: if there is a onMouseDown event in some tag, but the |
| | corresponding onKeyDown event is empty |
| Example use, | need to add corresponding onKeyDown event in the same tag as the |
| WCAG | current onMouseDown event |
| description | |

TABLE A-112

| Field | Description |
|---|---|
| Dependency | 9.3.2 |
| Transformation | M-2 |
| Number | |
| Knowledge gap | Device independent events |
| | Action to event map |
| Logic | onMouseUp event needed to be complemented with on onKeyDown |
| | event for device-independence |
| Used for | adding device-independent event handlers |
| About | Event handles when activated, are used to change something - |
| | activate a script or change a state of an element. |
| | For device independence these need to activated without requiring |
| | use of a mouse |
| | To provide equivalency we need to map the event with a change of |
| | state or role. |
| | onMouseUp event needed to be complemented with on onKeyDown |
| | event for device-independence |
| Best guess | Map onMouseup to onKeyUp |
| | Map event to action |
| Editor supplied | None |
| knowledge | |
| Example case | Case1: if there is a onMouseUp event in some tag, but there is no |
| (HTML description) | corresponding onKeyUp event |
| | Case2: if there is a onMouseUp event in some tag, but the |
| | corresponding onKeyUp event is empty |
| Example use, | need to add corresponding onKeyUp event in the same tag as the |
| WCAG | current onMouseUp event |
| description | |

TABLE A-113

| Field | Description |
|---|---|
| Dependency | 9.3.3 |
| Transformation | M-2 |
| Number | |
| Knowledge gap | Device independent events |
| | Action to event map |
| Logic | onMouseOver event needed to be complemented with on onFocus |
| | event for device-independence |
| Used for | adding device-independent event handlers |
| About | Event handles when activated, are used to change something - |
| | activate a script or change a state of an element. |
| | For device independence these need to activated without requiring |
| | use of a mouse |
| | To provide equivalency we need to map the event with a change of |
| | state or role. |
| | onMouseOver event needed to be complemented with on onFocus |
| | event for device-independence |
| Best guess | Map onMouseover to onFocuse |
| | Map event to action |
| Editor supplied | None |
| knowledge | |
| Example case | Case1: if there is a onMouseOver event in some tag, but there is no |
| (HTML description) | corresponding onFocus event |
| | Case2: if there is a onMouseOver event in some tag, but the |
| | corresponding onFocus event is empty |
| Example use, | need to add corresponding onFocus event in the same tag as the |
| WCAG | current onMouseOver event |
| description | |

TABLE A-114

| Field | Description |
|---|---|
| Dependency | 9.3.4 |
| Transformation | M-2 |
| Number | |
| Knowledge gap | Device independent events |
| | Action to event map |
| Logic | onMouseOut event needed to be complemented with |
| | on onBlur event for device-independence |
| Used for | adding device-independent event handlers |
| About | Event handles when activated, are used to change |
| | something - activate a script or change a state of an |
| | element. |
| | For device independence these need to activated |
| | without requiring use of a mouse |
| | To provide equivalency we need to map the event with |
| | a change of state or role. |
| | onMouseOut event needed to be complemented |
| | with on onBlur event for device-independence |
| Best guess | Map onMouseOut to onBlur |
| | Map event to action |
| Editor supplied | None |
| knowledge | |
| Example case | Case1: if there is a onMouseOut event in some tag, but |
| (HTML | there is no corresponding onBlur event |
| description) | Case2: if there is a onMouseOut event in some tag, but |
| | the corresponding onBlur event is empty |
| Example use, | need to add corresponding onFocus event in the same |
| WCAG | tag as the current onMouseOut event |
| description | |

TABLE A-115

| Field | Description |
|---|---|
| Dependency | 9.3.5 |
| Transformation | M-2 |
| Number | |
| Knowledge gap | Device independent events |
| | Action to event map |
| Logic | onClick event needed to be complemented with on |
| | onKeyPress event for device-independence |
| Used for | adding device-independent event handlers |
| About | Event handles when activated, are used to change |
| | something - activate a script or change a state of an |
| | element. |
| | For device independence these need to activated |
| | without requiring use of a mouse |
| | To provide equivalency we need to map the event with |
| | a change of state or role. |
| | onClick event needed to be complemented with on |
| | onKeyPress event for device-independence |
| Best guess | Map onClick to onKeyPress |
| | Map event to action |
| Editor supplied | None |
| knowledge | |
| Example case | Case1: if there is a onClick event in some tag, but |
| (HTML | there is no corresponding onKeyPress event |
| description) | Case2: if there is a onClick event in some tag, but |
| | the corresponding onKeyPress event is empty |
| Example use, | need to add corresponding onKeyPress event in the same |
| WCAG | tag as the current onClick event |
| description | |

TABLE A-116

| Field | Description |
|---|---|
| Dependency | 9.4.1 |
| Transformation | M-2 |
| Number | |
| Knowledge gap | Logical Flow of page |
| Logic | any tag that needs tabindex without tabindex attribute |
| Used for | create a logical tab order |
| About | People using assistive technology need to be able to |
| | tab through content. |
| | We also need to know the logical order of a page so we |
| | can linearize and render it. |
| | any tag that needs tabindex without tabindex attribute |
| Best guess | create a logical tab order from sequential flow of |
| | content in code |
| Editor supplied | None |
| knowledge | |
| Example case | Case1: a tag with no tabindex attribute |
| (HTML | Case2: area tag with no tabindex attribute |
| description) | Case3: button tag with no tabindex attribute |
| | Case4: input tag with no tabindex attribute |
| | Case5: select tag with no tabindex attribute |
| | Case6: textarea tag with no tabindex attribute |
| Example use, | need to add tabindex with value 0 |
| WCAG | |
| description | |

TABLE A-117

| Field | Description |
|---|---|
| Dependency | 10.1.1 |
| Transformation | M-2 |
| Number | |
| Knowledge gap | What window is a user on or sent to |
| Logic | a or area tag with target attribute with _blank value |
| Used for | blank target in a tag should be avoided |
| About | a or area tag with target attribute with _blank value |
| Best guess | This goes to a new window |
| Editor supplied | None |
| knowledge | |
| Example case | Case1: target attribute that causes opening new window |
| (HTML | Case2: target attribute that causes opening new window |
| description) | Case3: target attribute that causes opening new window |
| | Case4: target attribute that causes opening new window |
| Example use, | need to change target attribute's value to remove, in |
| WCAG | order to enable it's removal in final SWAP rendering |
| description | |

TABLE A-118

| Field | Description |
|---|---|
| Dependency | 10.1.2 |
| Transformation | M-2 |
| Number | |
| Knowledge gap | What window is a user on or sent to |
| Logic | if there is alert function inside script tag, we need to |
| | add to the content of alert(text) notification that |
| | this is a pop-up window |
| Used for | notify the user that pop-up window appeared |
| About | if there is alert function inside script tag, we need to |
| | add to the content of alert(text) notification that |
| | this is a pop-up window |
| Best guess | pop-up window appeared |
| Editor supplied | None |
| knowledge | |
| Example case | Case1: if there is a script tag that contains alert function |
| (HTML | |
| description) | |
| Example use, | need to add “pop-up window” text before the content of |
| WCAG | the alert function |
| description | |

TABLE A-119

| Field | Description |
|---|---|
| Dependency | 10.1.6 |
| Transformation | M-2 |
| Number | |
| Knowledge gap | What window is a user on or sent to |
| Logic | if there is alert function inside script tag, and the |
| | script content is inside a comment, we need to add to the |
| | content of alert(text) notification that this is a pop-up |
| | window |
| Used for | notify the user that pop-up window appeared |
| About | if there is alert function inside script tag, and the |
| | script content is inside a comment, we need to add to the |
| | content of alert(text) notification that this is a pop-up |
| | window |
| Best guess | pop-up window appeared |
| Editor supplied | None |
| knowledge | |
| Example case | Case1: if there is a script tag with comment that contains |
| (HTML | all script content, and the comment content contains alert |
| description) | function |
| Example use, | need to add “pop-up window” text before the content |
| WCAG | of the alert function |
| description | |

TABLE A-120

| Field | Description |
|---|---|
| Dependency | 10.1.7 |
| Transformation | M-2 |
| Number | |
| Knowledge gap | What window is a user on or sent to |
| Logic | if there is any tag with event-handler attribute that |
| | contains alert function, we need to add user notification |
| | that pop-up window appeared. |
| Used for | notify the user that pop-up window appeared |
| About | if there is any tag with event-handler attribute that |
| | contains alert function, we need to add user notification |
| | that pop-up window appeared. |
| Best guess | pop-up window appeared |
| Editor supplied | None |
| knowledge | |
| Example case | Case1: since only event handler attribute can contain |
| (HTML | alert function, we just check if any attribute of any tag |
| description) | contains alert function |
| Example use, | need to put a notification about pop-up being dealt with |
| WCAG | in the info page of the wizard |
| description | |

TABLE A-121

| Field | Description |
|---|---|
| Dependency | 10.1.4 |
| Transformation | M-2 |
| Number | |
| Knowledge gap | What window is a user on or sent to |
| Logic | if window.open or open function is used in the script |
| | to cause opening new window, we need to change it to |
| | load the new page in the current window. |
| Used for | replace window.open or open function with location.href |
| | for not causing spawned windows |
| About | if window.open or open function is used in the script |
| | to cause opening new window, we need to change it to |
| | load the new page in the current window. |
| Best guess | Map window.open or open function with location.href |
| | for not causing spawned windows |
| Editor supplied | None |
| knowledge | |
| Example case | Case1: if there is a script tag in the text that contains |
| (HTML | window.open function |
| description) | |
| Example use, | need to replace the window.open or open function with |
| WCAG | location.href, which will cause specified url to open in |
| description | the current window, instead of opening a new |
| | browser window. |

TABLE A-122

| Field | Description |
|---|---|
| Dependency | 10.1.5 |
| Transformation | M-2 |
| Number | |
| Knowledge gap | Page interactivity |
| Logic | if there is an external script, we can't check it, we |
| | just give a message to the user that we can't check it. |
| Used for | if there are external scripts that cannot be checked, |
| | present a message about that to the user |
| About | if there is an external script, we can't check it, we |
| | just give a message to the user that we can't check it. |
| Best guess | if there are external scripts that cannot be checked, |
| | present a message about that to the user |
| Editor supplied | Confirm, edit or change the best guess add new |
| knowledge | information where necessary |
| Example case | Case1: if there is a script tag with src attribute, it means |
| (HTML | that the script is external and cannot be checked |
| description) | |
| Example use, | |
| WCAG | |
| description | |

TABLE A-123

| Field | Description |
|---|---|
| Dependency | 6.3.1 |
| Transformation | M-3 |
| Number | |
| Knowledge gap | Roles, mappings and equivalencies of the script |
| Logic | script tag inside the body with no further noscript tag for |
| | users not supporting scripts |
| Used for | The content of script is rendered when scripts are |
| | not enabled |
| About | Scripts are often not run well by assistive technology. |
| | They produce end content, and it can be hard for assistive |
| | technology to understand the role semantics or |
| | usage of the script |
| Best guess | Script parse, and activating scripts though a com object |
| | called by the screen build a best guess of mapping a |
| | script to an equivalent. |
| Editor supplied | Confirm, edit or change the best guess add new |
| knowledge | information where necessary |
| Example case | Case1: noscript tag is missing (right after the script tag), |
| (HTML | script tag is not inside the head tag |
| description) | |
| Example use, | Put equivalent into no script tag |
| WCAG | |
| description | |

TABLE A-124

| Field | Description |
|---|---|
| Dependency | 6.3.2 |
| Transformation | M-3 |
| Number | |
| Knowledge gap | Roles, mappings and equivalencies of the script |
| Logic | script tag in the head with no further noscript tag |
| | for users not supporting scripts |
| Used for | The content of script is rendered when |
| | scripts are not enabled |
| About | Scripts are often not run well by assistive technology. |
| | They produce end content, and it can be hard for |
| | assistive technology to understand the role |
| | semantics or usage of the script |
| Best guess | Script parse, and activating scripts though a com |
| | object called by the screen build a best guess of |
| | mapping a script to an equivalent. |
| Editor supplied | Confirm, edit or change the best guess add |
| knowledge | new information where necessary |
| Example case | Case1: noscript tag is missing (right after the script |
| (HTML | tag), script tag is inside the head tag |
| description) | |
| Example use, | Put equivalent into no script tag |
| WCAG | |
| description | |

TABLE A-125

| Field | Description |
|---|---|
| Dependency | 6.3.5 |
| Transformation | M-3 |
| Number | |
| Knowledge gap | What is the state of content |
| Logic | if there is a style attribute with content ‘display:none’, we need to |
| | add two new classes to the CSS - invisible and visible. This is done |
| | because if there is display: none style, it probably means that there is |
| | some script that changes it to visible when some event occurs. Since |
| | we are getting rid of style attributes, we need to replace them with |
| | class, but then we will need to change the content of script, that will |
| | now refer to class instead of style |
| Used for | add new classes to CSS for style = ‘display:none’ |
| About | Scripts may make styles visible an invisible using ‘display:none’, we |
| | need to map these situations to our classes to the CSS - invisible and visible. |
| Best guess | When style = ‘display:none’ is changed map to display = invisible . . . |
| Editor supplied | None |
| knowledge | |
| Example case | Case1: there is style attribute with content display: none |
| (HTML | |
| description) | |
| Example use, | add two classes to the CSS, add class attribute to the parent node of |
| WCAG | style and delete style. |
| description | |

TABLE A-126

| Field | Description |
|---|---|
| Dependency | 6.3.6 |
| Transformation | M-3 |
| Number | |
| Knowledge gap | What is the state of content |
| Logic | for script that contains reference to .style.display, we |
| | need to change it to .className and |
| | appropriate class name. |
| Used for | Change script reference to some attributes that will |
| | be removed in accessible rendering. |
| About | Style changes are part of a state of an element. Script |
| | can change the look feel and state of a element. We need |
| | to map the state and relate it to the script |
| Best guess | Change script reference to map to class state |
| Editor supplied | None |
| knowledge | |
| Example case | Case1: script contains reference to display property |
| (HTML | of some style attribute - .style.display |
| description) | |
| Example use, | replace .style.display = ‘none’/” with |
| WCAG | .className = ‘invisible’/‘visible’ |
| description | |

TABLE A-127

| Field | Description |
|---|---|
| Dependency | 6.3.7 |
| Transformation | M-3 |
| Number | |
| Knowledge gap | What is the state of content |
| Logic | for script that contains reference to .style.display, we |
| | need to change it to .className and |
| | appropriate class name. |
| Used for | Change script reference to some attributes that will |
| | be removed in accessible rendering. |
| About | Style changes are part of a state of an element. Script |
| | can change the look feel and state of a element. We need |
| | to map the state and relate it to the script |
| Best guess | Change script reference to map to class state |
| Editor supplied | Confirm, edit or change the best guess add |
| knowledge | new information where necessary |
| Example case | Case1: script has commented content that contains |
| (HTML | reference to display property of some style |
| description) | attribute - .style.display |
| Example use, | replace .style.display = ‘none’/” with .className = |
| WCAG | ‘invisible’/‘visible’ |
| description | |

TABLE A-128

| Field | Description |
|---|---|
| Dependency | 6.3.3 |
| Transformation | M-4 |
| Number | |
| Knowledge gap | What is the state of content |
| Logic | If there is a script that contains “.style”, it means that this script |
| | changes some style attribute of some node. SInce we are getting rid |
| | of all the style attributes and replacing them with class attributes, we |
| | need to replace each .style occurence in script with .className. And |
| | probably also change some other code in script due to that change. |
| Used for | Change script reference to some attributes that will be removed in |
| | accessible rendering. |
| About | Style changes are part of a state of an element. Script can change the |
| | look feel and state of a element. We need to map the state and relate |
| | it to the script |
| Best guess | Change script reference to map to class state |
| Editor supplied | Confirm, edit or change the best guess add new information where necessary |
| knowledge | |
| Example case | Case1: if script contains ‘.style’, it must be changed, because we |
| (HTML | replace style attributes with class. |
| description) | |
| Example use, | need to replace each occurence of .style in the script with .className |
| WCAG | |
| description | |

TABLE A-129

| Field | Description |
|---|---|
| Dependency | 6.3.4 |
| Transformation | M-4 |
| Number | |
| Knowledge gap | What is the state of content |
| Logic | If there is a script that contains “.style”, it means that this script |
| | changes some style attribute of some node. SInce we are getting rid |
| | of all the style attributes and replacing them with class attributes, we |
| | need to replace each .style occurence in script with .className. And |
| | probably also change some other code in script due to that change. |
| Used for | Change script reference to some attributes that will be removed in |
| | accessible rendering. |
| About | Style changes are part of a state of an element. Script can change the |
| | look feel and state of a element. We need to map the state and relate it |
| | to the script |
| Best guess | Change script reference to map to class state |
| Editor supplied | Confirm, edit or change the best guess add new information where |
| knowledge | necessary |
| Example case | Case1: if script's code is inside a comment, and it contains ‘.style’, it |
| (HTML | must be changed, because we replace style attributes with class. |
| description) | |
| Example use, | need to replace each occurence of .style in the script with |
| WCAG | .className |
| description | |

TABLE A-130

| Field | Description |
|---|---|
| Dependency | 6.3.9 |
| Transformation | M-4 |
| Number | |
| Knowledge gap | Possible Function, role and equivalency |
| Logic | form tag without submit button alerts us to the use of a script for |
| | submission of the form |
| Used for | The content of script is rendered when scripts are not enabled |
| About | form tag without submit button alerts us to the use of a script for |
| | submission of the form |
| | We need to capture the role of the script and map it to equivalences |
| Best guess | Parser called by screen and activating scripts though a com object |
| | and pre known mappings should help build knowledge to include |
| | functional |
| | equivalent in html or xform |
| Editor supplied | Confirm, edit or change the best guess add new information where |
| knowledge | necessary |
| Example case | Case1: there is no submit button but there exists some element in the |
| (HTML | form that has an event handler (a form can be submitted by javascript |
| description) | using onclick, for example) |
| Example use, | add submit button in a noscript after the last element in the form and add |
| WCAG | action attribute to the form |
| description | |

TABLE A-132

| Field | Description |
|---|---|
| Dependency | 6.3.10 |
| Transformation | M-4 |
| Number | |
| Knowledge gap | Possible Function, role and equivalency |
| Logic | form tag with submit button but without action attribute |
| | alerts us to the use of a script for |
| | submission of the form |
| Used for | The content of script is rendered when scripts |
| | are not enabled |
| About | form tag with submit button but without action attribute |
| | alerts us to the use of a script for |
| | submission of the form |
| Best guess | Script Parser called and pre known mappings |
| | should help build knowledge to include functional |
| | equivalent in html or xform |
| Editor supplied | Confirm, edit or change the best guess add |
| knowledge | new information where necessary |
| Example case | Case1: action attribute is missing from the form |
| (HTML | and there is a submit input |
| description) | Case2: action attribute is missing from the form |
| | and there is an image input |
| | Case3: action attribute is missing from the form and |
| | there is a submit button |
| | Case4: action attribute is missing from the form and |
| | there is a submit input |
| | Case5: action attribute is missing from the form and |
| | there is an image input |
| | Case6: action attribute is missing from the form and |
| | there is a submit button |
| Example use, | add action attribute to the form |
| WCAG | |
| description | |

TABLE A-132

| Field | Description |
|---|---|
| Dependency | 6.3.11 |
| Transformation | M-4 |
| Number | |
| Knowledge gap | Id and integrity of page elements |
| Logic | a submit button in a form without an action should |
| | be assigned a name if it does not already have one, |
| | so that it can be referenced by the |
| | server side script |
| Used for | The content of script is rendered when scripts |
| | are not enabled |
| About | a submit button in a form without an action should be |
| | assigned a name if it does not already have one, so |
| | that it can be referenced by the server side script |
| Best guess | Name for each form control |
| | role |
| Editor supplied | Confirm, edit or change the best guess add |
| knowledge | new information where necessary |
| Example case | Case1: a submit input without a name attribute whose |
| (HTML | parent form has an empty action attribute |
| description) | Case2: an image input without a name attribute whose |
| | parent form has an empty action attribute |
| | Case3: a submit button without a name attribute whose |
| | parent form has an empty action attribute |
| Example use, | add name attribute to the button |
| WCAG | |
| description | |

TABLE A-133

| Field | Description |
|---|---|
| Dependency | 6.3.12 |
| Transformation | M-4 |
| Number | |
| Knowledge gap | |
| Logic | a submit button in a form without an action should be assigned a |
| | value if it does not already have one, so that it can be referenced by |
| | the server side script |
| Used for | The content of script is rendered when scripts are not enabled |
| About | a submit button in a form without an action should be assigned a |
| | value if it does not already have one, so that it can be referenced by the |
| | server side script |
| Best guess | Map to a equivalent created by accessibility engine from mapping |
| | the elements and roles |
| | Example of mapping interaction |
| | 1 This textbox acts as a data field for an email address (role) |
| | 2. This script/function acts as a validation (role) |
| | 3. This script acts on this data field (relationship) |
| | 4 On key down should be an alternate for activation (of this script |
| | or in general) in place of a mouse over event (accessible alternative) |
| | This information could be captured at authoring time, or known by a |
| | general KB or a combination of capture mechanisms. |
| | Further information may also be available to the wizard such as the |
| | role of known accessible content and their location as well as the |
| | sub roles of section of that content. |
| | In our example that may be: |
| | This accessible script (another resource) is an accessible validation |
| | for email program (role) |
| | The engine can then use the accessible script in place of script 1, to |
| | act on the textbox when a key is pressed down. |
| Editor supplied | Confirm, edit or change the best guess add new information where |
| knowledge | necessary |
| Example case | Case1: a submit input without a value attribute whose parent form |
| (HTML | has an empty action attribute |
| description) | Case2: an image input without a value attribute whose parent form |
| | has an empty action attribute |
| | Case3: a submit button without a value attribute whose parent form |
| | has an empty action attribute |
| Example use, | add name attribute to the button |
| WCAG | |
| description | |

TABLE A-134

| Field | Description |
|---|---|
| Dependency | 6.3.13 |
| Transformation | M-4 |
| Number | |
| Knowledge gap | Does content disapear |
| Logic | css classes may make elements invisible, add |
| | default style as visible for all classes if javascript |
| | is not available |
| Used for | All content is rendered when scripts are not enabled |
| About | css classes may make elements invisible, add |
| | default style as visible for all classes if javascript |
| | is not available |
| Best guess | Make noscript equivalent - that all classers are visible |
| Editor supplied | None |
| knowledge | |
| Example case | Case1: a tag has a class attribute |
| (HTML | |
| description) | |
| Example use, | add a noscript/style as the first child of the body, |
| WCAG | which will default this class to be visible if scripts |
| description | are not available |

TABLE A-135

| Field | Description |
|---|---|
| Dependency | 6.3.14 |
| Transformation | M-4 |
| Number | |
| Knowledge gap | Page interactions |
| Logic | event handlers alert us to the use of javascript |
| Used for | important functionality should be performed even |
| | when scripts are not enabled |
| About | event handlers alert us to the use of javascript |
| Best guess | This event activates that script..of that role |
| | (Script parse, and activating scripts though a com |
| | object called by the screen build a best guess of |
| | mapping a script to an equivalent. |
| | Roles, mappings and equivalencies of the script) |
| Editor supplied | Confirm, edit or change the best guess |
| knowledge | add new information where necessary |
| Example case | Case1: an attribute whose name starts |
| (HTML | with ‘on’ (an event handler) which probably |
| | calls a function (it has an open parenthesis) |
| description) | |
| Example use, | add noscript tag with equivalent marked with script role |
| WCAG | |
| description | |

TABLE A-136

| Field | Description |
|---|---|
| Dependency | 6.3.15 |
| Transformation | M-4 |
| Number | |
| Knowledge gap | Page interactions |
| Logic | event handlers alert us to the use of javascript |
| Used for | important functionality should be performed even when |
| | scripts are not enabled |
| About | event handlers alert us to the use of javascript |
| Best guess | This event activates that script..of that role |
| | (Script parse, and activating scripts though a com |
| | object called by the screen build a best guess of mapping |
| | a script to an equivalent. Roles, mappings and |
| | equivalencies of the script) |
| Editor supplied | Confirm, edit or change the best guess add new |
| knowledge | information where necessary |
| Example case | Case1: an attribute whose name starts with |
| (HTML | ‘on’ (an event handler) which does not call a function |
| | (it does not have an open parenthesis) |
| description) | |
| Example use, | add noscript tag |
| WCAG | |
| description | |

TABLE A-137

| Field | Description |
|---|---|
| Dependency | 6.3.16 |
| Transformation | M-4 |
| Number | |
| Knowledge gap | Page interactivity - where does this script take me to |
| Logic | an a whose href contains javascript must have a |
| | noscript equivalent |
| Used for | important functionality should be performed |
| | even when scripts are not enabled |
| About | an a whose href contains javascript must have a |
| | noscript equivalent |
| Best guess | Script parse, and activating scripts though a com object |
| | to work out what happens when a script is activated |
| Editor supplied | Confirm, edit or change the best guess |
| knowledge | add new information where necessary |
| Example case | Case1: an a tag whose href contains javascript: |
| (HTML | and that does not have a following noscript tag |
| description) | Case2: an a tag whose href contains javascript: |
| | and that does not have a following noscript tag |
| Example use, | add noscript tag |
| WCAG | |
| description | |

TABLE A-138

| Field | Description |
|---|---|
| Dependency | 6.3.19 |
| Transformation | M-4 |
| Number | |
| Knowledge gap | Page interactivity - where does this script take me to |
| Logic | event handlers alert us to the use of javascript |
| Used for | important functionality should be performed even when |
| | scripts are not enabled |
| About | event handlers alert us to the use of javascript |
| Best guess | Script parse, and activating scripts though a com object |
| | to work out what happens when a script is activated |
| Editor supplied | Confirm, edit or change the best guess add new |
| knowledge | information where necessary |
| Example case | Case1: an attribute whose name is onsubmit which |
| (HTML | probably calls a function (it has an open parenthesis) |
| description) | |
| Example use, | add noscript tag |
| WCAG | |
| description | |

TABLE A-139

| Field | Description |
|---|---|
| Dependency | 6.3.20 |
| Transformation | M-4 |
| Number | |
| Knowledge gap | Page interactivity - where does this script take me to |
| Logic | event handlers alert us to the use of javascript |
| Used for | important functionality should be performed even when |
| | scripts are not enabled |
| About | event handlers alert us to the use of javascript |
| Best guess | Script parse, and activating scripts though a com object |
| | to work out what happens when a script is activated |
| Editor supplied | Confirm, edit or change the best guess add new |
| knowledge | information where necessary |
| Example case | Case1: an attribute whose name is onsubmit which |
| (HTML | probably calls a function (it has an open parenthesis) |
| description) | |
| Example use, | add noscript tag |
| WCAG | |
| description | |

TABLE A-140

| Field | Description |
|---|---|
| Dependency | 6.3.17 |
| Transformation | M-4 |
| Number | |
| Knowledge gap | Page interactivity - role, functionality and equivalence of |
| | a script |
| Logic | script which contains code other than functions and |
| | variables must have a noscript equivalent |
| Used for | important functionality should be performed even when |
| | scripts are not enabled |
| About | script which contains code other than functions and |
| | variables must have a noscript equivalent |
| Best guess | Script parse, and activating scripts though a com object |
| | to guess what happens when a script is activated |
| Editor supplied | Confirm, edit or change the best guess add new |
| knowledge | information where necessary |
| Example case | Case1: a script that has non variable and non function |
| (HTML | content and does not have a following noscript tag |
| description) | |
| Example use, | add noscript tag |
| WCAG | |
| description | |

TABLE A-141

| Field | Description |
|---|---|
| Dependency | 6.3.18 |
| Transformation | M-4 |
| Number | |
| Knowledge gap | Page interactivity - role, functionality and equivalence of |
| | a script |
| Logic | script which contains code other than functions and |
| | variables must have a noscript equivalent |
| Used for | important functionality should be performed even when |
| | scripts are not enabled |
| About | script which contains code other than functions and |
| | variables must have a noscript equivalent |
| Best guess | Script parse, and activating scripts though a com object |
| | to guess what happens when a script is activated |
| Editor supplied | Confirm, edit or change the best guess add new |
| knowledge | information where necessary |
| Example case | Case1: a script that has non variable and non function |
| (HTML | content and does not have a following noscript tag |
| description) | |
| Example use, | add noscript tag |
| WCAG | |
| description | |

TABLE A-142

| Field | Description |
|---|---|
| Dependency | 9.5.1 |
| Transformation | M-4 |
| Number | |
| Knowledge gap | Author preferred keyboard access |
| | Relative importance of controls |
| Logic | button tag without accesskey attribute |
| Used for | provide keyboard access to important buttons |
| About | button tag without accesskey attribute |
| Best guess | If the role is known then suggest using role defaults |
| | (like a search this site button) access keys and not |
| | overriding. Recommend assigning the next available page |
| | accesskey for keyboard access to important buttons |
| | without roles Important tags will get higher priority to |
| | receive an keys allocated first |
| | Allow editor to override, automatic allocation by |
| | assigning specific access keys |
| Editor supplied | None |
| knowledge | |
| Example case | Case1: button tag with no accesskey attribute |
| (HTML | |
| description) | |
| Example use, | need to add accesskey with next value available |
| WCAG | |
| description | |

TABLE A-143

| Field | Description |
|---|---|
| Dependency | 9.5.2 |
| Transformation | M-4 |
| Number | |
| Knowledge gap | Author preferred keyboard access |
| | Relative importance of controls |
| Logic | input tag without accesskey attribute |
| Used for | provide keyboard access to important form elements |
| About | input tag without accesskey attribute |
| Best guess | If the role is known then suggest using role defaults |
| | (like a search this site input field) access keys and not |
| | overriding. |
| | Important tags will get higher priority to |
| | receive an keys allocated first Recommend assigning |
| | the next available page accesskey for keyboard access |
| | to important input tags without roles |
| | Allow editor to override, automatic allocation by |
| | assigning specific access keys |
| Editor supplied | None |
| knowledge | |
| Example case | Case1: input tag with no accesskey attribute |
| (HTML | |
| description) | |
| Example use, | need to add accesskey with next value available |
| WCAG | |
| description | |

TABLE A-144

| Field | Description |
|---|---|
| Dependency | 9.5.3 |
| Transformation | M-4 |
| Number | |
| Knowledge gap | Author preferred keyboard access |
| | Relative importance of controls |
| Logic | textarea tag without accesskey attribute |
| Used for | provide keyboard access to important form elements |
| About | textarea tag without accesskey attribute |
| Best guess | If the role is known then suggest using role defaults |
| | (like a search this site button) access keys and not |
| | overriding. Recommend assigning the next available |
| | page accesskey for keyboard access to important |
| | controls without roles |
| | Important tags will get higher priority to receive |
| | an keys allocated first |
| | Author can override by providing designated keys |
| Editor supplied | None |
| knowledge | |
| Example case | Case1: textarea tag with no accesskey attribute |
| (HTML | |
| description) | |
| Example use, | need to add accesskey with next value available |
| WCAG | |
| description | |

TABLE A-145

| Field | Description |
|---|---|
| Dependency | 9.5.4 |
| Transformation | M-4 |
| Number | |
| Knowledge gap | Author preferred keyboard access |
| | Relative importance of controls |
| Logic | label tag without accesskey attribute |
| Used for | provide keyboard access to important form elements |
| About | label tag without accesskey attribute |
| Best guess | If the role is known then suggest using role defaults |
| | (like a search this site button) access keys and not |
| | overriding. Recommend assigning the next available |
| | page accesskey for keyboard access to important |
| | controls without roles by marking their relative |
| | importance |
| | Important tags will get higher priority to receive an |
| | keys allocated first. |
| | Allow editor to override, automatic allocation by |
| | assigning specific access keys |
| Editor supplied | None |
| knowledge | |
| Example case | Case1: label tag with no accesskey attribute |
| (HTML | |
| description) | |
| Example use, | need to add accesskey with next value available |
| WCAG | |
| description | |

TABLE A-146

| Field | Description |
|---|---|
| Dependency | 9.5.5 |
| Transformation | M-4 |
| Number | |
| Knowledge gap | Author preferred keyboard access |
| | Relative importance of controls |
| Logic | legend tag without accesskey attribute |
| Used for | provide keyboard access to important form elements |
| About | legend tag without accesskey attribute |
| Best guess | If the role is known then suggest using role defaults |
| | access keys and not overriding. Recommend assigning |
| | the next available page accesskey for |
| | keyboard access to important controls without roles by |
| | marking their relative importance |
| | Important tags will get higher priority to receive an |
| | keys allocated first. |
| | Allow editor to override, automatic allocation by |
| | assigning specific access keys |
| Editor supplied | None |
| knowledge | |
| Example case | Case1: legend tag with no accesskey attribute |
| (HTML | |
| description) | |
| Example use, | need to add accesskey with next value available |
| WCAG | |
| description | |

TABLE A-147

| Field | Description |
|---|---|
| Dependency | 3.7.3 |
| Transformation | T-1 |
| Number | |
| Knowledge gap | Structure and role of content |
| Logic | if there are quotations in the text, they should be |
| | marked up with a q tag. |
| Used for | mark up quotations |
| About | If there are quotations in the text, they should be |
| | identified if this is a quotation. |
| Best guess | Anything between “” or ‘’ etc is probably a quote |
| Editor supplied | Confirm, edit or change the best guess add new |
| knowledge | information where necessary |
| Example case | Case1: for each tag with text content, check if |
| (HTML | this content contains quotes that are not marked up |
| description) | The only tag that is allowed to have unmarked |
| | quotes is the script tag. |
| Example use, | enclose each quotation in q tag |
| WCAG | |
| description | |

TABLE A-148

| Field | Description |
|---|---|
| Dependency | 4.2.1 |
| Transformation | T-1 |
| Number | |
| Knowledge gap | Meaning of text |
| Logic | if there is an acronym in the text, need to mark it up |
| | using acronym tag |
| Used for | mark up acronyms |
| About | if there is an acronym in the text, need to be |
| | identified and a knowledge base of the full meaning |
| | of the acronym need to be provided |
| Best guess | Lookup table with lexicon or lexicon rules |
| | (Or third party) to suggest acronym |
| Editor supplied | Confirm, edit or change the best guess add new |
| knowledge | information where necessary |
| Example case | Case1: for the whole text content of the document |
| (HTML | (i.e. of the html tag), check if this content |
| description) | contains acronym |
| Example use, | enclose each acronym in the acronym tag |
| WCAG | |
| description | |

TABLE A-149

| Field | Description |
|---|---|
| Dependency | 12.3.1 |
| Transformation | T-2 |
| Number | |
| Knowledge gap | Structure of content |
| Logic | If there is a select element in the form with too |
| | many option child elements, option elements should |
| | be grouped into a hierarchy using the optgroup element. |
| Used for | group large blocks of information where appropriate |
| About | Sometimes we need to improve and increase the |
| | hierarchy of the content so that we can present content |
| | in an easer to understand form. |
| | If there is a select element in the form with too many |
| | option child elements, option elements should be |
| | grouped into a hierarchy using the optgroup element. |
| Best guess | Where there is a change in format or irregular |
| | content (such as a new image) Suggest a brake in content |
| Editor supplied | Confirm, edit or change the best guess add new |
| knowledge | information where necessary |
| Example case | Case1: if there is a select tag with more than 5 child |
| (HTML | option tags, using optgroup element for grouping them |
| description) | into a hierarchy should be considered. |
| Example use, | Put Optgroup around sections of options |
| WCAG | |
| description | |

TABLE A-150

| Field | Description |
|---|---|
| Dependency | 12.3.2 |
| Transformation | T-2 |
| Number | |
| Knowledge gap | Structure of content |
| Logic | If there is are more than 5 form elements in the |
| | form, fieldset may be used to group controls |
| | into logical units. |
| Used for | group large blocks of information where appropriate |
| About | improve and increase the hierarchy of the content |
| | If there is are more than 5 form elements in the form, |
| | fieldset may be used to group controls into logical units. |
| Best guess | Where there is a change in format or irregular content |
| | (such as a new image) Suggest a brake in content |
| Editor supplied | Confirm, edit or change the best guess add new |
| knowledge | information where necessary |
| Example case | Case1: if there is a form tag with more than 5 child |
| (HTML | control tags (input, select or textarea), using fieldset |
| description) | element for grouping them into a hierarchy |
| | should be considered. |
| Example use, | Put fieldset around sections of form controls |
| WCAG | |
| description | |

TABLE A-151

| Field | Description |
|---|---|
| Dependency | 12.3.3 |
| Transformation | T-2 |
| Number | |
| Knowledge gap | Structure of content |
| Logic | If there is are more than 5 list items in a list (ul or dl), |
| | nested list may be used for better understanding |
| Used for | group large blocks of information where appropriate |
| About | to improve and increase the hierarchy of the content |
| | If there is are more than 5 list items in a list (ul or dl), |
| | nested list may be used for better understanding |
| Best guess | Where there is a change in format or irregular content |
| | (such as a bullet Or the term and, or “or”) Suggest |
| | a brake in content |
| Editor supplied | Confirm, edit or change the best guess add new |
| knowledge | information where necessary |
| Example case | Case1: if there is a list with more than 5 list items, |
| (HTML | using nested list for grouping may ease |
| description) | the understanding |
| Example use, | Put ul tag around list sections |
| WCAG | |
| description | |

TABLE A-152

| Field | Description |
|---|---|
| Dependency | 12.3.4 |
| Transformation | T-2 |
| Number | |
| Knowledge gap | Structure of content |
| Logic | If there is are more than 5 list items in a definition list, |
| | nested list may be used for better understanding |
| Used for | group large blocks of information where appropriate |
| About | to improve and increase the hierarchy of the content |
| | If there is are more than 5 list items in a definition list, |
| | nested list may be used for better understanding |
| Best guess | Where there is a change in format or irregular content |
| | (such as a bullet Or the term and, or “or”) Suggest |
| | a brake in content |
| Editor supplied | Confirm, edit or change the best guess add new |
| knowledge | information where necessary |
| Example case | Case1: if there is a definition list with more than 5 |
| (HTML | list items, using nested list for grouping may ease |
| description) | the understanding |
| Example use, | Put dl tag around list sections |
| WCAG | |
| description | |

TABLE A-153

| Field | Description |
|---|---|
| Dependency | 14.1.1 |
| Transformation | T-2 |
| Number | |
| Knowledge gap | Clear header text |
| Logic | The text content of each header on the page should |
| | be unique to enable better user comprehension |
| Used for | Use informative headings so that users can scan a |
| | page quickly for information rather than reading it |
| | in detail |
| About | Use informative headings so that users can scan a |
| | page quickly for information rather than reading it in |
| | detail The text content of each header on the page should |
| | be unique to enable better user comprehension |
| Best guess | Original header text with any emphasized word in |
| | subsection in brackets after it |
| Editor supplied | Confirm, edit or change the best guess add new |
| knowledge | information where necessary |
| Example case | Case1: If there is a heading with the same text content |
| (HTML | as some other heading before it, the content of this |
| description) | heading should be changed to be unique |
| | Case2: If there is a heading with the same text content |
| | as some other heading after it, the content of this |
| | heading should be change to be unique |
| Example use, | Replace header text with clear unique text. |
| WCAG | |
| description | |

TABLE A-154

| Field | Description |
|---|---|
| Dependency | 13.1.1 |
| Transformation | T-3 |
| Number | |
| Knowledge gap | Role of the link |
| Logic | Every link text should clearly identify the link target |
| Used for | Clearly identify the target of each link |
| About | Every link text should clearly identify the link target |
| Best guess | Pull the role of each linked to page and add it to |
| | the original, unclear linked text |
| | For example: |
| | “click hear (for site map)” |
| Editor supplied | Confirm, edit or change the best guess add new |
| knowledge | information where necessary |
| Example case | Case1: for a link with a link text, need to verify |
| (HTML | that it's clear and unique |
| description) | |
| Example use, | replace link text |
| WCAG | |
| description | |

TABLE A-155

| Field | Description |
|---|---|
| Dependency | 13.1.2 |
| Transformation | T-3 |
| Number | |
| Knowledge gap | Role of the link |
| Logic | a tag with non-meaningful link text |
| Used for | provide a meaningful link text |
| About | Every link text should clearly identify the link target |
| | A tag with non-meaningful link text needs to be changed |
| Best guess | Pull the role of each linked to page and add it |
| | to the original, unclear linked text |
| | For example: |
| | “click hear (for site map)” |
| Editor supplied | Confirm, edit or change the best guess add |
| knowledge | new information where necessary |
| Example case | Case1: a tag with non-meaningful link text |
| (HTML | Case2: a tag with non-meaningful link text |
| description) | Case3: a tag with non-meaningful link text |
| | Case4: a tag with non-meaningful link text |
| | Case5: a tag with non-meaningful link text |
| | Case6: a tag with non-meaningful link text |
| | Case7: a tag with non-meaningful link text |
| | Case8: a tag with non-meaningful link text |
| Example use, | Replace linked text |
| WCAG | |
| description | |

TABLE A-156

| Field | Description |
|---|---|
| Dependency | 13.1.3 |
| Transformation | T-3 |
| Number | |
| Knowledge gap | Role of the link |
| Logic | If more than one link on a page shares the same link text, |
| | all those links should point to the same resource |
| Used for | edit links with same link text but different href attributes |
| About | If more than one link on a page shares the same link text, |
| | all those links should point to the same resource |
| Best guess | Pull the role/title of each linked to page and add it to |
| | the original, linked text that has been used two times |
| | For example: |
| | “example (HTML example)” |
| Editor supplied | Confirm, edit or change the best guess add new |
| knowledge | information where necessary |
| Example case | Case1: a tag that has a preceding a tag with the same link |
| (HTML | text, but different href attribute |
| description) | |
| Example use, | Replace linked text |
| WCAG | |
| description | |

TABLE A-157

| Field | Description |
|---|---|
| Dependency | 14.1.2 |
| Transformation | T-4 |
| Number | |
| Knowledge gap | Simple language equivalents, easily understood content, |
| | disambiguation of content Mark Jargon to lexicon Clarify |
| | ambiguous words Map words and terms to extra information |
| Logic | If the container contains a sentence with more than one conjunction |
| | word like and, or, if, it should be divided into more simple sentences |
| Used for | Avoid complex text |
| About | Simple text and disambiguated text makes text clearer for users to |
| | understand for example: |
| | If the container contains a sentence with more than one conjunction |
| | word like and, or, if, it should be divided into more simple sentences |
| | Also call helper transformation 3.5.001 to see were more |
| | information may be needed |
| Best guess | There are a few optional for helping the editor simplify language |
| | and disambiguate |
| | For example a sentence with a lot of commas and conjunctives, |
| | could be split into a bulleted list that is easer to read. The wizard can |
| | divide the sentence into a list and ask the edit to edit replace or |
| | confirm the simplification. |
| | Simple language and disambiguation: |
| | RDF is used to provide a link a document to a lexicon. This makes |
| | the text unambiguous, and easy to translate and simplify. |
| | Note: that this can be overridden by a word specific definition. |
| | A document can link to a sequence of default lexicons. The Lexicon |
| | Priority property, sets the priorities of a lexicon, were the highest |
| | priority lexicon is referenced and used first. This is like cascading |
| | lexicons so that words and phrases can default to a small but |
| | preferred lexicon (jargon or local), |
| | When each word has been located then the Engine can render it |
| | according to the user preference (putting ambiguous words with the |
| | examinations as a mouse over) |
| | In this example the sentence could be understood tree ways |
| | depending on the meanings of the word using and tap |
| | By removing these ambiguities the sentence is clear. |
| | The rendering may just clarify words that are ambiguous (coursing |
| | knowledge systems to misunderstand the sentence, or be uncertain |
| | what the sentence means, for example) |
| | Rules for defaulting (these rules are changeable) |
| | 1. If a word is part of a known phrase found in the default lexicon, |
| | the meaning of the phrase is the first meaning found in the default |
| | lexicon for that phrase |
| | 2. If a word is part of a known phrase found in a lower priority |
| | lexicon then the default meaning of the phrase is the first meaning |
| | found in the highest priority lexicon |
| | 3. If a word is found in the default lexicon, then the meaning of the |
| | word is the first meaning found in the default lexicon |
| | 4. If a word is found in a lower priority lexicon then the default |
| | meaning of the word is the first meaning found in the highest |
| | priority lexicon |
| | <ub:lexicon rdf:rdfID = “myBestLexicon” rdf: |
| | about=“myBestLexicon.xml” |
| | >www.ubaccess.com/simplelexicon.xml</ub:lexicon > |
| | <ub:lexiconPriority rdf:ref=“#myBestLexicon Value=“5”/> |
| | other example of clarification: |
| | In the following example, RDF is used to provide a link a specific |
| | instance of phrase or word to a definition in an onsite glossary. This |
| | helps makes the text unambiguous and/or clearer. |
| | Note that this would override a general reference to a lexicon. |
| | <rdf:description rdf: about=“xpointer to text” type=“ub:lexicon” |
| | value =“www.mysite.com/my glossary#this word/> |
| | The wizard uses the rules of lexicons to allow the editor to see what |
| | the default for each word is set to. The editor may have the |
| | thesaurus meaning of each word next to or above each normal word, |
| | so s/he can easily see when a word does not match |
| | In this case an override can be created so that the correct meaning of |
| | the word is stored in the knowledge base. |
| | Another help is parsing against a simple language lexicon, Word |
| | that are not in there the editor to provide a link to extra information. |
| | Best guess links can be provided using lexicon or using third party |
| | such as gurunet (www.gurunet.com) |
| | We also provide best guess for Disambiguating terms. The wizard |
| | uses the rules of lexicons cascading to guess the default meaning of |
| | each term. The editor to see what the default for each word is set to. |
| | The editor has the thesaurus meaning of each word next to or above |
| | each normal word, so s/he can easily see when a word does not |
| | match its default |
| | In this case an override can be created so that the correct meaning of |
| | the word is stored in the knowledge base. |
| | For Hebrew or Arabic sites, default terms guessed using third part |
| | tools and look up (Kolan database) and diacritics marks are added to |
| | show default terms to the Editor |
| | Known ambiguous terms are also highlighted (such as “It” and “h”e) |
| | so the editor can select the term of subject to which they refer |
| | Terms, who's ambiguity allows a sentence to be interpreted two |
| | ways, are also highlighted so the editor can select the meaning. |
| Editor supplied | Confirm, edit or change the best guess add new information where |
| knowledge | necessary |
| Example case | Case1: If there is a paragraph that contains at least one sentence with |
| (HTML description) | more than one conjunction (and, or, if etc.), and the container for |
| | this paragraph has some text that is not inside any other container, |
| | this paragraph (or sentence) needs to be simplified. |
| | Case2: If there is a paragraph that contains more than 5 sentences, |
| | and the container for this paragraph has some text that is not inside |
| | any other container, this paragraph needs to be simplified. |
| | Case3: If there is a paragraph that contains at least one sentence with |
| | more than 18 words, and the container for this paragraph has some |
| | text that is not inside any other container, this paragraph needs to be |
| | simplified. |
| | Case4: If there is a paragraph with average of more than 7 letters per |
| | word, and the container for this paragraph has some text that is not |
| | inside any other container, this paragraph needs to be simplified. |
| | Case 5 Words that are not in a “easy English” lexicon could be |
| | identified and a simplification suggested. |
| | For example: |
| | For simple and clear content, in the rendering, only sentences with |
| | important content are shown. |
| | In these sentences important terms are rendered as a symbol using a |
| | preferred set of symbols (such as BLISS) |
| | This can be done by mapping a term to a concept and a concept to a |
| | symbol |
| | In Educational material, content could be marked as important to |
| | learning disabled, and more advanced material could be marked as |
| | less important. |
| | Advanced profile can include how much background the user may |
| | need (for advances students) so that content, from the same source is |
| | tailored to the needs, level, and abilities of the student |
| | Case 6 |
| | Ambiguous terms are used (such as He) |
| | Also call helper transformation 3.5.001 to see were more |
| | information may be needed |
| | Sentence can be interpreted by third party natural language |
| | processing tools (such as dalkan) two ways. Or can be interpreted |
| | with a low level of certainty (below 99%) |
| Example use, | Allow the user to clarify complex text - add SWAPML slice that |
| WCAG | will be rendered in simplified text rendering Note: the alternative tag |
| description | will be added in the wizard. |

TABLE A-158

| Field | Description |
|---|---|
| Dependency | 13.3.3 |
| Transformation | U-3 |
| Number | |
| Knowledge gap | Page structure - navigational links |
| Logic | if one of the first three links on the page doesn't contain # in href |
| | attribute, it probably means that the page doesn't have a skip link |
| | over navigational links to main content. |
| Used for | Provide skip over navigational links |
| About | Finding the structure of the page and were the main content starts. |
| | As no link has been provided, we assume that we have to find the |
| | start of the main content. |
| Best guess | Look for last link before main content section - that is probably the |
| | end of the main content |
| Editor supplied | Confirm, edit or change the best guess add new information where |
| knowledge | necessary |
| Example case | Case1: if none of the first three a tags in the body doesn't contain # |
| (HTML description) | in href attribute, we assume that no skip link over navigational bars |
| | was provided. |
| Example use, | Add skip link to allow screen reader users to bypass navigational |
| WCAG | links |
| description | |

TABLE A-159

| Field | Description |
|---|---|
| Dependency | 3.2.3 |
| Transformation | Z-1 |
| Number | |
| Knowledge gap | Mapping to XHTML (conformant) |
| Logic | If the required type attribute is present, and the deprecated language |
| | tag is present, we need to delete the language attribute from the |
| | script tag |
| Used for | make the script tag conformant to xhtml |
| About | Often web authors do not use markup language correctly according |
| | to standards, but write what works in a common browser (like IE) |
| | It needs to be interoperable as many people with disabilities are |
| | using special browsers |
| | language attribute from the script tag is not valid (depreciated), so in |
| | mapping to valid XHTML it can be removed. If the required type |
| | attribute is present then no further knowledge is necessary |
| Best guess | Delete lang tag |
| Editor supplied | None |
| knowledge | |
| Example case | Case1: if there is a script tag, it has a type attribute, and it has a |
| (HTML description) | deprecated language attribute, we need to delete the language |
| | attribute. |
| Example use, | delete language attribute, leave type. |
| WCAG | |
| description | |

TABLE A-160

| Field | Description |
|---|---|
| Dependency | 3.2.4 |
| Transformation | Z-1 |
| Number | |
| Knowledge gap | Mapping to XHTML (conformant) |
| Logic | If the required type attribute is absent, and the deprecated language |
| | tag is present, we need to delete the language attribute and add type |
| | attribute according to the value of language attribute |
| Used for | make the script tag conformant to xhtml |
| About | Often web authors do not use markup language correctly according |
| | to standards, but write what works in a common browser (like IE) |
| | It needs to be interoperable as many people with disabilities are |
| | using special browsers |
| | language attribute from the script tag is not valid (depreciated), so in |
| | mapping to valid XHTML it can be removed. If the required type |
| | attribute is not present we need to map type attribute according to |
| | the value of language attribute |
| Best guess | map lang tag to type (text/@language) |
| Editor supplied | None |
| knowledge | |
| Example case | Case1: if there is a script tag, it doesn't have a type attribute, but it |
| (HTML description) | has a deprecated language attribute, we need to delete the language |
| | attribute and add type attribute with value text/@language. |
| Example use, | delete not allowed in xhtml language attribute and add type attribute |
| WCAG | based on value of language attribute The deleting of language |
| description | attribute is done in SWAPBasic.xsl - basic SWAPML rendering. |

TABLE A-161

| Field | Description |
|---|---|
| Dependency | 3.2.5 |
| Transformation | Z-1 |
| Number | |
| Knowledge gap | Mapping to XHTML (conformant) |
| Logic | if script tag is missing both type and language attributes, need to add |
| | default type attribute |
| Used for | make the script tag conformant to xhtml |
| About | Often web authors do not use markup language correctly according |
| | to standards, but write what works in a common browser (like IE) |
| | It needs to be interoperable as many people with disabilities are |
| | using special browsers |
| | if script tag is missing both type and language attributes, need to add |
| | default type attribute |
| Best guess | Create type (text/@language) of default language (javascript) |
| Editor supplied | Confirm, edit or change the best guess add new information where |
| knowledge | necessary |
| Example case | Case1: if there is a script tag, it is missing type and language |
| (HTML description) | attributes, |
| Example use, | add default type attribute |
| WCAG | |
| description | |

TABLE A-162

| Field | Description |
|---|---|
| Dependency | 4.3.1 |
| Transformation | Z-1 |
| Number | |
| Knowledge gap | Mapping to XHTML (conformant) |
| | What language is used, what Braille language to |
| | map to . . . |
| Logic | html tag without lang attribute |
| Used for | identifying the primary natural language of a document |
| About | the primary natural language of a document needs to be |
| | captured (if it has not been identified in html tag without |
| | lang attribute) |
| Best guess | Create of default language that maps encoding types |
| | (like English) |
| Editor supplied | Confirm, edit or change the best guess add new |
| knowledge | information where necessary |
| Example case | Case1: html tag with no lang attribute |
| (HTML | |
| description) | |
| Example use, | add lang attribute with value “en” - english as default |
| WCAG | |
| description | |

TABLE A-163

| Field | Description |
|---|---|
| Dependency | 7.2.1 |
| Transformation | Z-1 |
| Number | |
| Knowledge gap | Mapping to XHTML |
| Logic | blink tag is used in the document |
| Used for | removing the deprecated blink tag from the document |
| About | blink tag is used in the document. This is deprecated, |
| | and blinking text is best avoided |
| Best guess | map deprecated blink tag to formatted CSS |
| Editor supplied | None |
| knowledge | |
| Example case | Case1: blink tag is found |
| (HTML | |
| description) | |
| Example use, | remove the current blink tag and replace it with emphasis |
| WCAG | |
| description | |

TABLE A-164

| Field | Description |
|---|---|
| Dependency | 7.3.1 |
| Transformation | Z-1 |
| Number | |
| Knowledge gap | Mapping to XHTML |
| Logic | marquee tag is used in the document |
| Used for | removing the deprecated marquee tag from the |
| | document |
| About | marquee tag is used in the document This is non |
| | standard and, moving text is best avoided |
| Best guess | map deprecated marque tag to formatted CSS |
| Editor supplied | None |
| knowledge | |
| Example case | Case1: marquee tag is found |
| (HTML | |
| description) | |
| Example use, | remove the current marquee tag and replace it with |
| WCAG | emphasis |
| description | |

TABLE A-165

| Field | Description |
|---|---|
| Dependency | 7.4.1 |
| Transformation | Z-1 |
| Number | |
| Knowledge gap | Map to safe content |
| Logic | meta tag used to auto-refresh the page |
| Used for | verifying that there is no automatic refresh on the |
| | page |
| About | meta tag used to auto-refresh the page and reload it's |
| | content this can make screen readers start from the |
| | beginning of a page for no “apparent reason, and |
| | confuses the user |
| Best guess | Map auto refresh to a “refresh this page” button |
| Editor supplied | None |
| knowledge | |
| Example case | Case1: meta tag with http-equiv attribute with refresh |
| (HTML | value |
| description) | |
| Example use, | remove the meta tag that causes auto-refresh |
| WCAG | |
| description | |

TABLE A-166

| Field | Description |
|---|---|
| Dependency | 7.5.1 |
| Transformation | Z-1 |
| Number | |
| Knowledge gap | Where is the user. |
| | Map to safe content |
| Logic | meta tag used to auto-redirect the page |
| Used for | verifying that there is no auto-redirect on the page |
| About | meta tag used to auto-redirect the page this confuses |
| | the user and brakes the “back” option of the browser |
| Best guess | Map auto-redirect to linked text |
| Editor supplied | None |
| knowledge | |
| Example case | Case1: meta tag with http-equiv attribute with |
| (HTML | refresh value and content attribute with URI |
| description) | |
| Example use, | remove the meta tag that causes auto-redirect |
| WCAG | and instead put the link to the redirected page in |
| description | the body |

TABLE A-167

| Field | Description |
|---|---|
| Dependency | 10.5.1 |
| Transformation | Z-1 |
| Number | |
| Knowledge gap | Integrity of document |
| Logic | adjacent a tags with no separate characters between |
| | them |
| Used for | insert delimiter characters between adjacent a tags |
| About | adjacent a tags with no separate characters between |
| | them |
| Best guess | Automatic - where tags end |
| Editor supplied | None |
| knowledge | |
| Example case | Case1: a tag followed by another a tag with no |
| (HTML | content between them. Both a tags have href |
| description) | attribute, text content and are not image links. |
| Example use, | need to add delimiter between two a tags |
| WCAG | |
| description | |

TABLE A-168

| Field | Description |
|---|---|
| Dependency | 11.2.1 |
| Transformation | Z-1 |
| Number | |
| Knowledge gap | Mapping to XHTML (conformant) |
| Logic | deprecated applet tag is used in the document |
| Used for | suggest to replace applet tag with non-deprecated tag |
| About | Often web authors do not use markup language correctly |
| | according to standards, but write what works in a |
| | common browser (like IE) It needs to be interoperable as |
| | many people with disabilities are using special browsers |
| | deprecated applet tag is used in the document |
| Best guess | map applet tag with non-deprecated object and map |
| | sub elements/attributes |
| Editor supplied | None |
| knowledge | |
| Example case | Case1: deprecated applet tag is used in the document |
| (HTML | |
| description) | |
| Example use, | replace deprecated applet tag with tag code attribute will |
| WCAG | be deleted |
| description | |

TABLE A-169

| Field | Description |
|---|---|
| Dependency | 11.2.2 |
| Transformation | Z-1 |
| Number | |
| Knowledge gap | Mapping to XHTML (conformant) |
| Logic | deprecated center tag is used in the document |
| Used for | replace center tag with non-deprecated tag |
| About | Often web authors do not use markup language correctly |
| | according to standards, but write what works in a |
| | common browser (like IE) It needs to be interoperable |
| | as many people with disabilities are using special |
| | browsers deprecated center tag is used in the document |
| Best guess | map center with non-deprecated Div with |
| | referencing known CSS class |
| Editor supplied | None |
| knowledge | |
| Example case | Case1: center tag is found in the document |
| (HTML | |
| description) | |
| Example use, | replace it with div tag with CSS class align center |
| WCAG | |
| description | |

TABLE A-170

| Field | Description |
|---|---|
| Dependency | 11.2.3 |
| Transformation | Z-1 |
| Number | |
| Knowledge gap | Mapping to XHTML (conformant) |
| Logic | deprecated dir or menu tag is used in the document |
| Used for | replace dir/menu tag with non-deprecated tag |
| About | deprecated dir or menu tag is used in the document |
| Best guess | map dir/menu tag with non-deprecated UL tag |
| | map child tags and attributes |
| Editor supplied | None |
| knowledge | |
| Example case | Case1: dir tag is found in the document |
| (HTML | Case2: menu tag is found in the document |
| description) | |
| Example use, | replace it with ul tag |
| WCAG | |
| description | |

TABLE A-171

| Field | Description |
|---|---|
| Dependency | 11.2.4 |
| Transformation | Z-1 |
| Number | |
| Knowledge gap | Mapping to XHTML (conformant) |
| Logic | deprecated isindex tag is used in the document |
| Used for | replace isindex tag with non-deprecated tag |
| About | Often web authors do not use markup language correctly |
| | according to standards, but write what works in a |
| | common browser (like IE) It needs to be interoperable |
| | as many people with disabilities are using special |
| | browsers deprecated isindex tag is used in the |
| | document |
| Best guess | map isindex tag with non-deprecated equivalent form |
| Editor supplied | None |
| knowledge | |
| Example case | Case1: isindex tag is found in the document |
| (HTML | |
| description) | |
| Example use, | We are changing the isindex tag to a form with text |
| WCAG | input tag which has a value of isindex prompt attribute |
| description | as a title (maybe will be rewritten as a label) |

TABLE A-172

| Field | Description |
|---|---|
| Dependency | 11.2.5 |
| Transformation | Z-1 |
| Number | |
| Knowledge gap | Mapping to XHTML (conformant) |
| Logic | deprecated s or strike tags are used in the document |
| Used for | replace deprecated s or strike tags with css style |
| About | Often web authors do not use markup language correctly |
| | according to standards, but write what works in a |
| | common browser (like IE) It needs to be interoperable |
| | as many people with disabilities are using special |
| | browsers deprecated s or strike tags are used in the |
| | document |
| Best guess | map deprecated s or strike tags with span with css |
| | style from known resource |
| Editor supplied | None |
| knowledge | |
| Example case | Case1: s tag is found in |
| (HTML | Case2: strike tag is found in |
| description) | |
| Example use, | need to replace deprecated tag with div with css class |
| WCAG | |
| description | |

TABLE A-173

| Field | Description |
|---|---|
| Dependency | 11.2.6 |
| Transformation | Z-1 |
| Number | |
| Knowledge gap | Mapping to XHTML (conformant) |
| Logic | deprecated u tag is used in the document |
| Used for | replace deprecated u tag with css style |
| About | Often web authors do not use markup language correctly |
| | according to standards, but write what works in a |
| | common browser (like IE) It needs to be interoperable as |
| | many people with disabilities are using special browsers |
| | deprecated u tag is used in the document |
| Best guess | map deprecated u tag to span with with css style |
| | from know resource of equivalents |
| Editor supplied | None |
| knowledge | |
| Example case | Case1: u tag is found in the document |
| (HTML | |
| description) | |
| Example use, | replace the deprecated tag with style sheets |
| WCAG | |
| description | |

TABLE A-174

| Field | Description |
|---|---|
| Dependency | 13.10.1 |
| Transformation | Z-1 |
| Number | |
| Knowledge gap | Type of content |
| Logic | a pre tag is in the text for preformatting |
| Used for | provide a link to jump over a tag |
| About | Often web authors do not use markup language correctly |
| | according to standards, but write what works in a |
| | common browser (like IE) It needs to be interoperable |
| | as many people with disabilities are using special |
| | browsers |
| | a pre tag is in the text for preformatting |
| Best guess | This is askii art or a block that the user may want to skip |
| Editor supplied | Confirm, edit or change the best guess add new |
| knowledge | information where necessary |
| Example case | Case1: pre tag is used in the document |
| (HTML | |
| description) | |
| Example use, | provide skip links for ASCII art |
| WCAG | |
| description | |

TABLE A-175

| Field | Description |
|---|---|
| Dependency | 3.5.001 |
| Transformation | |
| Number | |
| Knowledge gap | More information needed |
| Logic | help transformation |
| Used for | |
| About | help transformation, when is extra help required for the user? These |
| | need to be created and referenced |
| Best guess | Suggest more information |
| | Terms and Jargon, |
| | Instructions |
| | Form controls. |
| | Long paragraphs |
| | Third party summarizing tools and knowledge processing are called |
| | by screen |
| | Resource of pre written instructions for filling up forms of standard |
| | roles, and fulfilling known internet user tasks n are suggested when |
| | role of form is of a known, predefined type. |
| | The editor may also want to show relationship between equations |
| | and diagrams to more detailed explanation of content. In equations |
| | finding term on the right had side appear on the left hand side of |
| | another equation often explains what the terms are |
| Editor supplied | Confirm, edit or change the best guess add new information where |
| knowledge | necessary |
| Example case | Case1: Jargon without more information |
| (HTML description) | Case 2: Acronym with out more information |
| | Case3: long section without summary |
| | Case4: Form |
| | Case 5: Instructions page (know base role..) |
| Example use, | User can request a zooming in or expantion of terms |
| WCAG description | Foer example the sentence |
| | “RDF is writen in triples” |
| | has a zoomed in or expanded sentence: |
| | “RDF(Resource Description Framework) |
| | is writen in triples (triples |
| | Describe the relationship between to items).” |
| | Extra information can also be provided in a mouse over affect. |

### TABLE A-176 THIS TABLE INTENTIONALLY OMITTED

TABLE A-177

| Field | Description |
|---|---|
| Dependency | 12.1.01 |
| Transformation | |
| Number | |
| Knowledge gap | Title and role for frame |
| Logic | frame that doesn't have a title |
| Used for | helper transformation |
| About | frame that doesn't have a title |
| Best guess | helper transformation |
| | Used by referencing transformation to provide a good |
| | Guess |
| Editor supplied | Confirm, edit or change the best guess add new |
| knowledge | information where necessary |
| Example case | Case1: a frame without title attribute content |
| (HTML | Case2: a frame with empty title attribute content |
| description) | |
| Example use, | See referencing transformation |
| WCAG | |
| description | |

TABLE A-178

| Field | Description |
|---|---|
| Dependency | 12.1.02 |
| Transformation | |
| Number | |
| Knowledge gap | Description of frame use |
| Logic | frame that doesn't have a longdesc |
| Used for | helper transformation |
| About | frame that doesn't have a longdesc |
| Best guess | helper transformation |
| | Used by referencing transformation to provide a good |
| | Guess |
| Editor supplied | Confirm, edit or change the best guess add new |
| knowledge | information where necessary |
| Example case | Case1: a frame without longdesc attribute content |
| (HTML | Case2: a frame with empty longdesc attribute content |
| description) | |
| Example use, | See referencing transformation |
| WCAG | |
| description | |

TABLE A-179

| Field | Description |
|---|---|
| Dependency | 12.4.01 |
| Transformation | |
| Number | |
| Knowledge gap | ID and identification of element unknown |
| Logic | tag that has no or empty id attribute |
| Used for | helper transformation |
| About | tag that has no or empty id attribute |
| Best guess | helper transformation |
| | Used by referencing transformation to provide a good |
| | Guess |
| Editor supplied | Confirm, edit or change the best guess add new |
| knowledge | information where necessary |
| Example case | Case1: tag with empty id attribute |
| (HTML | Case2: tag with missing id attribute |
| description) | |
| Example use, | See referencing transformation |
| WCAG | |
| description | |

TABLE A-180

| Field | Description |
|---|---|
| Dependency | 12.4.02 |
| Transformation | |
| Number | |
| Knowledge gap | Text equivalent of element |
| Logic | tag that has no or empty value attribute |
| Used for | helper transformation |
| About | tag that has no or empty value attribute |
| Best guess | helper transformation |
| | Used by referencing transformation to provide a good |
| | Guess |
| Editor supplied | Confirm, edit or change the best guess add new |
| knowledge | information where necessary |
| Example case | Case1: tag with empty value attribute |
| (HTML | Case2: tag with missing value attribute |
| description) | |
| Example use, | See referencing transformation |
| WCAG | |
| description | |

TABLE A-181

| Field | Description |
|---|---|
| Dependency | 14.1.01 |
| Transformation | |
| Number | |
| Knowledge gap | Sections of content on a page |
| Logic | help transformation for 14.1.2 |
| Used for | Select containers with text, do not catch too much. |
| About | help transformation for 14.1.2 |
| Best guess | helper transformation |
| | Used by referencing transformation to provide a good |
| | Guess |
| Editor supplied | Confirm, edit or change the best guess add new |
| knowledge | information where necessary |
| Example case | Case1: select container that contains text, doesn't |
| (HTML | have a descendant container that contains all the text of |
| description) | this container, and doesn't have an ancestor |
| | container that has text not in this container. |
| Example use, | See referencing transformation |
| WCAG | |
| description | |

TABLE A-182

| Field | Description |
|---|---|
| Dependency | 3.5.001 |
| Transformation | |
| Number | |
| Knowledge gap | More information needed |
| Logic | help transformation |
| Used for | |
| About | help transformation, when is extra help required for the user? These |
| | need to be created and referenced |
| Best guess | Suggest more information |
| | Terms and Jargon, |
| | Instructions |
| | Form controls. |
| | Long paragraphs |
| | Third party summarizing tools and knowledge processing are called |
| | by screen |
| | Resource of pre written instructions for filling up forms of standard |
| | roles, and fulfilling known internet user tasks n are suggested when |
| | role of form is of a known, predefined type. |
| | The editor may also want to show relationship between equations |
| | and diagrams to more detailed explanation of content. In equations |
| | finding term on the right had side appear on the left hand side of |
| | another equation often explains what the terms are |
| Editor supplied | Confirm, edit or change the best guess add new information where |
| knowledge | necessary |
| Example case | Case1: Jargon without more information |
| (HTML description) | Case2: Acronym with out more information |
| | Case3: long section without summary |
| | Case4: Form |
| | Case 5: Instructions page (know base role..) |
| Example use, | User can request a zooming in or explanation of terms |
| WCAG description | For example the sentence |
| | “RDF is written in triples” |
| | has a zoomed in or expanded sentence: |
| | “RDF(Resource Description Framework) |
| | is written in triples (triples describe the relationship between to |
| | items).” |
| | Extra information can also be provided in a mouse over affect. |

1. A method of enhancing resource accessibility, comprising:
using a computer to apply a resource knowledge base to the resource to generate a converted resource, the resource knowledge base providing information about the resource that is absent from or implicit in the resource, and
providing the converted resource to a user.

2. The method of claim 1, wherein the resource is a website.

3. The method of claim 1, wherein the resource is at a location remote from the user.

4. The method of claim 1, wherein the resource is local to the user.

5. The method of claim 1, wherein the resource knowledge base is created by
using a computer to apply rules representing knowledge gap situations to a resource to identify knowledge gaps, and
obtaining knowledge to fill the knowledge gaps, the obtained knowledge forming the resource knowledge base.

6. The method of claim 1, further comprising using a computer to apply at least one mapping knowledge base to the converted resource to generate a mapped resource.

7. The method of claim 1, further comprising using user preferences to generate the converted resource.

8. The method of claim 7, wherein the user preferences are obtained from a third party.

9. The method of claim 7, wherein the user preferences are obtained from a user preferences file.

10. The method of claim 7, wherein the user preferences are obtained from a dynamic selection made by the user.

11. The method of claim 1, further comprising using scenario-specific style sheet rules to generate the converted resource.

12. A method of creating a resource knowledge base, comprising:
using a computer to apply rules representing knowledge gap situations to a resource to identify knowledge gaps, and
obtaining knowledge to fill the knowledge gaps, the obtained knowledge forming the resource knowledge base.

13. The method of claim 12, wherein the knowledge is obtained by guessing.

14. The method of claim 12, wherein the knowledge is obtained from a human editor.

15. The method of claim 12, wherein the knowledge represents information that is absent from the resource.

16. The method of claim 12, wherein the knowledge represents information that is implicit in the resource.

17. The method of claim 12, wherein the knowledge is represented as an RDF triple.

18. The method of claim 12, wherein using a computer to apply rules includes
applying a first set of rules to the resource to create a first resource knowledge base,
applying the first resource knowledge base to the resource to generate a first converted resource, and
applying a second set of rules to the first converted resource to create a second resource knowledge base.

19. The method of claim 12, wherein the rules include specific situations that trigger their application and actions for obtaining knowledge that should be taken when the respective rule is applied.

20. The method of claim 12, further comprising receiving compliance information from an editor indicating which standard is of interest, and wherein the rules applied identify knowledge gaps that prevent the resource from being in compliance with the standard.

21. A method of converting a resource from one format to at least one other target format, comprising:
using a computer to apply at least one mapping knowledge base to the resource to generate at least one mapped resource, each mapping knowledge base providing information about the meaning of information whose format is to be converted so that the mapped resource is properly represented in the target format, and
providing the at least one mapped resource to a user.
